(19) United States
(12) Patent Application Publication
(10) Pub. No.: US 2026/0202648 A1
(43) Pub. Date: Jul. 16, 2026

(54) VARIABLE MAGNIFICATION OPTICAL SYSTEM AND IMAGING APPARATUS

(71) Applicant: FUJIFILM Corporation, Tokyo (JP)

(72) Inventor: Takuya TANAKA, Saitama-shi (JP)

(73) Assignee: FUJIFILM Corporation, Tokyo (JP)

(21) Appl. No.: 19/443,730

(22) Filed: Jan. 8, 2026

(30) Foreign Application Priority Data
Jan. 15, 2025 (JP) 2025-005511

(51) Int. Cl. G02B 13/00; G02B 7/02; G02B 15/14

(52) U.S. Cl. CPC G02B 13/009; G02B 7/025; G02B 13/0045; G02B 13/006; G02B 15/144511

(57) ABSTRACT

A variable magnification optical system consists of, in order from an object side to an image side, a first lens group having a negative refractive power, a second lens group having a positive refractive power, a third lens group, and a fourth lens group. The second lens group includes an aperture stop. A vibration-proof group is disposed adjacent to the aperture stop, and a focusing group is disposed closer to the image side than the aperture stop. The variable magnification optical system satisfies a predetermined conditional expression.

### CROSS-REFERENCE TO RELATED APPLICATIONS

This application claims priority from Japanese Patent Application No. 2025-005511, filed on Jan. 15, 2025, the entire disclosure of which is incorporated herein by reference.

### BACKGROUND

### Technical Field

The technology of the present disclosure relates to a variable magnification optical system and an imaging apparatus.

### Related Art

In the related art, a zoom lens described in JP2019-174510A has been proposed as an optical system that can be applied to an imaging apparatus such as a digital camera.

### SUMMARY

A variable magnification optical system that is configured to be small and wide-angle and that maintains favorable optical performance while having an image shake correction function is desired. A level of such demand is increasing year by year.

The present disclosure provides a variable magnification optical system that has an image shake correction function, is configured to be small and wide-angle, and maintains favorable optical performance, and an imaging apparatus comprising the variable magnification optical system.

A variable magnification optical system according to an aspect of the present disclosure consists of, in order from an object side to an image side, a first lens group having a negative refractive power, a second lens group having a positive refractive power, a third lens group, and a fourth lens group, in which all spacings between adjacent lens groups change during changing magnification, the second lens group includes an aperture stop, a vibration-proof group that moves in a direction intersecting an optical axis during image shake correction is disposed adjacent to the aperture stop, a focusing group that moves along the optical axis during focusing is disposed closer to the image side than the aperture stop, and

Conditional Expressions (1), (2), (3), and (4) are satisfied, which are represented by

$$1 < DG 1 fG 2 f / fw < 5 , \qquad ( 1 )$$

$$0.4 < DG 1 / fw < 2.5 , \qquad ( 2 )$$

$$2 < TLw / ( fw \times tan ω w ) < 8 , and \qquad ( 3 )$$

$$0.2 < Bfw / ( fw \times tan ω w ) < 1.8 . \qquad ( 4 )$$

Here, a distance on the optical axis from a lens surface of the first lens group closest to the object side to a lens surface of the second lens group closest to the object side in a state where an infinite distance object is in focus at a wide angle end is denoted by DG1fG2f. A focal length of an entire system in a state where the infinite distance object is in focus at the wide angle end is denoted by fw. A thickness of the first lens group on the optical axis is denoted by DG1. A sum of a distance on the optical axis from the lens surface of the first lens group closest to the object side to a lens surface of the fourth lens group closest to the image side and a back focus of the entire system in terms of an air conversion distance in a state where the infinite distance object is in focus at the wide angle end is denoted by TLw. A maximum half angle of view in a state where the infinite distance object is in focus at the wide angle end is denoted by ωw. A back focus of the entire system in terms of the air conversion distance at the wide angle end is denoted by Bfw.

It is preferable that the variable magnification optical system according to the aspect satisfies at least one of Conditional Expression (1-1), (2-1), or (3-1) represented by

$$1.8 < DG 1 fG 2 f / fw < 2.6 , \qquad ( 1 - 1 )$$

$$0.7 < DG 1 / fw < 1 , and \qquad ( 2 - 1 )$$

$$3 < TLw / ( fw \times tan ω w ) < 5.5 . \qquad ( 3 - 1 )$$

The third lens group may be configured to have a negative refractive power, the fourth lens group may be configured to have a positive refractive power, and the focusing group may be configured to consist of the third lens group.

In a case where a focal length of the vibration-proof group is denoted by fOIS and a focal length of the entire system in a state where the infinite distance object is in focus at a telephoto end is denoted by ft, it is preferable that the variable magnification optical system according to the aspect satisfies Conditional Expression (5) represented by

$$0.5 < fOIS / ft < 6. \qquad ( 5 )$$

In a case where a focal length of the first lens group is denoted by f1,
it is preferable that the variable magnification optical system according to the aspect satisfies Conditional Expression (6) represented by

$$- 4 < f 1 / fw < - 0.8 . \qquad ( 6 )$$

In a case where a focal length of the second lens group is denoted by f2,
it is preferable that the variable magnification optical system according to the aspect satisfies Conditional Expression (7) represented by

$$0.5 < f 2 / fw < 3. \qquad ( 7 )$$

It is preferable that a first lens disposed closest to the object side in the first lens group is an aspherical lens having a negative refractive power. In a configuration in which the first lens is an aspherical lens having a negative refractive power, in a case where a refractive index of the first lens with respect to a d line is denoted by N1, an Abbe number of the first lens based on the d line is denoted by v1, and a partial dispersion ratio of the first lens between a g line and an F line is denoted by θ1,
it is preferable that the variable magnification optical system according to the aspect satisfies Conditional Expressions (8) and (9) represented by

$$2.19 < N 1 + 0.01 \times ν 1 < 2.29 , and \qquad ( 8 )$$

$$0.65 < θ 1 + 0.0025 \times ν 1 < 0.7 . \qquad ( 9 )$$

It is preferable that a second lens disposed second from the object side in the first lens group has a negative refractive power. In a configuration in which the second lens has a negative refractive power, in a case where a refractive index of the second lens with respect to a d line is denoted by N2, an Abbe number of the second lens based on the d line is denoted by v2, and a partial dispersion ratio of the second lens between a g line and an F line is denoted by θ2,
it is preferable that the variable magnification optical system according to the aspect satisfies Conditional Expressions (10) and (11) represented by

$$2.18 < N 2 + 0.01 \times ν 2 < 2.4 , and \qquad ( 10 )$$

$$0.65 < θ 2 + 0.0025 \times ν 2 < 0.79 . \qquad ( 11 )$$

In a configuration in which the second lens group includes a plurality of positive lenses, in a case where an average value of refractive indices of all positive lenses included in the second lens group with respect to a d line is denoted by NG2p, an average value of Abbe numbers of all positive lenses included in the second lens group based on the d line is denoted by vG2p, and an average value of partial dispersion ratios of all positive lenses included in the second lens group between a g line and an F line is denoted by θG2p,
it is preferable that the variable magnification optical system according to the aspect satisfies Conditional Expressions (12) and (13) represented by

$$2.16 < NG 2 p + 0.01 \times ν G 2 p < 2.36 , and \qquad ( 12 )$$

$$0.68 < θ G 2 p + 0.0025 \times ν G 2 p < 0.76 . \qquad ( 13 )$$

It is preferable that a lens disposed closest to the image side in the second lens group is a positive lens. In a configuration in which a lens disposed closest to the image side in the second lens group is a positive lens, in a case where a refractive index of the positive lens closest to the image side in the second lens group with respect to a d line is denoted by NG2r, an Abbe number of the positive lens closest to the image side in the second lens group based on the d line is denoted by vG2r, and a partial dispersion ratio of the positive lens closest to the image side in the second lens group between a g line and an F line is denoted by θG2r,
it is preferable that the variable magnification optical system according to the aspect satisfies Conditional Expressions (14) and (15) represented by

$$2.18 < NG 2 r + 0.01 \times ν G 2 r < 2.4 , and \qquad ( 14 )$$

$$0.7 < θ G 2 r + 0.0025 \times ν G 2 r < 0.76 . \qquad ( 15 )$$

In a case where a paraxial curvature radius of a lens surface of the second lens group closest to the image side is denoted by RG2r, and a paraxial curvature radius of a lens surface of the third lens group closest to the object side is denoted by RG3f,
it is preferable that the variable magnification optical system according to the aspect satisfies Conditional Expression (16) represented by

$$- 12 < ( RG 2 r + RG 3 f ) / ( RG 2 r - RG 3 f ) < - 0.5 . \qquad ( 16 )$$

In a case where a distance on the optical axis from an image plane to a paraxial exit pupil position in a state where the infinite distance object is in focus at the wide angle end is denoted by Dexpw,
it is preferable that the variable magnification optical system according to the aspect satisfies at least one of Conditional Expression (17) or (18) represented by

$$- 5 < Dexpw / fw < - 1.5 , and \qquad ( 17 )$$

$$- 1 < Dexpw / TLw < - 0.3 . \qquad ( 18 )$$

Here, a sign of Dexpw is defined with the image plane as a reference such that a distance on the image side is positive and a distance on the object side is negative. In addition, Dexpw is calculated, in a case where an optical member not having a refractive power is disposed between the image plane and the paraxial exit pupil position, by using an air conversion distance for the optical member.

In a case where a sum of the thickness of the first lens group on the optical axis, a thickness of the second lens group on the optical axis, a thickness of the third lens group on the optical axis, and a thickness of the fourth lens group on the optical axis is denoted by ThG,
it is preferable that the variable magnification optical system according to the aspect satisfies at least one of Conditional Expression (19) or (20) represented by

$$0.5 < ThG / fw < 3.8 , and \qquad ( 19 )$$

$$0.15 < ThG / TLw < 0.7 . \qquad ( 20 )$$

In a case where an effective diameter of the lens surface of the first lens group closest to the object side is denoted by EDL1f,
it is preferable that the variable magnification optical system according to the aspect satisfies at least one of Conditional Expression (21) or (22) represented by

$$1.5 < EDL 1 f / fw < 2.5 , and \qquad ( 21 )$$

$$0.2 < EDL 1 f / TLw < 0.6 . \qquad ( 22 )$$

In a case where a lateral magnification of the focusing group in a state where the infinite distance object is in focus at a telephoto end is denoted by βFoc, and a combined lateral magnification of all lenses closer to the image side than the focusing group in a state where the infinite distance object is in focus at the telephoto end is denoted by βFocR,
it is preferable that the variable magnification optical system according to the aspect satisfies Conditional Expression (23) represented by

$$1 < \vert ( 1 - β {Foc}^{2} ) \times β {FocR}^{2} \vert < 10. \qquad ( 23 )$$

In a case where a lateral magnification of the vibration-proof group in a state where the infinite distance object is in focus at a telephoto end is denoted by BOIS, and a combined lateral magnification of all lenses closer to the image side than the vibration-proof group in a state where the infinite distance object is in focus at the telephoto end is denoted by βOISR,
it is preferable that the variable magnification optical system according to the aspect satisfies Conditional Expression (24) represented by

$$0.6 < \vert ( 1 - β OIS ) \times β OISR \vert < 3.5 . \qquad ( 24 )$$

The first lens group may be configured to consist of, in order from the object side to the image side, a single lens having a negative refractive power, a single lens having a negative refractive power, and a single lens having a positive refractive power.

The third lens group may be configured to consist of one single lens having a negative refractive power.

The fourth lens group may be configured to consist of one single lens having a positive refractive power.

It is preferable that the number of lenses included in the entire system is 12 or less.

According to another aspect of the present disclosure, there is provided an imaging apparatus comprising the variable magnification optical system according to the aspect.

In the present specification, the terms “consist of” and “consisting of” mean that a lens substantially not having a refractive power, an optical element other than a lens, such as a stop, a filter, and a cover glass, a mechanism part such as a lens flange, a lens barrel, an imaging element, and a camera shake correction mechanism, and the like may be included in addition to the shown constituents.

The expressions “~ group having a positive refractive power” and “~ group has a positive refractive power” in the present specification mean that the entire group has a positive refractive power. Similarly, the expressions “~ group having a negative refractive power” and “~ group has a negative refractive power” mean that the entire group has a negative refractive power. The terms “lens having a positive refractive power” and “positive lens” are synonymous with each other. The terms “lens having a negative refractive power” and “negative lens” are synonymous with each other. The terms “~ lens group”, “vibration-proof group”, and “focusing group” in the present specification are not limited to a configuration consisting of a plurality of lenses, but may be a configuration consisting of only one lens.

The number of lenses in the present specification is the number of lenses as constituents. For example, the number of lenses in a cemented lens in which a plurality of single lenses of different materials are cemented is represented by the number of single lenses constituting the cemented lens. However, a compound aspherical lens (that is, a lens of which a lens (for example, a spherical lens) and an aspherical film formed on the lens are integrally formed and which functions as one aspherical lens as a whole) is not regarded as a cemented lens, but is regarded as one lens. Unless otherwise specified, a curvature radius, a sign of a refractive power, and a surface shape related to a lens including an aspherical surface in a paraxial region are used.

In the present specification, the term “entire system” refers to a variable magnification optical system. The term “focal length” used in the conditional expressions means a paraxial focal length. Unless otherwise specified, the expression “distance on the optical axis” used in the conditional expressions means a geometrical distance. Unless otherwise specified, values used in the conditional expressions are values based on the d line in a state where the infinite distance object is in focus.

The terms “d line”, “C line”, “F line”, and “g line” according to the present specification are bright lines. A wavelength of the d line is 587.56 nanometers (nm), a wavelength of the C line is 656.27 nanometers (nm), a wavelength of the F line is 486.13 nanometers (nm), and a wavelength of the g line is 435.84 nanometers (nm).

According to the present disclosure, it is possible to provide a variable magnification optical system that has an image shake correction function, is configured to be small and wide-angle, and maintains favorable optical performance, and an imaging apparatus comprising the variable magnification optical system.

### BRIEF DESCRIPTION OF THE DRAWINGS

FIG. 1 is a diagram corresponding to a variable magnification optical system of Example 1 and showing a cross-sectional view of a configuration and a moving trajectory of a variable magnification optical system according to one embodiment.

FIG. 2 is a cross-sectional view of the configuration of the variable magnification optical system in FIG. 1 for describing symbols of conditional expressions.

FIG. 3 is a diagram for describing an effective diameter.

FIG. 4 is each aberration diagram of the variable magnification optical system of Example 1.

FIG. 5 is a diagram showing a cross-sectional view of a configuration and a moving trajectory of a variable magnification optical system of Example 2.

FIG. 6 is each aberration diagram of the variable magnification optical system of Example 2.

FIG. 7 is a diagram showing a cross-sectional view of a configuration and a moving trajectory of a variable magnification optical system of Example 3.

FIG. 8 is each aberration diagram of the variable magnification optical system of Example 3.

FIG. 9 is a diagram showing a cross-sectional view of a configuration and a moving trajectory of a variable magnification optical system of Example 4.

FIG. 10 is each aberration diagram of the variable magnification optical system of Example 4.

FIG. 11 is a diagram showing a cross-sectional view of a configuration and a moving trajectory of a variable magnification optical system of Example 5.

FIG. 12 is each aberration diagram of the variable magnification optical system of Example 5.

FIG. 13 is a diagram showing a cross-sectional view of a configuration and a moving trajectory of a variable magnification optical system of Example 6.

FIG. 14 is each aberration diagram of the variable magnification optical system of Example 6.

FIG. 15 is a diagram showing a cross-sectional view of a configuration and a moving trajectory of a variable magnification optical system of Example 7.

FIG. 16 is each aberration diagram of the variable magnification optical system of Example 7.

FIG. 17 is a diagram showing a cross-sectional view of a configuration and a moving trajectory of a variable magnification optical system of Example 8.

FIG. 18 is each aberration diagram of the variable magnification optical system of Example 8.

FIG. 19 is a diagram showing a cross-sectional view of a configuration and a moving trajectory of a variable magnification optical system of Example 9.

FIG. 20 is each aberration diagram of the variable magnification optical system of Example 9.

FIG. 21 is a diagram showing a cross-sectional view of a configuration and a moving trajectory of a variable magnification optical system of Example 10.

FIG. 22 is each aberration diagram of the variable magnification optical system of Example 10.

FIG. 23 is a perspective view of a front surface side of an imaging apparatus according to one embodiment.

FIG. 24 is a perspective view of a rear surface side of the imaging apparatus shown in FIG. 23.

### DETAILED DESCRIPTION

Hereinafter, an embodiment of the present disclosure will be described with reference to the drawings.

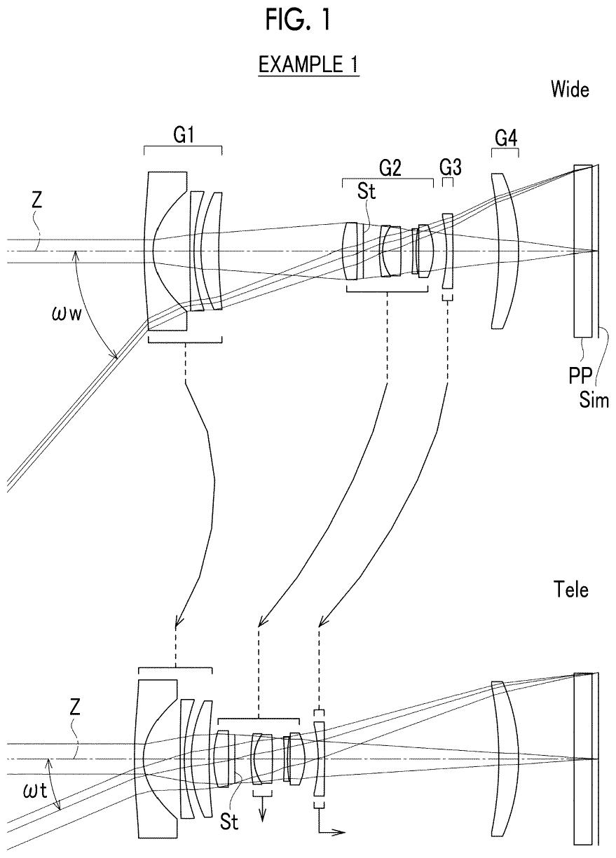

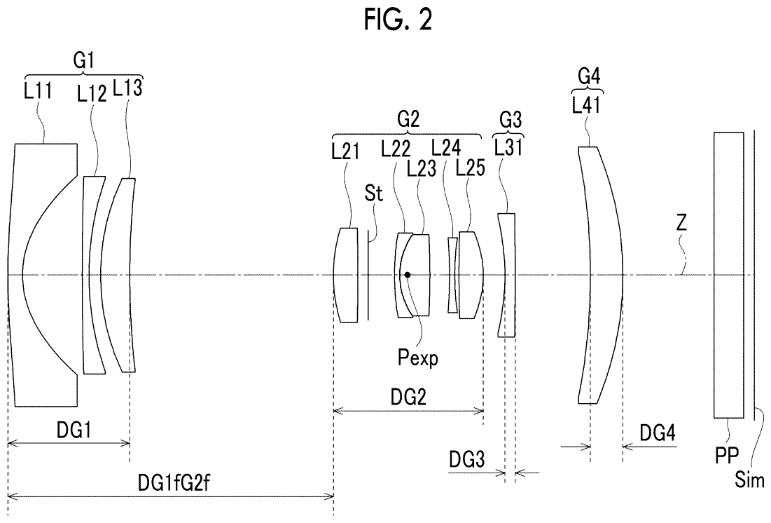

FIG. 1 shows a cross-sectional view of a configuration and a luminous flux, and a moving trajectory of a variable magnification optical system according to one embodiment of the present disclosure. In FIG. 1, a wide angle end state is shown in an upper part labeled “Wide”, and a telephoto end state is shown in a lower part labeled “Tele”. In addition, as the luminous flux, FIG. 1 shows an on-axis luminous flux and a luminous flux of a maximum half angle of view ow at a wide angle end and an on-axis luminous flux and a luminous flux of a maximum half angle of view ωt at a telephoto end. FIG. 2 shows a cross-sectional view of a configuration of the variable magnification optical system in FIG. 1 at the wide angle end. In FIGS. 1 and 2, a left side is an object side, a right side is an image side, and a state where an infinite distance object is in focus is shown. Examples shown in FIGS. 1 and 2 correspond to a variable magnification optical system of Example 1 described later. Hereinafter, FIG. 1 will be mainly referred to for description, and FIG. 2 will be referred to, as necessary.

FIG. 1 shows an example in which a parallel flat plate-shaped optical member PP is disposed between the variable magnification optical system and an image plane Sim, assuming application of the variable magnification optical system to an imaging apparatus. The optical member PP is a member that is assumed to be various filters and/or a cover glass or the like. The various filters include a low-pass filter, an infrared cut filter, and/or a filter or the like that cuts a specific wavelength range. The optical member PP is a member not having a refractive power. The imaging apparatus can also be configured without providing the optical member PP.

The variable magnification optical system according to the embodiment of the present disclosure consists of, in order from the object side to the image side along an optical axis Z, a first lens group G1 having a negative refractive power, a second lens group G2 having a positive refractive power, a third lens group G3, and a fourth lens group G4. All spacings between adjacent lens groups change during changing magnification. In the optical system having the four-lens group configuration, by continuously arranging the negative and positive refractive powers in order from closest to the object side to the image side, there is an advantage in achieving both a wide angle and reduction in size.

In the present specification, one lens group is a group of which a spacing with respect to an adjacent group in an optical axis direction changes during changing the magnification. During changing the magnification, a spacing between adjacent lenses does not change in one lens group. That is, the term “lens group” means a part constituting the variable magnification optical system and including at least one lens divided by an air spacing that changes during changing the magnification. During changing the magnification, each lens group moves or is fixed in lens group units. The term “lens group” may include a constituent, other than a lens, not having a refractive power, for example, an aperture stop St.

In addition, for example, as shown in FIG. 2, each lens group of the variable magnification optical system in FIG. 1 is configured as follows. The first lens group G1 consists of, in order from the object side to the image side, three lenses including lenses L11 to L13. The second lens group G2 consists of the lens L21, the aperture stop St, and the lenses L22 to L25 in order from the object side to the image side. The third lens group G3 consists of one lens that is a lens L31. The fourth lens group G4 consists of one lens that is a lens L41. The aperture stop St shown in FIGS. 1 and 2 does not show a size or a shape and shows a position in the optical axis direction.

In the example in FIG. 1, during changing the magnification, the fourth lens group G4 is fixed with respect to the image plane Sim, and the first lens group G1, the second lens group G2, and the third lens group G3 move along the optical axis Z by changing a spacing with respect to an adjacent lens group. In FIG. 1, a schematic moving trajectory during changing the magnification from the wide angle end to the telephoto end is shown between the upper part and the lower part of FIG. 1 by solid line arrows for each lens group that moves during changing the magnification.

The example shown in FIG. 1 is merely an example, and various modifications can be made to the variable magnification optical system according to the embodiment of the present disclosure without departing from the gist of the technology of the present disclosure. For example, the number and configurations of lenses included in each lens group may be different from those of the example in FIG. 1. Behavior of each lens group during changing the magnification may be different from that of the example in FIG. 1. While FIG. 1 shows an example in which the variable magnification optical system is a zoom lens, the variable magnification optical system according to the embodiment of the present disclosure may be a varifocal lens.

It is preferable that a first lens disposed closest to the object side in the first lens group G1 is a negative lens. In such a case, there is an advantage in achieving a wide angle. The first lens may be configured as an aspherical lens having a negative refractive power. By configuring the first lens as an aspherical lens, it is extremely advantageous for suppressing field curvature in a case of achieving the wide angle and for reducing the size.

A second lens disposed second from the object side in the first lens group G1 may be configured as a negative lens. In such a case, there is an advantage in achieving a wide angle and suppressing field curvature. In particular, in a case where both the first lens and the second lens are configured as negative lenses, it is more advantageous for achieving a wide angle and for suppressing field curvature.

For example, the first lens group G1 may be configured to consist of, in order from the object side to the image side, a single lens having a negative refractive power, a single lens having a negative refractive power, and a single lens having a positive refractive power. In such a case, there is an advantage in achieving both a wide angle and reduction in size. In the present specification, the term “single lens” refers to one lens that is not cemented.

It is preferable that the second lens group G2 includes a plurality of positive lenses. In such a case, there is an advantage in correcting spherical aberration. A positive lens may be configured to be disposed closest to the image side in the second lens group G2. In this case, the positive lens disposed closest to the image side in the second lens group G2 may be configured as an aspherical lens. In such a case, there is an advantage in correcting spherical aberration and field curvature.

The second lens group G2 may be configured to include two cemented lenses, in each of which a negative lens and a positive lens are cemented. In such a case, there is an advantage in correcting axial chromatic aberration. In this case, the cemented lens of the second lens group G2 may be configured to be disposed adjacent to the aperture stop St. In such a case, there is an advantage in suppressing chromatic aberration over the entire magnification range.

It is preferable that the second lens group G2 includes the aperture stop St and the vibration-proof group is configured to be disposed adjacent to the aperture stop St. The vibration-proof group may be disposed adjacent to the object side of the aperture stop St or may be disposed adjacent to the image side of the aperture stop St. The vibration-proof group is a group that moves in a direction intersecting the optical axis Z during image shake correction. The image shake correction is performed by moving the vibration-proof group. By disposing the vibration-proof group adjacent to the aperture stop St, there is an advantage in suppressing a change in various aberrations related to the on-axis luminous flux and the off-axis luminous flux during image shake correction.

For example, the vibration-proof group of the variable magnification optical system in FIG. 1 consists of the lenses L22 to L23 shown in FIG. 2. In the lower part of FIG. 1, a bracket with a downward arrow is given below the lenses constituting the vibration-proof group. While the vibration-proof group functions in the entire magnification range including the wide angle end state, the bracket and the arrow are given in only the lower part of FIG. 1 to avoid complication of the drawing. The above illustration method related to the vibration-proof group is the same for the drawings of other examples.

The vibration-proof group may be configured to consist of one cemented lens or one single lens. In a case where the vibration-proof group is configured to consist of one cemented lens, there is an advantage in suppressing a fluctuation in chromatic aberration during image shake correction. In a case where the vibration-proof group is configured to consist of one single lens, there is an advantage in reducing the weight.

It is preferable that the focusing group that moves along the optical axis Z during focusing is configured to be disposed closer to the image side than the aperture stop St. Focusing is performed by moving the focusing group. By disposing the focusing group closer to the image side than the aperture stop St, there is an advantage in reducing the size of the focusing group.

For example, the focusing group of the variable magnification optical system in FIG. 1 consists of the third lens group G3. In the lower part of FIG. 1, a bracket and an arrow in a left-to-right direction are given below a lens corresponding to the focusing group. The arrow in the left-to-right direction indicates a direction in which the focusing group moves during focusing from the infinite distance object to the nearby object. While the focusing group functions in the entire magnification range including the wide angle end state, the arrow is given in only the lower part of FIG. 1 to avoid complication of the drawing. The above illustration method related to the focusing group is the same for the drawings of other examples.

The third lens group G3 may be configured to have a negative refractive power. In this case, the focusing group may be configured to consist of the third lens group G3. Since the second lens group G2 is a group having a positive refractive power, by configuring the focusing group having a negative refractive power with the third lens group G3 having a relatively small lens diameter, there is an advantage in reducing the size of the focus unit, and thus there is an advantage in reducing the size of the entire system.

The third lens group G3 may be configured to consist of one single lens having a negative refractive power. In such a case, there is an advantage in reducing the size. In a case where the third lens group G3 is configured to consist of one single lens having a negative refractive power and the focusing group is configured to consist of the third lens group G3, it is more advantageous for reducing the size of the focus unit. For example, the third lens group G3 may be configured to consist of one negative lens having a concave surface facing the object side.

The fourth lens group G4 may be configured to have a positive refractive power. By configuring the fourth lens group G4 as a group having a positive refractive power, it is possible to further reduce the incidence angle of the off-axis principal ray on the image plane Sim while reducing the size.

The fourth lens group G4 may be configured to consist of one single lens having a positive refractive power. In such a case, it is possible to further reduce the incidence angle of the off-axis principal ray on the image plane Sim while further reducing the size. For example, the fourth lens group G4 may be configured to consist of one positive lens having a convex surface facing the image side.

The number of lenses included in the entire system may be configured to be 12 or less. In such a case, there is an advantage in reducing the size of the entire system.

Next, preferable configurations of the variable magnification optical system according to the embodiment of the present disclosure related to the conditional expressions will be described. In the following description of the conditional expressions, to avoid redundancy, duplicate descriptions of symbols will be omitted using the same symbols for the same definitions. Hereinafter, to avoid redundancy, the “variable magnification optical system according to the embodiment of the present disclosure” will be simply referred to as the “variable magnification optical system”.

It is preferable that the variable magnification optical system satisfies Conditional Expression (1). Here, a distance on the optical axis from a lens surface of the first lens group G1 closest to the object side to a lens surface of the second lens group G2 closest to the object side in a state where the infinite distance object is in focus at the wide angle end is denoted by DG1fG2f. A focal length of an entire system in a state where the infinite distance object is in focus at the wide angle end is denoted by fw. For example, FIG. 2 shows the distance DG1fG2f. By setting the corresponding value of Conditional Expression (1) not to be equal to or less than the lower limit value, there is an advantage in achieving a wide angle. By setting the corresponding value of Conditional Expression (1) not to be equal to or greater than the upper limit value, the distance between the lens closest to the object side in the first lens group G1 and the aperture stop St is not excessively long, and thus there is an advantage in reducing the size of the lens closest to the object side and reducing the size of the entire system.

$$1 < DG 1 fG 2 f / fw < 5 \qquad ( 1 )$$

In order to obtain more favorable characteristics, the lower limit value of Conditional Expression (1) is more preferably 1.2, further preferably 1.4, still more preferably 1.6, even more preferably 1.8, and yet more preferably 1.9. In order to obtain more favorable characteristics, the upper limit value of Conditional Expression (1) is more preferably 4, further preferably 3.4, still more preferably 3, even more preferably 2.6, and yet more preferably 2.4. For example, it is more preferable that the variable magnification optical system satisfies Conditional Expression (1-1).

$$1.8 < DG 1 fG 2 f / fw < 2.6 \qquad ( 1 - 1 )$$

In a case where a thickness of the first lens group G1 on the optical axis is denoted by DG1, it is preferable that the variable magnification optical system satisfies Conditional Expression (2). For example, FIG. 2 shows the thickness DG1. DG1 is a distance on the optical axis from a surface of the first lens group G1 closest to the object side to a surface of the first lens group G1 closest to the image side. By setting the corresponding value of Conditional Expression (2) not to be equal to or less than the lower limit value, there is an advantage in achieving both reduction in size of the entire system and a wide angle. By setting the corresponding value of Conditional Expression (2) not to be equal to or greater than the upper limit value, the thickness of the first lens group G1 is not excessively large, and thus there is an advantage in reducing the size of the first lens group G1 and the entire system.

$$0.4 < DG 1 / fw < 2.5 \qquad ( 2 )$$

In order to obtain more favorable characteristics, the lower limit value of Conditional Expression (2) is more preferably 0.5, further preferably 0.6, and still more preferably 0.7. In order to obtain more favorable characteristics, the upper limit value of Conditional Expression (2) is more preferably 2.2, further preferably 1.8, still more preferably 1.5, even more preferably 1.25, and yet more preferably 1. For example, it is more preferable that the variable magnification optical system satisfies Conditional Expression (2-1).

$$0.7 < DG 1 / fw < 1 \qquad ( 2 - 1 )$$

It is preferable that the variable magnification optical system satisfies Conditional Expression (3). A sum of a distance on the optical axis from a lens surface of the first lens group G1 closest to the object side to a lens surface of the fourth lens group G4 closest to the image side and a back focus of the entire system in terms of an air conversion distance in a state where the infinite distance object is in focus at the wide angle end is denoted by TLw. A maximum half angle of view in a state where the infinite distance object is in focus at the wide angle end is denoted by ωw. Here, tan indicates a tangent. For example, FIG. 1 shows the maximum half angle of view ow. By setting the corresponding value of Conditional Expression (3) not to be equal to or less than the lower limit value, there is an advantage in suppressing various aberrations at the wide angle end. By setting the corresponding value of Conditional Expression (3) not to be equal to or greater than the upper limit value, there is an advantage in shortening the total length of the optical system.

$$2 < TLw / ( fw \times tan ω w ) < 8 \qquad ( 3 )$$

In order to obtain more favorable characteristics, the lower limit value of Conditional Expression (3) is more preferably 2.5, further preferably 3, and still more preferably 3.5. In order to obtain more favorable characteristics, the upper limit value of Conditional Expression (3) is more preferably 7, further preferably 6, still more preferably 5.5, even more preferably 5, and yet more preferably 4.8. For example, it is more preferable that the variable magnification optical system satisfies Conditional Expression (3-1).

$$3 < TLw / ( fw \times tan ω w ) < 5.5 \qquad ( 3 - 1 )$$

In a case where a back focus of the entire system in terms of an air conversion distance at the wide angle end is denoted by Bfw, it is preferable that the variable magnification optical system satisfies Conditional Expression (4). By setting the corresponding value of Conditional Expression (4) not to be equal to or less than the lower limit value, the back focus is not excessively short, and thus it is easy to attach a mount replacement mechanism or the like. By setting the corresponding value of Conditional Expression (4) not to be equal to or greater than the upper limit value, the back focus is not excessively long, and thus there is an advantage in reducing the size.

$$0.2 < Bfw / ( fw \times tan ω w ) < 1.8 \qquad ( 4 )$$

In order to obtain more favorable characteristics, the lower limit value of Conditional Expression (4) is more preferably 0.3, further preferably 0.4, still more preferably 0.5, and even more preferably 0.6. In order to obtain more favorable characteristics, the upper limit value of Conditional Expression (4) is more preferably 1.5, further preferably 1.2, still more preferably 1, even more preferably 0.9, and yet more preferably 0.8.

It is preferable that the variable magnification optical system satisfies Conditional Expression (5). Here, a focal length of the vibration-proof group is denoted by fOIS. A focal length of the entire system in a state where the infinite distance object is in focus at the telephoto end is denoted by ft. By setting the corresponding value of Conditional Expression (5) not to be equal to or less than the lower limit value, there is an advantage in suppressing an aberration fluctuation during image shake correction. By setting the corresponding value of Conditional Expression (5) not to be equal to or greater than the upper limit value, it is possible to suppress a movement amount of the vibration-proof group during image shake correction, and thus there is an advantage in reducing the size.

$$0.5 < fOIS / ft < 6 \qquad ( 5 )$$

In order to obtain more favorable characteristics, the lower limit value of Conditional Expression (5) is more preferably 0.8, further preferably 1.1, still more preferably 1.3, even more preferably 1.5, and yet more preferably 1.8. In order to obtain more favorable characteristics, the upper limit value of Conditional Expression (5) is more preferably 5.5, further preferably 5, still more preferably 4.5, even more preferably 4, and yet more preferably 3.5.

In a case where a focal length of the first lens group G1 is denoted by f1, it is preferable that the variable magnification optical system satisfies Conditional Expression (6). By setting the corresponding value of Conditional Expression (6) not to be equal to or less than the lower limit value, a refractive power of the first lens group G1 is not excessively weak, and thus there is an advantage in reducing the size of the first lens group G1. By setting the corresponding value of Conditional Expression (6) not to be equal to or greater than the upper limit value, the refractive power of the first lens group G1 is not excessively strong, and thus there is an advantage in suppressing various aberrations such as field curvature at the wide angle end.

$$- 4 < f 1 / fw < - 0.8 \qquad ( 6 )$$

In order to obtain more favorable characteristics, the lower limit value of Conditional Expression (6) is more preferably −3.5, further preferably −3, still more preferably −2.5, even more preferably −2, and yet more preferably −1.8. In order to obtain more favorable characteristics, the upper limit value of Conditional Expression (6) is more preferably −0.9, further preferably −1, still more preferably −1.1, even more preferably −1.2, and yet more preferably −1.3.

In a case where a focal length of the second lens group G2 is denoted by f2, it is preferable that the variable magnification optical system satisfies Conditional Expression (7). By setting the corresponding value of Conditional Expression (7) not to be equal to or less than the lower limit value, a refractive power of the second lens group G2 is not excessively strong, and thus there is an advantage in suppressing various aberrations such as spherical aberration. By setting the corresponding value of Conditional Expression (7) not to be equal to or greater than the upper limit value, the refractive power of the second lens group G2 is not excessively weak, and thus there is an advantage in reducing the size of the entire system.

$$0.5 < f 2 / fw < 3 \qquad ( 7 )$$

In order to obtain more favorable characteristics, the lower limit value of Conditional Expression (7) is more preferably 0.6, further preferably 0.7, still more preferably 0.8, and even more preferably 0.9. In order to obtain more favorable characteristics, the upper limit value of Conditional Expression (7) is more preferably 2.6, further preferably 2.2, still more preferably 1.8, and even more preferably 1.5.

In a configuration in which the first lens disposed closest to the object side in the first lens group G1 is an aspherical lens having a negative refractive power, it is preferable that the variable magnification optical system satisfies Conditional Expression (8). Here, a refractive index of the first lens with respect to a d line is denoted by N1. An Abbe number of the first lens based on the d line is denoted by v1. By setting the corresponding value of Conditional Expression (8) not to be equal to or less than the lower limit value, there is an advantage in correcting field curvature. By setting the corresponding value of Conditional Expression (8) not to be equal to or greater than the upper limit value, it is possible to suppress an excessive correction of field curvature.

$$2.19 < N 1 + 0.01 \times ν1 < 2.29 \qquad ( 8 )$$

In order to obtain more favorable characteristics, the lower limit value of Conditional Expression (8) is more preferably 2.2 and further preferably 2.21. In order to obtain more favorable characteristics, the upper limit value of Conditional Expression (8) is more preferably 2.28 and further preferably 2.27.

In a configuration in which the first lens is an aspherical lens having a negative refractive power, it is preferable that the variable magnification optical system satisfies Conditional Expression (9). A partial dispersion ratio of the first lens between a g line and an F line is denoted by θ1. By setting the corresponding value of Conditional Expression (9) not to be equal to or less than the lower limit value, there is an advantage in preventing an insufficient correction of lateral chromatic aberration at the wide angle end. By setting the corresponding value of Conditional Expression (9) not to be equal to or greater than the upper limit value, it is possible to suppress an excessive correction of lateral chromatic aberration at the wide angle end.

$$0.65 < θ1 + 0.0 \; 025 \times ν1 < 0.7 \qquad ( 9 )$$

In order to obtain more favorable characteristics, the lower limit value of Conditional Expression (9) is more preferably 0.66 and further preferably 0.67. In order to obtain more favorable characteristics, the upper limit value of Conditional Expression (9) is more preferably 0.69 and further preferably 0.681.

In a configuration in which the first lens is an aspherical lens having a negative refractive power, it is preferable that the variable magnification optical system satisfies Conditional Expressions (8) and (9) at the same time. By satisfying Conditional Expressions (8) and (9) at the same time, it is possible to appropriately correct field curvature and lateral chromatic aberration.

In a configuration in which the second lens disposed second from the object side in the first lens group G1 is a negative lens, it is preferable that the variable magnification optical system satisfies Conditional Expression (10). Here, a refractive index of the second lens with respect to a d line is denoted by N2. An Abbe number of the second lens based on the d line is denoted by v2. By setting the corresponding value of Conditional Expression (10) not to be equal to or less than the lower limit value, there is an advantage in correcting field curvature. By setting the corresponding value of Conditional Expression (10) not to be equal to or greater than the upper limit value, it is possible to suppress an excessive correction of field curvature.

$$2.18 < N 2 + 0.01 \times ν2 < 2.4 \qquad ( 10 )$$

In order to obtain more favorable characteristics, the lower limit value of Conditional Expression (10) is more preferably 2.19, further preferably 2.2, still more preferably 2.209, and even more preferably 2.25. In order to obtain more favorable characteristics, the upper limit value of Conditional Expression (10) is more preferably 2.39, further preferably 2.38, still more preferably 2.37, and even more preferably 2.32.

In a configuration in which the second lens is a negative lens, it is preferable that the variable magnification optical system satisfies Conditional Expression (11). A partial dispersion ratio of the second lens between a g line and an F line is denoted by θ2. By setting the corresponding value of Conditional Expression (11) not to be equal to or less than the lower limit value, there is an advantage in preventing an insufficient correction of lateral chromatic aberration at the wide angle end. By setting the corresponding value of Conditional Expression (11) not to be equal to or greater than the upper limit value, it is possible to suppress an excessive correction of lateral chromatic aberration at the wide angle end.

$$0.65 < θ2 + 0.0 \; 025 \times ν2 < 0.79 \qquad ( 11 )$$

In order to obtain more favorable characteristics, the lower limit value of Conditional Expression (11) is more preferably 0.66, further preferably 0.67, still more preferably 0.68, and even more preferably 0.69. In order to obtain more favorable characteristics, the upper limit value of Conditional Expression (11) is more preferably 0.78, further preferably 0.772, still more preferably 0.765, and even more preferably 0.755.

In a configuration in which the second lens is a negative lens, it is preferable that the variable magnification optical system satisfies Conditional Expressions (10) and (11) at the same time. By satisfying Conditional Expressions (10) and (11) at the same time, it is possible to appropriately correct field curvature and lateral chromatic aberration.

In a configuration in which the second lens group G2 includes a plurality of positive lenses, it is preferable that the variable magnification optical system satisfies Conditional Expression (12). An average value of refractive indices of all positive lenses included in the second lens group G2 with respect to a d line is denoted by NG2p. An average value of Abbe numbers of all positive lenses included in the second lens group G2 based on the d line is denoted by vG2p. By setting the corresponding value of Conditional Expression (12) not to be equal to or less than the lower limit value, it is possible to suppress an excessive correction of spherical aberration. By setting the corresponding value of Conditional Expression (12) not to be equal to or greater than the upper limit value, there is an advantage in appropriately correcting spherical aberration and axial chromatic aberration.

$$2.16 < NG 2 p + 0.01 \times ν G 2 p < 2.36 \qquad ( 12 )$$

In order to obtain more favorable characteristics, the lower limit value of Conditional Expression (12) is more preferably 2.17, further preferably 2.18, and still more preferably 2.19. In order to obtain more favorable characteristics, the upper limit value of Conditional Expression (12) is more preferably 2.34, further preferably 2.32, and still more preferably 2.3.

In a configuration in which the second lens group G2 includes a plurality of positive lenses, it is preferable that the variable magnification optical system satisfies Conditional Expression (13). An average value of partial dispersion ratios of all positive lenses included in the second lens group G2 between a g line and an F line is denoted by θG2p. By setting the corresponding value of Conditional Expression (13) not to be equal to or less than the lower limit value, there is an advantage in correcting axial chromatic aberration. By setting the corresponding value of Conditional Expression (13) not to be equal to or greater than the upper limit value, it is possible to suppress an excessive correction of axial chromatic aberration.

$$0.68 < θ G 2 p + 0.0 \; 025 \times ν G 2 p < 0.76 \qquad ( 13 )$$

In order to obtain more favorable characteristics, the lower limit value of Conditional Expression (13) is more preferably 0.69, further preferably 0.7, and still more preferably 0.705. In order to obtain more favorable characteristics, the upper limit value of Conditional Expression (13) is more preferably 0.75, further preferably 0.74, and still more preferably 0.73.

In a configuration in which the second lens group G2 includes a plurality of positive lenses, it is preferable that the variable magnification optical system satisfies Conditional Expressions (12) and (13) at the same time. By satisfying Conditional Expressions (12) and (13) at the same time, it is possible to appropriately correct spherical aberration and axial chromatic aberration.

In a configuration in which a lens disposed closest to the image side in the second lens group G2 is a positive lens, it is preferable that the variable magnification optical system satisfies Conditional Expression (14). Here, a refractive index of the positive lens closest to the image side in the second lens group G2 with respect to a d line is denoted by NG2r. An Abbe number of the positive lens closest to the image side in the second lens group based on the d line is denoted by vG2r. By setting the corresponding value of Conditional Expression (14) not to be equal to or less than the lower limit value, it is possible to suppress an excessive correction of field curvature. By setting the corresponding value of Conditional Expression (14) not to be equal to or greater than the upper limit value, there is an advantage in appropriately correcting field curvature.

$$2.18 < NG 2 r + 0.01 \times ν G 2 r < 2.4 \qquad ( 14 )$$

In order to obtain more favorable characteristics, the lower limit value of Conditional Expression (14) is more preferably 2.19, further preferably 2.2, still more preferably 2.209, and even more preferably 2.25. In order to obtain more favorable characteristics, the upper limit value of Conditional Expression (14) is more preferably 2.39, further preferably 2.38, still more preferably 2.37, and even more preferably 2.32.

In a configuration in which a lens disposed closest to the image side in the second lens group G2 is a positive lens, it is preferable that the variable magnification optical system satisfies Conditional Expression (15). A partial dispersion ratio of the positive lens closest to the image side in the second lens group between a g line and an F line is denoted by θG2r. By setting the corresponding value of Conditional Expression (15) not to be equal to or less than the lower limit value, there is an advantage in correcting axial chromatic aberration. By setting the corresponding value of Conditional Expression (15) not to be equal to or greater than the upper limit value, it is possible to suppress an excessive correction of axial chromatic aberration.

$$0.7 < θ G 2 r + 0.0 \; 025 \times ν G 2 r < 0.76 \qquad ( 15 )$$

In order to obtain more favorable characteristics, the lower limit value of Conditional Expression (15) is more preferably 0.71. In order to obtain more favorable characteristics, the upper limit value of Conditional Expression (15) is more preferably 0.75.

In a configuration in which a lens disposed closest to the image side in the second lens group G2 is a positive lens, it is preferable that the variable magnification optical system satisfies Conditional Expressions (14) and (15) at the same time. By satisfying Conditional Expressions (14) and (15) at the same time, it is possible to appropriately correct field curvature and axial chromatic aberration.

It is preferable that the variable magnification optical system satisfies Conditional Expression (16). Here, a paraxial curvature radius of the lens surface of the second lens group G2 closest to the image side is denoted by RG2r. A paraxial curvature radius of the lens surface of the third lens group G3 closest to the object side is denoted by RG3f. By setting the corresponding value of Conditional Expression (16) not to be equal to or less than the lower limit value, it is easy to prevent the second lens group G2 and the third lens group G3 from coming into contact with each other without excessively increasing the spacing between the second lens group G2 and the third lens group G3, and thus there is an advantage in reducing the size. By setting the corresponding value of Conditional Expression (16) not to be equal to or greater than the upper limit value, there is an advantage in correcting various aberrations.

$$- 12 < ( RG 2 r + RG 3 f ) / ( RG 2 r - RG 3 f ) < - 0.5 \qquad ( 16 )$$

In order to obtain more favorable characteristics, the lower limit value of Conditional Expression (16) is more preferably −9, further preferably −8, still more preferably −7, even more preferably −6, and yet more preferably −5. In order to obtain more favorable characteristics, the upper limit value of Conditional Expression (16) is more preferably −1, further preferably −1.5, still more preferably −2, even more preferably −2.5, and yet more preferably −3.

It is preferable that the variable magnification optical system satisfies Conditional Expression (17). Here, a distance on the optical axis from the image plane Sim to a paraxial exit pupil position in a state where the infinite distance object is in focus at the wide angle end is denoted by Dexpw. A sign of Dexpw is defined with the image plane Sim as a reference such that a distance on the image side is positive and a distance on the object side is negative. Dexpw is calculated, in a case where an optical member not having a refractive power is disposed between the image plane Sim and the paraxial exit pupil position, by using an air conversion distance for the optical member. For example, FIG. 2 shows a paraxial exit pupil position Pexp in a state where the infinite distance object is in focus at the wide angle end of the variable magnification optical system of FIG. 1. By setting the corresponding value of Conditional Expression (17) not to be equal to or less than the lower limit value, the total length of the optical system can be easily shortened, and thus there is an advantage in reducing the size. By setting the corresponding value of Conditional Expression (17) not to be equal to or greater than the upper limit value, it is possible to further reduce the incidence angle of the off-axis principal ray on the image plane Sim, and thus there is an advantage in ensuring the peripheral light amount.

$$- 5 < D e xpw / fw < - 1.5 \qquad ( 17 )$$

In order to obtain more favorable characteristics, the lower limit value of Conditional Expression (17) is more preferably −4.5, further preferably −4, still more preferably −3.6, and even more preferably −3.2. In order to obtain more favorable characteristics, the upper limit value of Conditional Expression (17) is more preferably −1.8, further preferably −2.1, still more preferably −2.4, and even more preferably −2.7.

It is preferable that the variable magnification optical system satisfies Conditional Expression (18). By setting the corresponding value of Conditional Expression (18) not to be equal to or less than the lower limit value, the total length of the optical system can be easily shortened, and thus there is an advantage in reducing the size. By setting the corresponding value of Conditional Expression (18) not to be equal to or greater than the upper limit value, it is possible to further reduce the incidence angle of the off-axis principal ray on the image plane Sim, and thus there is an advantage in ensuring the peripheral light amount.

$$- 1 < D e xpw / TLw < - 0.3 \qquad ( 18 )$$

In order to obtain more favorable characteristics, the lower limit value of Conditional Expression (18) is more preferably −0.9, further preferably −0.8, still more preferably −0.7, and even more preferably −0.6. In order to obtain more favorable characteristics, the upper limit value of Conditional Expression (18) is more preferably −0.35, further preferably −0.4, still more preferably −0.45, and even more preferably −0.5.

It is preferable that the variable magnification optical system satisfies Conditional Expression (19). Here, a sum of the thickness of the first lens group G1 on the optical axis, a thickness of the second lens group G2 on the optical axis, a thickness of the third lens group G3 on the optical axis, and a thickness of the fourth lens group G4 on the optical axis is denoted by ThG. For example, FIG. 2 shows a thickness DG1 of the first lens group G1 on the optical axis, a thickness DG2 of the second lens group G2 on the optical axis, a thickness DG3 of the third lens group G3 on the optical axis, and a thickness DG4 of the fourth lens group G4 on the optical axis. A thickness of a lens group on the optical axis is a distance on the optical axis from a surface of the lens group closest to the object side to a surface of the lens group closest to the image side. By setting the corresponding value of Conditional Expression (19) not to be equal to or less than the lower limit value, the thickness of the entire system is not excessively thin, and thus there is an advantage in improving the workability. By setting the corresponding value of Conditional Expression (19) not to be equal to or greater than the upper limit value, the thickness of the entire system is not excessively thick, and thus there is an advantage in reducing the size.

$$0.5 < ThG / fw < 3.8 \qquad ( 19 )$$

In order to obtain more favorable characteristics, the lower limit value of Conditional Expression (19) is more preferably 0.7, further preferably 0.9, still more preferably 1.1, and even more preferably 1.3. In order to obtain more favorable characteristics, the upper limit value of Conditional Expression (19) is more preferably 3.5, further preferably 3.2, still more preferably 2.9, and even more preferably 2.5.

It is preferable that the variable magnification optical system satisfies Conditional Expression (20). By setting the corresponding value of Conditional Expression (20) not to be equal to or less than the lower limit value, the thickness of the entire system is not excessively thin, and thus there is an advantage in improving the workability. By setting the corresponding value of Conditional Expression (20) not to be equal to or greater than the upper limit value, the thickness of the entire system is not excessively thick, and thus there is an advantage in reducing the size.

$$0.15 < ThG / TLw < 0.7 \qquad ( 20 )$$

In order to obtain more favorable characteristics, the lower limit value of Conditional Expression (20) is more preferably 0.2, further preferably 0.25, still more preferably 0.3, and even more preferably 0.35. In order to obtain more favorable characteristics, the upper limit value of Conditional Expression (20) is more preferably 0.65, further preferably 0.6, still more preferably 0.55, and even more preferably 0.5.

In a case where an effective diameter of a lens surface of the first lens group G1 closest to the object side is denoted by EDL1f, it is preferable that the variable magnification optical system satisfies Conditional Expression (21). By setting the corresponding value of Conditional Expression (21) not to be equal to or less than the lower limit value, there is an advantage in achieving a wide angle. By setting the corresponding value of Conditional Expression (21) not to be equal to or greater than the upper limit value, the effective diameter of the lens surface of the first lens group G1 closest to the object side is not excessively large, and thus there is an advantage in reducing the size of the lens closest to the object side in the first lens group G1 and reducing the size of the entire system.

$$1.5 < EDL 1 f / fw < 2.5 \qquad ( 21 )$$

In order to obtain more favorable characteristics, the lower limit value of Conditional Expression (21) is more preferably 1.6, further preferably 1.7, and still more preferably 1.8. In order to obtain more favorable characteristics, the upper limit value of Conditional Expression (21) is more preferably 2.4, further preferably 2.3, and still more preferably 2.2.

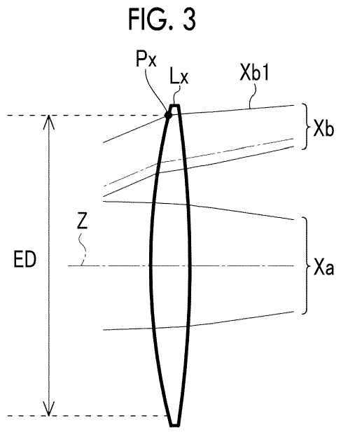

Here, the term “effective diameter” will be described with reference to FIG. 3. FIG. 3 is a diagram for description and shows a configuration in a cross section including the optical axis Z. In FIG. 3, a left side is the object side, and a right side is the image side. FIG. 3 shows an on-axis luminous flux Xa and an off-axis luminous flux Xb passing through a lens Lx. In the example in FIG. 3, a ray Xb1 that is an upper ray of the off-axis luminous flux Xb is a ray passing through the outermost side. The term “outer side” means an outer side in a radial direction centered on the optical axis Z, that is, a side away from the optical axis Z. In the present specification, an effective diameter ED is twice a distance from a position Px of an intersection between the ray passing through the outermost side and a lens surface to the optical axis Z. While the upper ray of the off-axis luminous flux Xb is the ray passing through the outermost side in the example in FIG. 3, which ray is the ray passing through the outermost side varies depending on the optical system.

It is preferable that the variable magnification optical system satisfies Conditional Expression (22). By setting the corresponding value of Conditional Expression (22) not to be equal to or less than the lower limit value, there is an advantage in achieving both a wide angle and reduction in size. By setting the corresponding value of Conditional Expression (22) not to be equal to or greater than the upper limit value, the effective diameter of the lens surface of the first lens group G1 closest to the object side is not excessively large, and thus there is an advantage in reducing the size of the lens closest to the object side in the first lens group G1 and reducing the size of the entire system.

$$0.2 < EDL 1 f / TLw < 0.6 \qquad ( 22 )$$

In order to obtain more favorable characteristics, the lower limit value of Conditional Expression (22) is more preferably 0.25, further preferably 0.3, and still more preferably 0.35. In order to obtain more favorable characteristics, the upper limit value of Conditional Expression (22) is more preferably 0.55, further preferably 0.5, and still more preferably 0.45.

It is preferable that the variable magnification optical system satisfies Conditional Expression (23). Here, a lateral magnification of the focusing group in a state where the infinite distance object is in focus at the telephoto end is denoted by βFoc. A combined lateral magnification of all lenses closer to the image side than the focusing group in a state where the infinite distance object is in focus at the telephoto end is denoted by βFocR. By setting the corresponding value of Conditional Expression (23) not to be equal to or less than the lower limit value, a ratio of a movement amount of an image plane position to a unit movement amount of the focusing group is not excessively small, and thus a movement amount of the focusing group during focusing is not excessively large. As a result, there is an advantage in achieving both high performance and reduction in size. By setting the corresponding value of Conditional Expression (23) not to be equal to or greater than the upper limit value, the ratio of the movement amount of the image plane position to the unit movement amount of the focusing group is not excessively large, and thus there is an advantage in achieving both the manufacturing suitability and reduction in size.

$$1 < \vert ( 1 - β {Foc}^{2} ) \times β {FocR}^{2} \vert < 10 \qquad ( 23 )$$

In order to obtain more favorable characteristics, the lower limit value of Conditional Expression (23) is more preferably 1.5 and further preferably 2. In order to obtain more favorable characteristics, the upper limit value of Conditional Expression (23) is more preferably 8, further preferably 6, and still more preferably 4.

It is preferable that the variable magnification optical system satisfies Conditional Expression (24). Here, a lateral magnification of the vibration-proof group in a state where the infinite distance object is in focus at the telephoto end is denoted by BOIS. A combined lateral magnification of all lenses closer to the image side than the vibration-proof group in a state where the infinite distance object is in focus at the telephoto end is denoted by βOISR. By setting the corresponding value of Conditional Expression (24) not to be equal to or less than the lower limit value, a ratio of the movement amount of the image plane position to a unit movement amount of the vibration-proof group is not excessively small, and thus a movement amount of the vibration-proof group during image shake correction is not excessively large. As a result, there is an advantage in achieving both high performance and reduction in size. By setting the corresponding value of Conditional Expression (24) not to be equal to or greater than the upper limit value, the ratio of the movement amount of the image plane position to the unit movement amount of the vibration-proof group is not excessively large, and thus there is an advantage in achieving both the manufacturing suitability and reduction in size.

$$0.6 < \vert ( 1 - β OIS ) \times β OISR \vert < 3.5 \qquad ( 24 )$$

In order to obtain more favorable characteristics, the lower limit value of Conditional Expression (24) is more preferably 0.7, further preferably 0.8, still more preferably 0.9, and even more preferably 1. In order to obtain more favorable characteristics, the upper limit value of Conditional Expression (24) is more preferably 3, further preferably 2.5, still more preferably 2, and even more preferably 1.5.

The above preferable configurations and available configurations including the configurations related to the conditional expressions can be used in any combination thereof without contradiction and it is preferable to selectively adopt in accordance with required specifications as appropriate.

For example, a preferred aspect of the present disclosure is a variable magnification optical system consisting of, in order from an object side to an image side, a first lens group G1 having a negative refractive power, a second lens group G2 having a positive refractive power, a third lens group G3, and a fourth lens group G4, in which Conditional Expressions (1), (2), (3), and (4) are satisfied, all spacings between adjacent lens groups change during changing magnification, the second lens group G2 includes an aperture stop St, a vibration-proof group that moves in a direction intersecting an optical axis Z during image shake correction is disposed adjacent to the aperture stop St, and a focusing group that moves along the optical axis Z during focusing is disposed closer to the image side than the aperture stop St.

Next, examples of the variable magnification optical system according to the embodiment of the present disclosure will be described with reference to the drawings. Reference numerals given to each group in the cross-sectional views of each example are independently used for each example to avoid complication of description and the drawings caused by an increasing number of digits of the reference numerals. Accordingly, a common reference numeral given in the drawings of different examples does not necessarily indicate a common configuration.

### Example 1

A configuration and a moving trajectory of the variable magnification optical system of Example 1 are shown in FIG. 1, and the illustration method and the configuration thereof are described above. Thus, duplicate descriptions will be partially omitted. The variable magnification optical system of Example 1 consists of, in order from the object side to the image side, the first lens group G1 having a negative refractive power, the second lens group G2 having a positive refractive power, the third lens group G3 having a negative refractive power, and the fourth lens group G4 having a positive refractive power.

During changing the magnification from the wide angle end to the telephoto end, the fourth lens group G4 is fixed with respect to the image plane Sim, and other lens groups move along the optical axis Z by changing their spacings with respect to their adjacent lens groups. The vibration-proof group consists of one cemented lens that is a lens in the second lens group G2 and is disposed adjacent to the image side of the aperture stop St. The focusing group consists of the third lens group G3. During focusing from the infinite distance object to the nearby object, the focusing group moves to the image side.

With respect to the variable magnification optical system according to Example 1, basic lens data is shown in Table 1, specifications and variable surface spacings are shown in Table 2, and aspherical coefficients are shown in Table 3.

The table of the basic lens data is described as follows. A column of “Sn” indicates surface numbers in a case where a surface closest to the object side is set as a first surface, and the number is increased by one at a time toward the image side. A column of “R” indicates a curvature radius of each surface. A column of “D” indicates a surface spacing on the optical axis between each surface and a surface adjacent to each surface on the image side. A column of “Nd” indicates a refractive index with respect to a d line for each constituent. A column of “vd” indicates an Abbe number based on the d line for each constituent. A column of “θgF” indicates a partial dispersion ratio of each constituent between a g line and an F line. A column of “ED” indicates an effective diameter of each surface. A column of “Material” indicates a material name and a manufacturer name of each constituent with a period therebetween. Here, the manufacturer name is schematically shown as follows, including the descriptions of the examples described later. “CDGM” indicates Chengdu Guangming Guangdian Co., Ltd. “NHG” indicates Hubei New Huaguang Information Materials Co., Ltd. “HOYA” indicates HOYA Corporation. “OHARA” indicates OHARA INC. “HIKARI” indicates HIKARI GLASS Co., Ltd.

In the table of the basic lens data, a sign of the curvature radius of a surface having a convex shape facing the object side is positive, and a sign of the curvature radius of a surface having a convex shape facing the image side is negative. The table of the basic lens data also shows the aperture stop St and the optical member PP. A field of the surface number of a surface corresponding to the aperture stop St shows the surface number and a text (St). A value in a lowermost field of the column of D in the table is a spacing between a surface closest to the image side in the table and the image plane Sim. A symbol DD[ ] is used for the variable surface spacings. A surface number on the object side of a spacing is shown in [ ] in the column of the surface spacing.

Table 2 shows a zoom ratio Zr, a focal length f, an open F-number FNo., a maximum full angle of view 2ω, and a variable surface spacing during changing the magnification, based on the d line. In a case where the variable magnification optical system is a zoom lens, the zoom ratio is synonymous with a zoom magnification. [°] in the fields of 2ω indicates that 2ω is in degree units. Table 2 shows each value in the wide angle end state, a middle focal length state, and the telephoto end state in columns labeled “Wide”, “Middle”, and “Tele”, respectively.

In the table of the basic lens data, the surface number of an aspherical surface is marked with *, and a field of the curvature radius of the aspherical surface shows a value of a paraxial curvature radius. In Table 3, a column of Sn indicates the surface number of the aspherical surface, and columns of KA and Am indicate numerical values of the aspherical coefficients for each aspherical surface. It should be noted that m of Am is an integer of 3 or more, and differs depending on the surface. For example, in the first surface of Example 1, m=3, 4, 5, . . . , and 20. The “E±n” (n: integer) in numerical values of the aspherical coefficients in Table 3 indicates “×10^{±n}”. KA and Am are aspherical coefficients in an aspheric equation represented by the following expression.

$$Z d = C \times {h}^{2} / \{ 1 + {( 1 - KA \times {C}^{2} \times {h}^{2} )}^{1 / 2} \} + \sum Am \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z),
h: a height (a distance from the optical axis Z to the lens surface),
C: a reciprocal of the paraxial curvature radius,
KA and Am: aspherical coefficients,
Σ in the aspheric equation means a sum total related to m.

In the data of each table, a degree unit is used for angles, and a millimeter unit is used for lengths. However, since the optical system can also be proportionally enlarged or proportionally reduced to be used, other appropriate units can also be used. In addition, each table below shows numerical values rounded to predetermined digits.

TABLE 1
Example 1

| Sn | R | D | Nd | vd | θgF | ED | Material |
|---|---|---|---|---|---|---|---|
| *1 | 80.8179 | 1.400 | 1.81000 | 40.99 | 0.56996 | 25.66 | D-ZLAF52LA.CDGM |
| *2 | 9.6107 | 5.750 | | | | 19.70 | |
| 3 | 337.7103 | 0.650 | 1.45860 | 90.17 | 0.53706 | 19.53 | H-FK90.NHG |
| 4 | 30.0739 | 1.107 | | | | 19.11 | |
| 5 | 23.0276 | 2.809 | 2.00100 | 29.13 | 0.59935 | 19.13 | H-ZLAF82.NHG |
| 6 | 88.0276 | DD[6] | | | | 18.67 | |
| *7 | 15.6344 | 2.355 | 1.62263 | 58.16 | 0.53913 | 9.29 | M-BACD15.HOYA |
| *8 | −200.2902 | 0.973 | | | | 9.07 | |
| 9(St) | ∞ | 2.545 | | | | 8.84 | |
| 10 | 25.1182 | 0.510 | 1.57135 | 52.95 | 0.55544 | 8.32 | S-BAL3.OHARA |
| 11 | 7.1429 | 2.895 | 1.52841 | 76.45 | 0.53954 | 8.00 | S-FPM4.OHARA |
| 12 | −82.7890 | 1.890 | | | | 7.68 | |
| 13 | −48.8513 | 0.500 | 1.95375 | 32.32 | 0.58998 | 7.00 | TAFD45L.HOYA |
| 14 | 26.2316 | 0.407 | | | | 7.34 | |
| *15 | 176.4199 | 2.334 | 1.49710 | 81.56 | 0.53848 | 7.56 | M-FCD1.HOYA |
| *16 | −10.0234 | DD[16] | | | | 8.56 | |
| *17 | −17.8964 | 1.000 | 1.63858 | 55.18 | 0.55320 | 11.04 | M-PCD55AR.HOYA |
| *18 | −54.4965 | DD[18] | | | | 11.99 | |
| 19 | −64.4358 | 3.118 | 1.77250 | 49.60 | 0.55165 | 24.09 | H-LAF50B.CDGM |
| 20 | −33.2708 | 8.779 | | | | 24.96 | |
| 21 | ∞ | 2.850 | 1.51680 | 64.20 | 0.53430 | | BSC7.HOYA |
| 22 | ∞ | 1.019 | | | | | |

TABLE 2
Example 1

| | Wide | Middle | Tele |
|---|---|---|---|
| Zr | 1.0 | 1.7 | 2.4 |
| f | 13.39 | 22.59 | 32.14 |
| FNo. | 3.60 | 4.70 | 6.49 |
| 2ω[°] | 100.37 | 64.36 | 47.84 |
| DD[6] | 19.541 | 5.995 | 0.748 |
| DD[16] | 2.103 | 2.652 | 2.125 |
| DD[18] | 7.159 | 16.007 | 27.471 |

TABLE 3
Example 1

| Sn | 1 | 2 | 7 | 8 |
|---|---|---|---|---|
| KA | 1.0000000E+00 | −1.2576327E+00 | 1.0000000E+00 | 1.0000000E+00 |
| A3 | 0.0000000E+00 | 0.0000000E+00 | 0.0000000E+00 | 0.0000000E+00 |
| A4 | 2.1012568E−05 | 2.1411688E−04 | −5.8138832E−05 | 5.2115154E−05 |
| A5 | −7.7154002E−06 | 1.3009244E−05 | −8.2599137E−05 | −1.9364378E−04 |
| A6 | 1.7080933E−06 | −3.7880744E−06 | 1.5160878E−04 | 2.6417734E−04 |
| A7 | −2.1756426E−07 | 8.7137638E−08 | −1.0520889E−04 | −1.9938527E−04 |
| A8 | −8.5649329E−09 | −4.3506732E−08 | 3.1154018E−05 | 9.0319412E−05 |
| A9 | 3.7228872E−09 | 1.8733356E−08 | −4.2416426E−07 | −2.3995235E−05 |
| A10 | −1.5212747E−10 | 4.9008102E−10 | −1.5709015E−06 | 2.8835559E−06 |
| A11 | −1.2193393E−11 | −9.1230189E−10 | −1.2579700E−07 | 2.5102621E−07 |
| A12 | 1.1023665E−12 | 9.2810580E−11 | 2.2348371E−07 | −1.3090376E−07 |
| A13 | −4.3556525E−14 | 4.5369491E−12 | −3.5033166E−08 | 5.9270436E−09 |
| A14 | −1.5987029E−15 | −5.4840004E−13 | −4.9586463E−09 | 4.7008870E−09 |
| A15 | 2.9261609E−16 | −6.2891178E−14 | 1.5164638E−09 | −7.8665774E−10 |
| A16 | 2.7916685E−17 | 1.4481801E−15 | 7.2960752E−11 | −8.9275024E−11 |
| A17 | −2.3966744E−18 | 3.6553939E−16 | −4.5340030E−11 | 3.6713556E−11 |
| A18 | −2.3464908E−19 | 8.4601918E−17 | 1.4634253E−12 | −2.6944496E−12 |
| A19 | 2.4534067E−20 | −1.2480594E−17 | 5.5452272E−13 | −1.3378376E−13 |
| A20 | −5.7215952E−22 | 4.1462965E−19 | −4.4593199E−14 | 1.7530908E−14 |
| Sn | 15 | 16 | 17 | 18 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.1398550E−04 | 1.8363783E−04 | 5.7486710E−04 | 3.9005594E−04 |
| A5 | 5.3420106E−05 | −5.3565754E−05 | 3.2944246E−05 | 1.8236010E−04 |
| A6 | −1.3700316E−04 | −5.8001649E−05 | −6.0502620E−05 | −1.3511387E−04 |
| A7 | 1.0164413E−04 | 1.0175447E−04 | 2.1279814E−05 | 4.6377533E−05 |
| A8 | −1.9158104E−05 | −5.0747364E−05 | −2.2419247E−06 | −1.0178646E−05 |
| A9 | −9.3980369E−06 | 5.9385136E−06 | −7.0186849E−07 | 1.1660027E−06 |
| A10 | 5.0972752E−06 | 3.5014757E−06 | 1.2434213E−07 | 1.0143922E−07 |
| A11 | −7.5625248E−07 | −1.2011516E−06 | 2.5168952E−08 | −5.9809737E−08 |
| A12 | 8.4908220E−08 | 2.6232319E−08 | −3.3569391E−09 | −2.6107370E−09 |
| A13 | −4.3576269E−08 | 4.1927156E−08 | −1.1102496E−09 | 4.7845188E−09 |
| A14 | −1.5779686E−10 | −8.0413057E−09 | 2.1787417E−11 | −6.1983538E−10 |
| A15 | 6.8518575E−09 | 4.5258474E−10 | 5.4781343E−11 | −6.8386384E−11 |
| A16 | −2.2294729E−09 | 3.2406146E−10 | −2.0779017E−12 | 1.3525400E−11 |
| A17 | 3.1100172E−10 | −1.1569486E−10 | −5.6043511E−13 | 2.2469223E−12 |
| A18 | −8.1371143E−12 | 9.5896802E−12 | −2.0935901E−13 | −6.7140193E−13 |
| A19 | −3.9199543E−12 | 9.9684710E−13 | 5.2966254E−14 | 5.6640015E−14 |
| A20 | 4.2667275E−13 | −1.3848411E−13 | −3.0093282E−15 | −1.6499314E−15 |

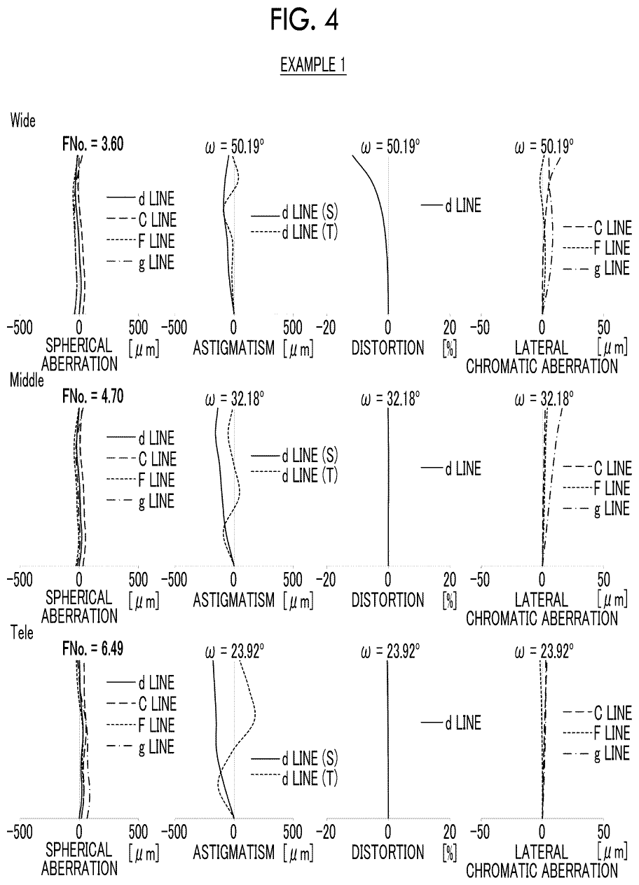

FIG. 4 shows each aberration diagram of the variable magnification optical system of Example 1 in a state where the infinite distance object is in focus. FIG. 4 shows, in order from the left, spherical aberration, astigmatism, distortion, and lateral chromatic aberration. In FIG. 4, an upper part labeled “Wide” indicates aberration in the wide angle end state, a middle part labeled “Middle” indicates aberration in the middle focal length state, and a lower part labeled “Tele” indicates aberration in the telephoto end state. In the spherical aberration diagram, aberration on a d line, a C line, an F line, and a g line is shown by a solid line, a long broken line, a short broken line, and a dot dash line, respectively. In the astigmatism diagram, aberration on a d line in a sagittal direction is shown by a solid line, and aberration on a d line in a tangential direction is shown by a short broken line. In the distortion diagram, aberration on a d line is shown by a solid line. In the lateral chromatic aberration diagram, aberration on a C line, an F line, and a g line is shown by a long broken line, a short broken line, and a dot dash line, respectively. In the spherical aberration diagram, a value of the open F-number is shown after FNo.=. In other aberration diagrams, a value of the maximum half angle of view is shown after ω=.

Symbols, meanings, description methods, and illustration methods of each data related to Example 1 are basically the same for the following examples unless otherwise specified. Thus, duplicate descriptions will be omitted below.

### Example 2

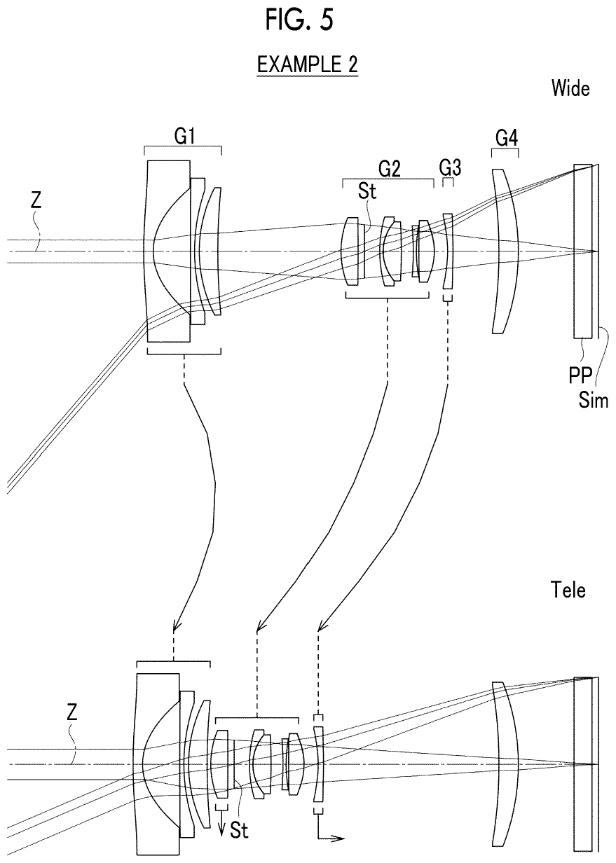

A configuration and a moving trajectory of a variable magnification optical system of Example 2 are shown in FIG. 5. The variable magnification optical system of Example 2 consists of, in order from the object side to the image side, the first lens group G1 having a negative refractive power, the second lens group G2 having a positive refractive power, the third lens group G3 having a negative refractive power, and the fourth lens group G4 having a positive refractive power.

During changing the magnification from the wide angle end to the telephoto end, the fourth lens group G4 is fixed with respect to the image plane Sim, and other lens groups move along the optical axis Z by changing their spacings with respect to their adjacent lens groups. The vibration-proof group consists of one single lens that is a lens in the second lens group G2 and is disposed adjacent to the object side of the aperture stop St. The focusing group consists of the third lens group G3. During focusing from the infinite distance object to the nearby object, the focusing group moves to the image side.

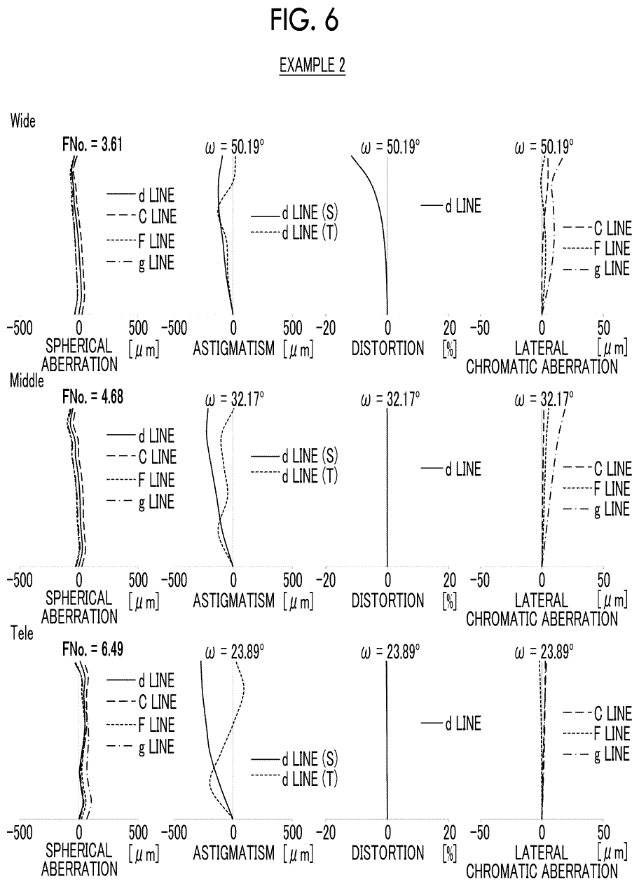

With respect to the variable magnification optical system according to Example 2, basic lens data is shown in Table 4, specifications and variable surface spacings are shown in Table 5, aspherical coefficients are shown in Table 6, and each aberration diagram is shown in FIG. 6.

TABLE 4
Example 2

| Sn | R | D | Nd | vd | θgF | ED | Material |
|---|---|---|---|---|---|---|---|
| *1 | 82.4182 | 1.500 | 1.81000 | 40.99 | 0.56996 | 25.74 | D-ZLAF52LA.CDGM |
| *2 | 9.4507 | 5.850 | | | | 19.68 | |
| 3 | 1015.2124 | 0.660 | 1.45860 | 90.17 | 0.53706 | 19.53 | H-FK90.NHG |
| 4 | 31.7149 | 0.740 | | | | 19.18 | |
| 5 | 23.3414 | 2.920 | 2.00100 | 29.13 | 0.59935 | 19.24 | H-ZLAF82.NHG |
| 6 | 110.7088 | DD[6] | | | | 18.76 | |
| *7 | 14.8019 | 2.680 | 1.58313 | 59.38 | 0.54237 | 9.30 | L-BAL42.OHARA |
| *8 | −292.1140 | 1.000 | | | | 8.96 | |
| 9(St) | ∞ | 2.420 | | | | 8.70 | |
| 10 | 20.7342 | 0.540 | 1.56883 | 56.04 | 0.54960 | 8.27 | H-BAK7.CDGM |
| 11 | 7.4820 | 2.850 | 1.49700 | 81.61 | 0.53887 | 7.96 | FCD1.HOYA |
| 12 | −92.4697 | 1.890 | | | | 7.65 | |
| 13 | −49.3088 | 0.500 | 1.85883 | 30.00 | 0.59793 | 7.05 | NBFD30.HOYA |
| 14 | 25.5757 | 0.380 | | | | 7.41 | |
| *15 | 259.4380 | 2.430 | 1.49710 | 81.56 | 0.53848 | 7.58 | M-FCD1.HOYA |
| *16 | −10.3926 | DD[16] | | | | 8.64 | |
| *17 | −17.8221 | 0.850 | 1.69350 | 53.20 | 0.54661 | 11.09 | M-LAC130.HOYA |
| *18 | −47.3864 | DD[18] | | | | 11.94 | |
| 19 | −80.9757 | 3.050 | 1.83481 | 42.72 | 0.56434 | 24.39 | H-ZLAF55D.CDGM |
| 20 | −37.7369 | 8.769 | | | | 25.20 | |
| 21 | ∞ | 2.850 | 1.51680 | 64.20 | 0.53430 | | BSC7.HOYA |
| 22 | ∞ | 1.014 | | | | | |

TABLE 5
Example 2

| | Wide | Middle | Tele |
|---|---|---|---|
| Zr | 1.0 | 1.7 | 2.4 |
| f | 13.39 | 22.59 | 32.14 |
| FNo. | 3.61 | 4.68 | 6.49 |
| 2ω[°] | 100.38 | 64.34 | 47.79 |
| DD[6] | 19.330 | 5.614 | 0.577 |
| DD[16] | 2.100 | 2.905 | 2.143 |
| DD[18] | 7.240 | 15.617 | 27.633 |

TABLE 6
Example 2

| Sn | 1 | 2 | 7 | 8 |
|---|---|---|---|---|
| KA | 1.0000000E+00 | −1.2578218E+00 | 1.0000000E+00 | 1.0000000E+00 |
| A3 | 0.0000000E+00 | 0.0000000E+00 | 0.0000000E+00 | 0.0000000E+00 |
| A4 | −1.5758296E−05 | 1.8980128E−04 | −4.2748386E−05 | 2.2908357E−04 |
| A5 | −4.2722857E−06 | 6.9333947E−06 | −2.3838568E−05 | −5.1538069E−04 |
| A6 | 1.3827365E−06 | 2.3751538E−06 | 4.8173037E−05 | 6.0583227E−04 |
| A7 | 2.7601200E−07 | −2.1395860E−06 | −2.7625429E−05 | −4.0464394E−04 |
| A8 | −1.2898125E−07 | 4.4879179E−07 | 4.3645433E−06 | 1.5920291E−04 |
| A9 | 1.1676532E−08 | −1.4815714E−08 | 1.8914443E−06 | −3.3320416E−05 |
| A10 | 3.7632516E−10 | −8.1201271E−09 | −8.1534488E−07 | 7.9217748E−07 |
| A11 | −9.5350878E−11 | 6.3804378E−10 | 5.9509296E−08 | 1.6854508E−06 |
| A12 | 2.8017530E−12 | 1.2030287E−10 | 5.8783802E−09 | −4.6772213E−07 |
| A13 | 1.3970203E−14 | −1.7011405E−11 | 3.8144137E−09 | 1.6116630E−09 |
| A14 | 5.4895961E−15 | 1.9090623E−13 | −1.1555618E−09 | 2.8115110E−08 |
| A15 | −3.6080615E−16 | 1.2860516E−13 | −6.1395863E−11 | −6.1937566E−09 |
| A16 | 7.6383997E−17 | −2.0572044E−14 | 7.9507032E−11 | 8.2595849E−10 |
| A17 | −7.4237576E−18 | 6.3670468E−16 | −2.4992439E−11 | −3.2258594E−10 |
| A18 | −7.0231664E−20 | 2.1139314E−16 | 4.9070482E−12 | 9.9051398E−11 |
| A19 | 2.8048284E−20 | −2.3165833E−17 | −5.1546810E−13 | −1.3307353E−11 |
| A20 | −7.5613701E−22 | 6.9499628E−19 | 2.1427166E−14 | 6.5210588E−13 |
| Sn | 15 | 16 | 17 | 18 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.4868788E−05 | 2.1236361E−04 | 6.7284450E−04 | 5.0964794E−04 |
| A5 | 2.9357291E−05 | 2.6784326E−06 | 1.2767004E−04 | 1.4107929E−04 |
| A6 | −1.3083393E−04 | −5.2276839E−05 | −1.9463873E−04 | −8.6485499E−05 |
| A7 | 9.2318048E−05 | 3.8119100E−05 | 7.8501994E−05 | −1.3786593E−05 |
| A8 | −2.7647581E−05 | −1.2755999E−05 | −1.7404679E−05 | 1.7432284E−05 |
| A9 | 6.7727660E−06 | 1.5289661E−06 | 3.6636666E−06 | −2.9821038E−06 |
| A10 | −2.6120221E−06 | 8.0528407E−07 | −8.8518911E−07 | −4.0603649E−07 |
| A11 | 6.5479176E−07 | −3.3588241E−07 | 1.0697126E−07 | 1.3768870E−07 |
| A12 | −1.1307989E−07 | −2.1735833E−08 | −8.5053139E−09 | −5.1524681E−09 |
| A13 | 4.9876183E−08 | 3.3406636E−08 | 5.8251242E−09 | 8.3497718E−10 |
| A14 | −7.6351635E−09 | −5.1234064E−09 | −1.4218854E−09 | −3.4827231E−10 |
| A15 | −2.6185248E−09 | −2.2947435E−10 | 6.8822601E−11 | −3.7198148E−11 |
| A16 | 2.6061525E−10 | 5.7543228E−11 | 9.2179104E−12 | 1.4258190E−11 |
| A17 | 1.8250269E−10 | 1.6347716E−11 | −9.1297499E−13 | −7.0653083E−13 |
| A18 | −1.1560435E−11 | −3.9072853E−12 | 1.4864022E−13 | 4.8909269E−14 |
| A19 | −6.8349634E−12 | 3.3566418E−13 | −2.8495731E−14 | −1.7707666E−14 |
| A20 | 7.8206959E−13 | −1.5935713E−14 | 1.5716625E−15 | 1.2089564E−15 |

### Example 3

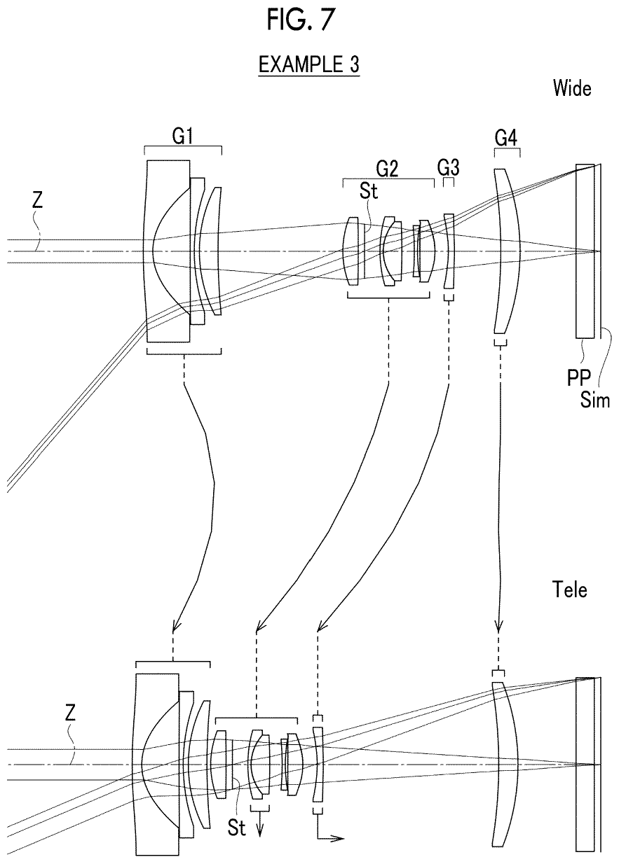

A configuration and a moving trajectory of a variable magnification optical system of Example 3 are shown in FIG. 7. The variable magnification optical system of Example 3 consists of, in order from the object side to the image side, the first lens group G1 having a negative refractive power, the second lens group G2 having a positive refractive power, the third lens group G3 having a negative refractive power, and the fourth lens group G4 having a positive refractive power.

During changing the magnification from the wide angle end to the telephoto end, all lens groups move along the optical axis Z by changing a spacing with respect to an adjacent lens group. The vibration-proof group consists of one cemented lens that is a lens in the second lens group G2 and is disposed adjacent to the image side of the aperture stop St. The focusing group consists of the third lens group G3. During focusing from the infinite distance object to the nearby object, the focusing group moves to the image side.

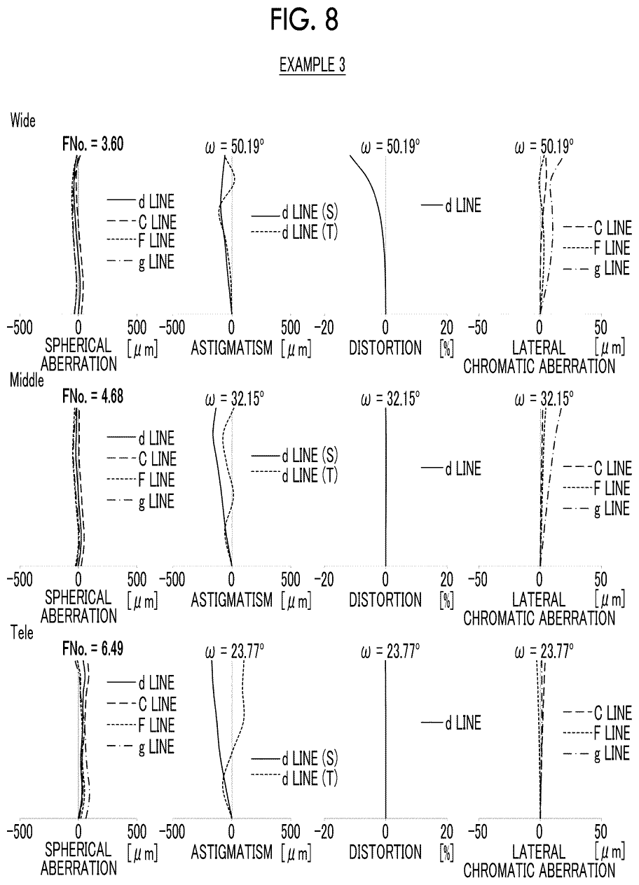

With respect to the variable magnification optical system according to Example 3, basic lens data is shown in Table 7, specifications and variable surface spacings are shown in Table 8, aspherical coefficients are shown in Table 9, and each aberration diagram is shown in FIG. 8.

TABLE 7
Example 3

| Sn | R | D | Nd | vd | θgF | ED | Material |
|---|---|---|---|---|---|---|---|
| *1 | 82.4793 | 1.500 | 1.81000 | 40.99 | 0.56996 | 25.71 | D-ZLAF52LA.CDGM |
| *2 | 9.4393 | 5.850 | | | | 19.67 | |
| 3 | 1199.0939 | 0.650 | 1.45650 | 90.27 | 0.53501 | 19.52 | H-FK71.CDGM |
| 4 | 31.7373 | 0.795 | | | | 19.16 | |
| 5 | 23.3038 | 2.924 | 2.00100 | 29.13 | 0.59935 | 19.22 | H-ZLAF82.NHG |
| 6 | 108.4912 | DD[6] | | | | 18.78 | |
| *7 | 14.7100 | 2.412 | 1.58313 | 59.38 | 0.54237 | 9.31 | L-BAL42.OHARA |
| *8 | −294.0458 | 0.988 | | | | 9.04 | |
| 9(St) | ∞ | 2.420 | | | | 8.81 | |
| 10 | 20.7671 | 0.517 | 1.56883 | 56.04 | 0.54831 | 8.34 | H-BAK7B.NHG |
| 11 | 7.3931 | 2.911 | 1.49700 | 81.61 | 0.53887 | 8.03 | FCD1.HOYA |
| 12 | −93.5004 | 1.945 | | | | 7.69 | |
| 13 | −49.2060 | 0.503 | 1.85883 | 30.00 | 0.59793 | 7.05 | NBFD30.HOYA |
| 14 | 25.5370 | 0.380 | | | | 7.41 | |
| *15 | 269.1657 | 2.357 | 1.49710 | 81.56 | 0.53848 | 7.57 | M-FCD1.HOYA |
| *16 | −10.4476 | DD[16] | | | | 8.60 | |
| *17 | −17.8134 | 0.943 | 1.69350 | 53.18 | 0.54831 | 11.06 | L-LAL13.OHARA |
| *18 | −47.3171 | DD[18] | | | | 11.95 | |
| 19 | −81.8303 | 3.016 | 1.83481 | 42.74 | 0.56490 | 24.25 | S-LAH55VS.OHARA |
| 20 | −38.1527 | DD[20] | | | | 25.04 | |
| 21 | ∞ | 2.850 | 1.51680 | 64.20 | 0.53430 | | BSC7.HOYA |
| 22 | ∞ | 1.011 | | | | | |

TABLE 8
Example 3

| | Wide | Middle | Tele |
|---|---|---|---|
| Zr | 1.0 | 1.7 | 2.4 |
| f | 13.39 | 22.59 | 32.27 |
| FNo. | 3.60 | 4.68 | 6.49 |
| 2ω[°] | 100.38 | 64.30 | 47.53 |
| DD[6] | 19.463 | 5.810 | 0.582 |
| DD[16] | 2.097 | 2.730 | 2.174 |
| DD[18] | 7.274 | 15.716 | 27.487 |
| DD[20] | 8.774 | 9.078 | 9.096 |

TABLE 9
Example 3

| Sn | 1 | 2 | 7 | 8 |
|---|---|---|---|---|
| KA | 1.0000000E+00 | −1.2532307E+00 | 1.0000000E+00 | 1.0000000E+00 |
| A3 | 0.0000000E+00 | 0.0000000E+00 | 0.0000000E+00 | 0.0000000E+00 |
| A4 | 3.3742483E−06 | 2.0650589E−04 | −5.7639307E−05 | 7.5721822E−05 |
| A5 | −5.4529466E−06 | 9.5792495E−06 | −2.3803009E−05 | −2.0098642E−04 |
| A6 | 1.1504713E−06 | −7.6708682E−07 | 3.7494469E−05 | 2.2374124E−04 |
| A7 | −3.3807173E−08 | −1.0790481E−06 | −1.9112745E−05 | −1.4747825E−04 |
| A8 | −2.8495115E−08 | 1.9991674E−07 | 3.3357121E−06 | 6.4475394E−05 |
| A9 | 2.6888372E−09 | 3.1220113E−09 | 5.1236858E−07 | −1.9055959E−05 |
| A10 | 1.7190386E−10 | −3.4829268E−09 | −2.9966598E−07 | 2.7977435E−06 |
| A11 | −2.0344378E−11 | −7.8597148E−12 | 4.7926417E−08 | 6.0331115E−07 |
| A12 | −4.4834106E−13 | 4.6695154E−11 | −5.0371421E−09 | −4.4909477E−07 |
| A13 | −6.7907788E−14 | 2.3298629E−12 | 4.2971358E−11 | 9.9080497E−08 |
| A14 | 1.5963052E−14 | −1.5239670E−12 | 1.8504372E−10 | −7.4861219E−09 |
| A15 | 3.4488724E−16 | 2.9601845E−13 | 6.2424854E−11 | 4.5621756E−10 |
| A16 | −1.1265619E−16 | −3.9982792E−14 | −3.6811326E−11 | −4.3533062E−10 |
| A17 | 1.2985335E−18 | 2.2155250E−15 | 1.8040056E−12 | 9.8974766E−11 |
| A18 | 3.7603833E−19 | 1.0537612E−16 | 1.2945891E−12 | −4.2680156E−12 |
| A19 | −1.9238108E−20 | −1.7162954E−17 | −2.3019055E−13 | −7.7880881E−13 |
| A20 | 2.9612246E−22 | 5.3253401E−19 | 1.1601038E−14 | 6.6843872E−14 |
| Sn | 15 | 16 | 17 | 18 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −4.4478349E−05 | 2.2859528E−04 | 6.3219280E−04 | 5.0189734E−04 |
| A5 | −1.5153512E−05 | −1.0811358E−05 | 1.0384341E−04 | 1.0094413E−04 |
| A6 | −7.6189217E−05 | −1.0865587E−04 | −1.1202620E−04 | −3.2192216E−05 |
| A7 | 1.2936400E−04 | 1.0914407E−04 | 2.1843168E−05 | −3.6794327E−05 |
| A8 | −1.0735452E−04 | −4.1554507E−05 | 3.2581715E−06 | 2.1186244E−05 |
| A9 | 4.9758488E−05 | 3.2447771E−06 | −1.9249951E−06 | −3.2817611E−06 |
| A10 | −9.7779398E−06 | 1.7299213E−06 | 2.8247968E−07 | −3.4210052E−07 |
| A11 | −5.8163180E−07 | −8.7905138E−08 | −1.7510094E−08 | 1.3466629E−07 |
| A12 | −6.3653419E−08 | −1.1837748E−07 | −4.5088125E−09 | −4.8978611E−09 |
| A13 | 4.4896379E−07 | −1.5807056E−10 | 1.3273029E−09 | −1.2165534E−10 |
| A14 | −1.3356181E−07 | 6.9470018E−09 | 2.1454377E−10 | −4.5153794E−10 |
| A15 | −4.7478285E−10 | −4.5287630E−10 | −7.2457275E−11 | 8.9907415E−11 |
| A16 | 2.8082356E−09 | −3.5015146E−11 | −8.2619555E−13 | −7.4683263E−12 |
| A17 | 1.4195365E−09 | −2.3375158E−11 | −2.2938958E−13 | 6.2310771E−13 |
| A18 | −6.4310975E−10 | 3.2001629E−12 | 4.9276047E−13 | −2.8040646E−14 |
| A19 | 9.0603421E−11 | 3.4117773E−13 | −7.3610739E−14 | −4.6908321E−15 |
| A20 | −4.5036189E−12 | −4.6901806E−14 | 3.2037311E−15 | 4.1977941E−16 |

### Example 4

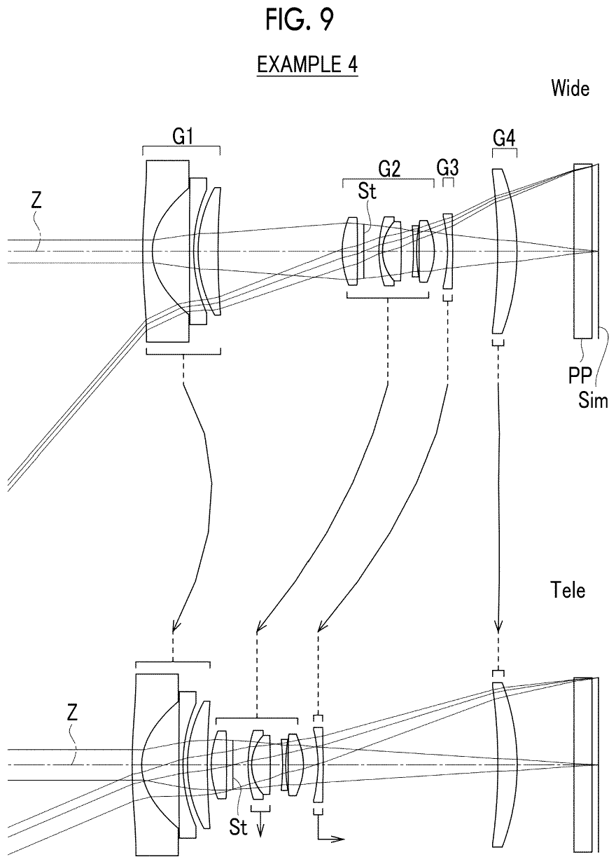

A configuration and a moving trajectory of a variable magnification optical system of Example 4 are shown in FIG. 9. The variable magnification optical system of Example 4 consists of, in order from the object side to the image side, the first lens group G1 having a negative refractive power, the second lens group G2 having a positive refractive power, the third lens group G3 having a negative refractive power, and the fourth lens group G4 having a positive refractive power.

During changing the magnification from the wide angle end to the telephoto end, all lens groups move along the optical axis Z by changing a spacing with respect to an adjacent lens group. The vibration-proof group consists of one cemented lens that is a lens in the second lens group G2 and is disposed adjacent to the image side of the aperture stop St. The focusing group consists of the third lens group G3. During focusing from the infinite distance object to the nearby object, the focusing group moves to the image side.

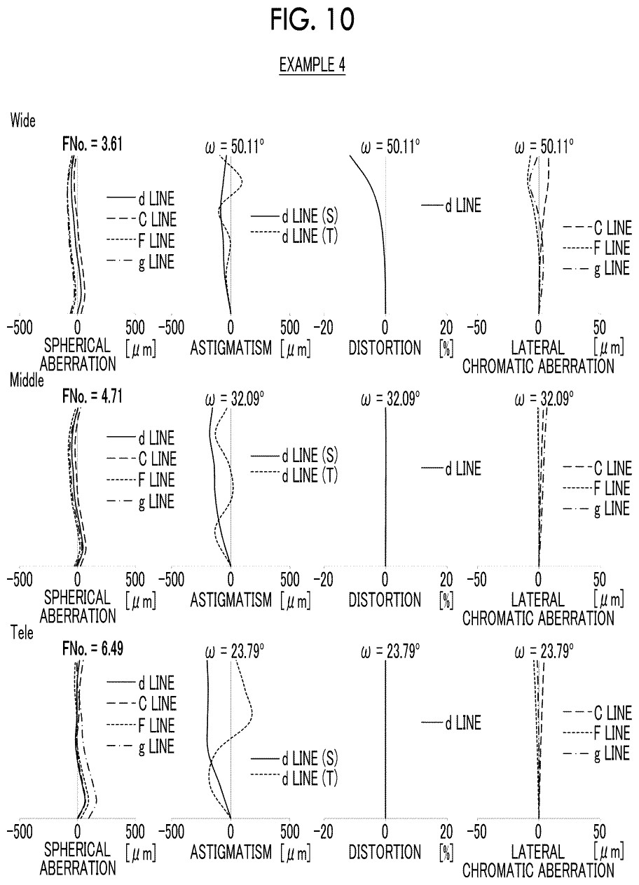

With respect to the variable magnification optical system according to Example 4, basic lens data is shown in Table 10, specifications and variable surface spacings are shown in Table 11, aspherical coefficients are shown in Table 12, and each aberration diagram is shown in FIG. 10.

TABLE 10
Example 4

| Sn | R | D | Nd | vd | θgF | ED | Material |
|---|---|---|---|---|---|---|---|
| *1 | 91.5144 | 1.500 | 1.80610 | 40.73 | 0.56940 | 25.70 | M-NBFD130.HOYA |
| *2 | 9.6012 | 5.850 | | | | 19.67 | |
| 3 | 1219.4488 | 0.650 | 1.43700 | 95.10 | 0.53364 | 19.51 | FCD100.HOYA |
| 4 | 25.5509 | 0.700 | | | | 19.08 | |
| 5 | 21.8652 | 3.126 | 1.95375 | 32.32 | 0.58998 | 19.19 | TAFD45L.HOYA |
| 6 | 129.8501 | DD[6] | | | | 18.79 | |
| *7 | 14.7963 | 2.404 | 1.58313 | 59.38 | 0.54237 | 9.31 | L-BAL42.OHARA |
| *8 | −290.6970 | 0.993 | | | | 9.03 | |
| 9(St) | ∞ | 2.386 | | | | 8.79 | |
| 10 | 18.8666 | 0.566 | 1.58913 | 61.25 | 0.54017 | 8.33 | H-ZK3A.CDGM |
| 11 | 7.2444 | 2.936 | 1.49700 | 81.61 | 0.53887 | 8.00 | FCD1.HOYA |
| 12 | −105.1917 | 1.921 | | | | 7.67 | |
| 13 | −41.5310 | 0.500 | 1.85013 | 30.06 | 0.59836 | 7.05 | H-ZLAF76.NHG |
| 14 | 25.6416 | 0.380 | | | | 7.43 | |
| *15 | 282.5144 | 2.404 | 1.49710 | 81.56 | 0.53848 | 7.60 | M-FCD1.HOYA |
| *16 | −10.0442 | DD[16] | | | | 8.64 | |
| *17 | −17.3754 | 0.800 | 1.62263 | 58.16 | 0.53913 | 11.13 | M-BACD15.HOYA |
| *18 | −54.0124 | DD[18] | | | | 12.02 | |
| 19 | −99.4493 | 3.033 | 1.77250 | 49.62 | 0.55038 | 24.41 | TAF1.HOYA |
| 20 | −39.1045 | DD[20] | | | | 25.13 | |
| 21 | ∞ | 2.850 | 1.51680 | 64.20 | 0.53430 | | BSC7.HOYA |
| 22 | ∞ | 1.019 | | | | | |

TABLE 11
Example 4

| | Wide | Middle | Tele |
|---|---|---|---|
| Zr | 1.0 | 1.7 | 2.4 |
| f | 13.42 | 22.65 | 32.22 |
| FNo. | 3.61 | 4.71 | 6.49 |
| 2ω[°] | 100.23 | 64.18 | 47.57 |
| DD[6] | 19.442 | 5.975 | 0.615 |
| DD[16] | 2.088 | 2.610 | 2.218 |
| DD[18] | 7.070 | 16.288 | 27.461 |
| DD[20] | 8.946 | 8.770 | 8.918 |

TABLE 12
Example 4

| Sn | 1 | 2 | 7 | 8 |
|---|---|---|---|---|
| KA | 1.0000000E+00 | −1.3566618E+00 | 1.0000000E+00 | 1.0000000E+00 |
| A3 | 0.0000000E+00 | 0.0000000E+00 | 0.0000000E+00 | 0.0000000E+00 |
| A4 | 8.1330764E−06 | 1.9309756E−04 | −7.4611335E−05 | 2.8116853E−04 |
| A5 | −8.3287933E−06 | 2.9061046E−05 | 8.3063543E−06 | −8.1648803E−04 |
| A6 | 5.9516989E−06 | −7.4023826E−06 | 2.5004818E−05 | 1.0631778E−03 |
| A7 | −1.6239083E−06 | 1.2602516E−06 | −2.2207807E−05 | −7.5853454E−04 |
| A8 | 1.4335395E−07 | −4.2515692E−07 | 7.0701743E−06 | 2.9731645E−04 |
| A9 | 9.9303080E−09 | 7.0144182E−08 | −6.4717138E−07 | −5.2436522E−05 |
| A10 | −2.7504496E−09 | −1.7874874E−09 | −6.8389396E−08 | −6.6221964E−07 |
| A11 | 1.3437489E−10 | −1.7083565E−11 | −2.0158311E−08 | 2.4036071E−07 |
| A12 | 7.0170422E−12 | −1.8922288E−10 | 1.2320993E−08 | 7.4071747E−07 |
| A13 | −6.3876980E−13 | 2.6992554E−11 | −8.1753058E−10 | −1.7647707E−07 |
| A14 | −1.8109311E−14 | 9.0696064E−13 | −1.3997987E−10 | −7.8284510E−09 |
| A15 | 1.4281306E−15 | −3.5292184E−13 | 2.4271903E−12 | 3.3940054E−09 |
| A16 | 8.6955140E−17 | 1.2563338E−14 | −6.7456935E−12 | 1.0625758E−09 |
| A17 | 4.3631325E−18 | 2.5881208E−16 | 4.6685926E−12 | −2.7475366E−10 |
| A18 | −1.4395618E−18 | 1.1896626E−16 | −9.4043695E−13 | −2.3777209E−12 |
| A19 | 7.5416572E−20 | −1.5202236E−17 | 8.4013706E−14 | 4.9208850E−12 |
| A20 | −1.2625988E−21 | 4.6357007E−19 | −2.9677251E−15 | −3.4053966E−13 |
| Sn | 15 | 16 | 17 | 18 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.5327927E−04 | 1.3673127E−04 | 5.5911888E−04 | 4.0942442E−04 |
| A5 | 1.7820288E−04 | −2.6721769E−05 | 4.6185275E−05 | 1.7611112E−04 |
| A6 | −1.9159089E−04 | −2.3108400E−05 | −3.9260352E−05 | −1.2816880E−04 |
| A7 | 1.1539392E−05 | 4.5573510E−05 | −1.2576681E−06 | 4.5255056E−05 |
| A8 | 1.1531026E−04 | −2.1093746E−05 | 6.8161679E−06 | −1.0038329E−05 |
| A9 | −8.7411469E−05 | 2.2589329E−06 | −2.0148563E−06 | 9.5873145E−07 |
| A10 | 2.8032031E−05 | 1.1231619E−06 | 2.5532030E−09 | 1.3167870E−07 |
| A11 | −4.0166140E−06 | −3.1350569E−07 | 7.3264493E−08 | −6.0770439E−08 |
| A12 | 5.3040997E−07 | 1.2724091E−08 | −6.8072555E−09 | 8.0771100E−09 |
| A13 | −3.4637182E−07 | −2.8350895E−09 | 2.3972410E−10 | −9.3704339E−11 |
| A14 | 1.1975481E−07 | 1.5216947E−09 | −3.7488607E−10 | −2.0845795E−11 |
| A15 | −8.9400160E−09 | 1.5331247E−10 | 4.3229752E−11 | −8.9788766E−12 |
| A16 | −5.3180322E−09 | −1.0616050E−10 | 1.9666714E−11 | −2.1191599E−12 |
| A17 | 1.8046851E−09 | 1.6979547E−11 | −5.6891723E−12 | 1.1015474E−12 |
| A18 | −2.3713990E−10 | −2.9596122E−12 | 5.3239415E−13 | −1.3190034E−13 |
| A19 | 1.1218339E−11 | 4.7427473E−13 | −1.0443419E−14 | 5.2864229E−15 |
| A20 | 1.0753175E−13 | −3.0967085E−14 | −7.2878552E−16 | −1.1849714E−17 |

### Example 5

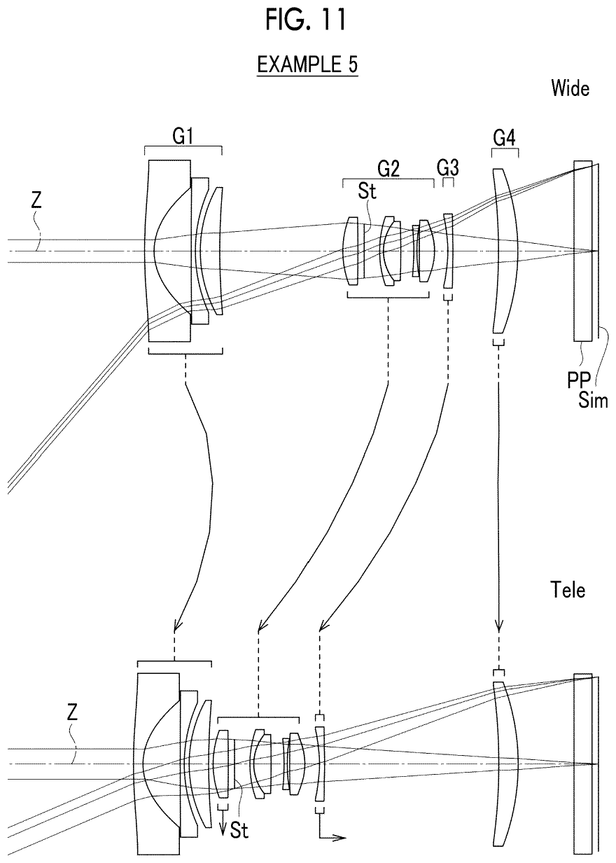

A configuration and a moving trajectory of a variable magnification optical system of Example 5 are shown in FIG. 11. The variable magnification optical system of Example 5 consists of, in order from the object side to the image side, the first lens group G1 having a negative refractive power, the second lens group G2 having a positive refractive power, the third lens group G3 having a negative refractive power, and the fourth lens group G4 having a positive refractive power.

During changing the magnification from the wide angle end to the telephoto end, all lens groups move along the optical axis Z by changing a spacing with respect to an adjacent lens group. The vibration-proof group consists of one single lens that is a lens in the second lens group G2 and is disposed adjacent to the object side of the aperture stop St. The focusing group consists of the third lens group G3. During focusing from the infinite distance object to the nearby object, the focusing group moves to the image side.

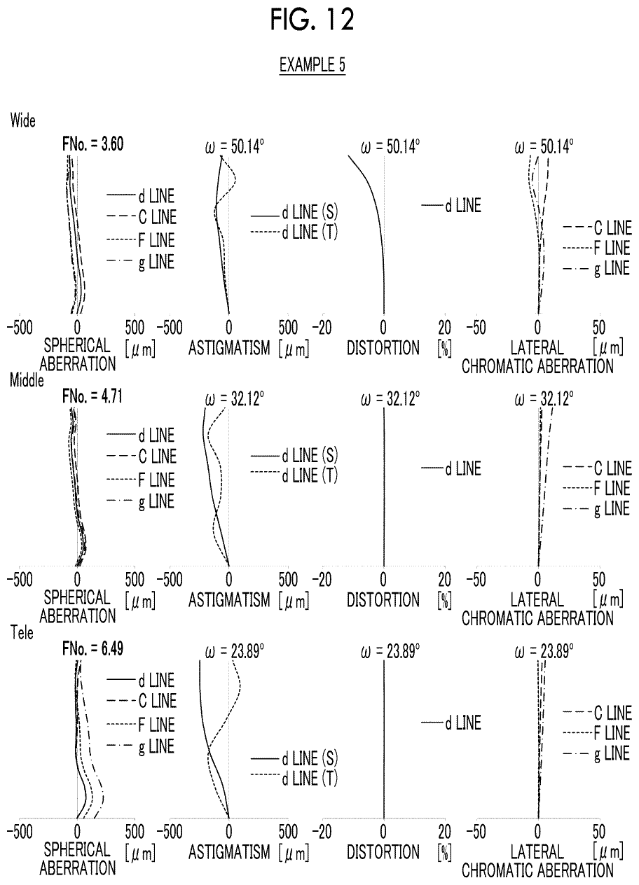

With respect to the variable magnification optical system according to Example 5, basic lens data is shown in Table 13, specifications and variable surface spacings are shown in Table 14, aspherical coefficients are shown in Table 15, and each aberration diagram is shown in FIG. 12.

TABLE 13
Example 5

| Sn | R | D | Nd | vd | θgF | ED | Material |
|---|---|---|---|---|---|---|---|
| *1 | 89.3698 | 1.500 | 1.80610 | 40.73 | 0.56940 | 25.73 | M-NBFD130.HOYA |
| *2 | 9.7098 | 5.850 | | | | 19.68 | |
| 3 | 1219.5376 | 0.650 | 1.43700 | 95.10 | 0.53364 | 19.50 | FCD100.HOYA |
| 4 | 25.0000 | 0.775 | | | | 19.02 | |
| 5 | 21.9436 | 3.072 | 1.95375 | 32.32 | 0.58998 | 19.10 | TAFD45L.HOYA |
| 6 | 120.8517 | DD[6] | | | | 18.71 | |
| *7 | 15.1434 | 2.383 | 1.58313 | 59.38 | 0.54237 | 9.33 | L-BAL42.OHARA |
| *8 | −298.3143 | 0.992 | | | | 9.06 | |
| 9(St) | ∞ | 2.426 | | | | 8.79 | |
| 10 | 17.5125 | 0.610 | 1.61309 | 60.60 | 0.54146 | 8.34 | H-ZK7.NHG |
| 11 | 7.7773 | 2.727 | 1.49700 | 81.61 | 0.53887 | 8.01 | FCD1.HOYA |
| 12 | −140.7589 | 2.043 | | | | 7.69 | |
| 13 | −41.3009 | 0.500 | 1.80001 | 29.83 | 0.59940 | 7.05 | H-ZLAF57.NHG |
| 14 | 24.5232 | 0.380 | | | | 7.45 | |
| *15 | 282.4765 | 2.391 | 1.49710 | 81.56 | 0.53848 | 7.59 | M-FCD1.HOYA |
| *16 | −10.1305 | DD[16] | | | | 8.63 | |
| *17 | −17.8955 | 0.800 | 1.69350 | 53.20 | 0.54661 | 11.12 | M-LAC130.HOYA |
| *18 | −49.0104 | DD[18] | | | | 11.94 | |
| 19 | −96.7608 | 3.050 | 1.75500 | 52.35 | 0.54815 | 24.40 | H-LAK53B.NHG |
| 20 | −38.3451 | DD[20] | | | | 25.13 | |
| 21 | ∞ | 2.850 | 1.51680 | 64.20 | 0.53430 | | BSC7.HOYA |
| 22 | ∞ | 1.017 | | | | | |

TABLE 14
Example 5

| | Wide | Middle | Tele |
|---|---|---|---|
| Zr | 1.0 | 1.7 | 2.4 |
| f | 13.41 | 22.62 | 32.06 |
| FNo. | 3.60 | 4.71 | 6.49 |
| 2ω[°] | 100.28 | 64.24 | 47.78 |
| DD[6] | 19.296 | 5.925 | 0.695 |
| DD[16] | 2.096 | 2.580 | 2.226 |
| DD[18] | 7.174 | 16.269 | 27.448 |
| DD[20] | 8.843 | 8.864 | 8.783 |

TABLE 15
Example 5

| Sn | 1 | 2 | 7 | 8 |
|---|---|---|---|---|
| KA | 1.0000000E+00 | −1.3577617E+00 | 1.0000000E+00 | 1.0000000E+00 |
| A3 | 0.0000000E+00 | 0.0000000E+00 | 0.0000000E+00 | 0.0000000E+00 |
| A4 | −4.7037269E−06 | 1.8318568E−04 | −1.6500555E−04 | 7.8019951E−05 |
| A5 | 6.8151857E−07 | −6.9965138E−06 | 2.9614630E−04 | −1.8766800E−04 |
| A6 | 1.5847692E−06 | 2.5885522E−05 | −4.1906640E−04 | 1.7316431E−04 |
| A7 | −4.4024623E−07 | −1.1739338E−05 | 3.6316929E−04 | −9.7965220E−05 |
| A8 | 9.2312991E−09 | 2.0518071E−06 | −1.9632650E−04 | 3.8388630E−05 |
| A9 | 6.0953989E−09 | −8.7827649E−08 | 6.4694791E−05 | −9.9050542E−06 |
| A10 | −3.6659009E−10 | −1.6650322E−08 | −1.2168280E−05 | 8.9863327E−07 |
| A11 | −3.8577487E−11 | 1.1456135E−09 | 1.5461231E−06 | 3.8616895E−07 |
| A12 | 3.4276191E−12 | 1.4637413E−10 | −5.2867832E−07 | −1.4187132E−07 |
| A13 | 3.5539973E−14 | −4.1357336E−12 | 2.1116292E−07 | 1.0150589E−08 |
| A14 | 3.5716835E−15 | −5.3461759E−13 | −3.3212547E−08 | 3.8664182E−09 |
| A15 | −1.6068946E−15 | −3.4153708E−13 | −1.7877876E−09 | −1.2372594E−09 |
| A16 | 5.4232099E−17 | 4.2649564E−14 | 1.0857615E−09 | 1.8085710E−10 |
| A17 | 1.9447571E−18 | 8.5751865E−16 | −3.7502283E−11 | −2.6729980E−12 |
| A18 | 5.0616107E−20 | −3.3419554E−16 | −2.2408203E−11 | −5.2434135E−12 |
| A19 | −1.4989449E−20 | 1.5817748E−17 | 3.1811795E−12 | 9.5774081E−13 |
| A20 | 4.1660104E−22 | −1.9909420E−19 | −1.3306101E−13 | −5.4696016E−14 |
| Sn | 15 | 16 | 17 | 18 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.3701981E−04 | 2.0972681E−04 | 6.7991184E−04 | 5.9155141E−04 |
| A5 | 2.9774343E−04 | −2.0956541E−04 | 9.7360015E−05 | 2.3513566E−05 |
| A6 | −2.6713543E−04 | 2.9363642E−04 | −1.0041981E−04 | 4.9228294E−05 |
| A7 | 9.2787389E−05 | −2.5293916E−04 | 2.4348591E−05 | −8.1633762E−05 |
| A8 | 3.6479116E−06 | 1.3379481E−04 | −2.8374047E−06 | 3.5774405E−05 |
| A9 | −7.6035501E−06 | −3.8240971E−05 | 5.3043151E−07 | −6.5010076E−06 |
| A10 | −1.3052205E−07 | 2.7846109E−06 | −1.3133699E−07 | 2.2893457E−07 |
| A11 | 4.7299705E−07 | 1.5404821E−06 | 1.6490038E−09 | 2.1376024E−08 |
| A12 | 5.2491033E−08 | −3.9665368E−07 | 1.1597492E−09 | 2.3147860E−08 |
| A13 | −2.3638025E−08 | 2.4759573E−09 | −1.7700255E−10 | −5.6975195E−09 |
| A14 | −4.2824669E−09 | 9.9031776E−09 | 2.1943629E−10 | 1.4480427E−10 |
| A15 | 8.7133830E−11 | −1.9004443E−09 | −3.1135818E−11 | 4.9355743E−11 |
| A16 | 2.2291572E−10 | 3.4635964E−10 | −4.6225499E−13 | 6.0640675E−12 |
| A17 | 9.1954180E−11 | 1.5199367E−12 | −3.1646092E−13 | −2.8088164E−12 |
| A18 | −2.6107309E−11 | −1.9935982E−11 | 3.7380781E−14 | 3.0778331E−13 |
| A19 | −6.8858194E−14 | 3.5096501E−12 | 1.4902871E−14 | −1.3488798E−14 |
| A20 | 2.5220742E−13 | −1.8466377E−13 | −1.5614876E−15 | 1.5858449E−16 |

### Example 6

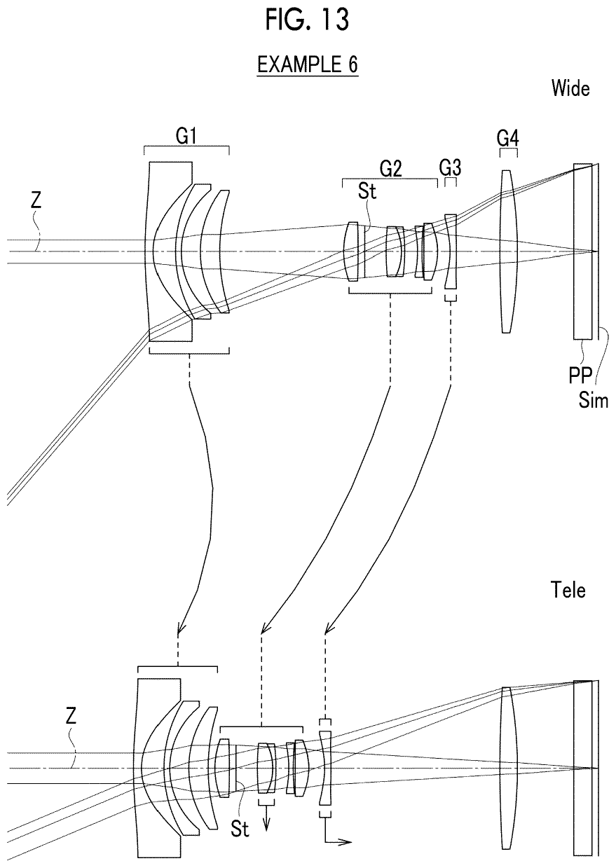

A configuration and a moving trajectory of a variable magnification optical system of Example 6 are shown in FIG. 13. The variable magnification optical system of Example 6 consists of, in order from the object side to the image side, the first lens group G1 having a negative refractive power, the second lens group G2 having a positive refractive power, the third lens group G3 having a negative refractive power, and the fourth lens group G4 having a positive refractive power.

During changing the magnification from the wide angle end to the telephoto end, the fourth lens group G4 is fixed with respect to the image plane Sim, and other lens groups move along the optical axis Z by changing their spacings with respect to their adjacent lens groups. The vibration-proof group consists of one cemented lens that is a lens in the second lens group G2 and is disposed adjacent to the image side of the aperture stop St. The focusing group consists of the third lens group G3. During focusing from the infinite distance object to the nearby object, the focusing group moves to the image side.

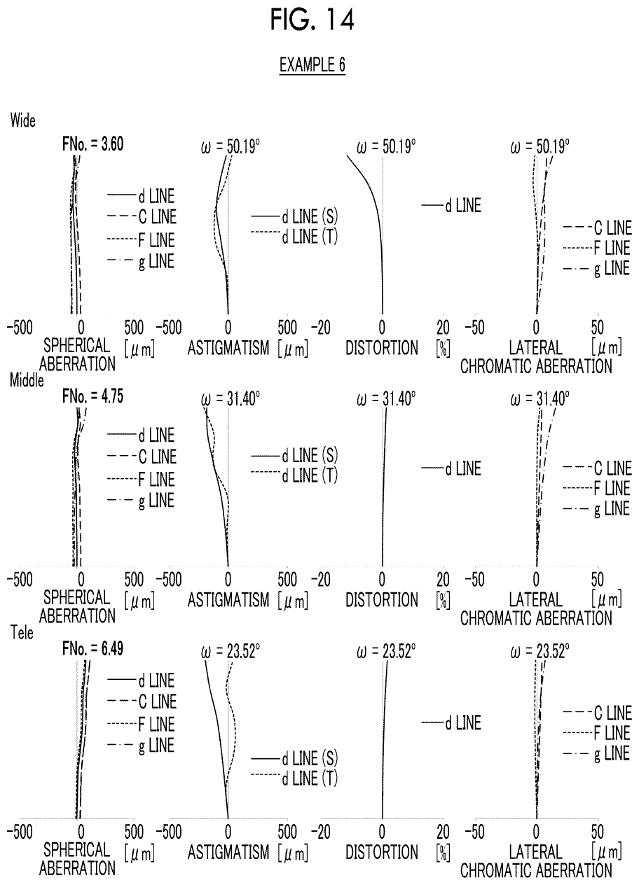

With respect to the variable magnification optical system according to Example 6, basic lens data is shown in Table 16, specifications and variable surface spacings are shown in Table 17, aspherical coefficients are shown in Table 18, and each aberration diagram is shown in FIG. 14.

TABLE 16
Example 6

| Sn | R | D | Nd | vd | θgF | ED | Material |
|---|---|---|---|---|---|---|---|
| *1 | 75.1689 | 1.250 | 1.69350 | 53.20 | 0.54661 | 28.65 | M-LAC130.HOYA |
| *2 | 9.7180 | 3.439 | | | | 21.91 | |
| 3 | 20.9792 | 0.900 | 1.49700 | 81.54 | 0.53748 | 21.69 | S-FPL51.OHARA |
| 4 | 12.9875 | 2.976 | | | | 19.85 | |
| 5 | 16.7239 | 3.031 | 1.90366 | 31.27 | 0.59487 | 19.74 | J-LASFH13HS.HIKARI |
| 6 | 31.4095 | DD[6] | | | | 18.94 | |
| *7 | 13.0958 | 2.250 | 1.49700 | 81.60 | 0.53774 | 9.36 | D-FK61A.CDGM |
| *8 | −182.1476 | 1.050 | | | | 8.60 | |
| 9(St) | ∞ | 3.338 | | | | 8.30 | |
| 10 | 45.3195 | 2.400 | 1.71299 | 53.93 | 0.54684 | 8.02 | H-LAK7.NHG |
| 11 | −9.1878 | 0.500 | 1.87070 | 40.73 | 0.56825 | 7.91 | TAFD32.HOYA |
| 12 | −31.3116 | 2.000 | | | | 7.91 | |
| 13 | −19.2827 | 0.700 | 1.62004 | 36.26 | 0.58800 | 7.50 | S-TIM2.OHARA |
| 14 | 41.5861 | 0.300 | | | | 8.20 | |
| *15 | 615.4685 | 2.136 | 1.55332 | 71.68 | 0.54029 | 8.35 | M-FCD500.HOYA |
| *16 | −10.2201 | DD[16] | | | | 9.08 | |
| *17 | −13.6386 | 1.000 | 1.69350 | 53.18 | 0.54831 | 10.90 | L-LAL13.OHARA |
| *18 | −48.0472 | DD[18] | | | | 11.93 | |
| 19 | 228.4189 | 2.730 | 1.87070 | 40.73 | 0.56833 | 25.84 | H-ZLAF64.NHG |
| 20 | −74.3309 | 8.811 | | | | 26.15 | |
| 21 | ∞ | 2.850 | 1.51680 | 64.20 | 0.53430 | | BSC7.HOYA |
| 22 | ∞ | 1.027 | | | | | |

TABLE 17
Example 6

| | Wide | Middle | Tele |
|---|---|---|---|
| Zr | 1.0 | 1.7 | 2.4 |
| f | 13.39 | 23.00 | 32.14 |
| FNo. | 3.60 | 4.75 | 6.49 |
| 2ω[°] | 100.38 | 62.80 | 47.05 |
| DD[6] | 19.368 | 6.041 | 1.054 |
| DD[16] | 1.943 | 2.411 | 2.473 |
| DD[18] | 6.721 | 16.334 | 26.323 |

TABLE 18
Example 6

| Sn | 1 | 2 | 7 | 8 |
|---|---|---|---|---|
| KA | 1.0000000E+00 | −1.4201354E+00 | 1.0000000E+00 | 1.0000000E+00 |
| A3 | 0.0000000E+00 | 0.0000000E+00 | 0.0000000E+00 | 0.0000000E+00 |
| A4 | 2.2030631E−05 | 2.6093444E−04 | −7.7173072E−05 | −6.6206558E−05 |
| A5 | −6.7388435E−06 | −8.6885067E−06 | −5.5805973E−06 | 1.6646181E−05 |
| A6 | 2.6682813E−07 | −1.1620572E−06 | 6.9289416E−06 | −3.8887199E−06 |
| A7 | 4.6810832E−09 | 4.1141431E−08 | −2.0335309E−06 | 1.8452874E−07 |
| A8 | 7.2034043E−10 | −8.5819853E−10 | −5.5722321E−07 | −1.3206314E−07 |
| A9 | −5.8890429E−11 | 3.5063742E−10 | 6.2241730E−07 | 7.4069858E−08 |
| A10 | −8.7884597E−12 | 7.3019255E−11 | −2.0667165E−07 | −1.2555828E−08 |
| A11 | 1.7138490E−13 | −5.8399187E−12 | 2.1520094E−08 | −1.9419018E−09 |
| A12 | 1.4278585E−13 | −2.7555110E−12 | 2.8280125E−10 | 1.6604361E−10 |
| A13 | −8.7350890E−15 | 2.0998376E−13 | 1.2493250E−09 | 1.4040954E−10 |
| A14 | −6.5800768E−16 | 8.6465599E−14 | −4.0079899E−10 | −5.0942759E−12 |
| A15 | 6.7565576E−17 | −1.8611330E−14 | −2.3503707E−11 | 7.2888689E−13 |
| A16 | 4.3345534E−19 | 1.3577168E−15 | 2.0171439E−11 | 4.4373086E−13 |
| A17 | −7.4097923E−20 | −4.5929517E−18 | −1.3867251E−12 | −3.2621780E−13 |
| A18 | −1.5217680E−20 | −5.2661308E−18 | −3.9274721E−13 | 2.1914386E−14 |
| A19 | 1.1902647E−21 | 3.0770495E−19 | 7.6972724E−14 | −1.6393693E−14 |
| A20 | −2.4073082E−23 | −5.8148044E−21 | −4.2036662E−15 | 3.4498406E−15 |
| Sn | 15 | 16 | 17 | 18 |
| KA | 1.0000000E+00 | 1.0000000E+00 | 1.0000000E+00 | 1.0000000E+00 |
| A3 | 0.0000000E+00 | 0.0000000E+00 | 3.3881318E−19 | −1.6940659E−19 |
| A4 | −1.0705985E−04 | 1.9689912E−04 | 5.8331128E−04 | 4.3711171E−04 |
| A5 | 1.2602544E−04 | 1.7055314E−05 | 1.2972495E−04 | 1.7851556E−04 |
| A6 | −1.2718674E−04 | −1.0935189E−04 | −4.1712221E−05 | −5.7588569E−05 |
| A7 | 7.6589869E−05 | 1.4290846E−04 | −1.2824449E−05 | −1.1030549E−05 |
| A8 | −2.7669534E−05 | −8.8660377E−05 | 6.0903428E−06 | 6.9845404E−06 |
| A9 | 5.8193250E−06 | 2.7961804E−05 | −7.3998184E−08 | −3.9077785E−07 |
| A10 | −8.2616013E−07 | −3.9580710E−06 | −3.2547980E−07 | −3.3379332E−07 |
| A11 | 2.4680230E−07 | 6.0257898E−07 | 4.1293467E−08 | 5.5874484E−08 |
| A12 | −7.8260578E−08 | −5.1745705E−07 | 7.5434881E−09 | 6.6788728E−09 |
| A13 | 9.8603605E−09 | 2.2727422E−07 | −1.9722847E−09 | −2.1984122E−09 |
| A14 | 2.3917365E−10 | −4.7843450E−08 | −1.9660823E−11 | −4.5476300E−12 |
| A15 | −1.3885950E−10 | 5.0401334E−09 | 4.2064086E−11 | 4.2239258E−11 |
| A16 | 6.9741546E−12 | −2.1620934E−10 | −2.2729489E−12 | −2.0174353E−12 |
| A17 | 1.8264862E−13 | −1.7854134E−13 | −4.3559597E−13 | −4.0704361E−13 |
| A18 | 3.5728973E−15 | 1.1111138E−14 | 3.9315989E−14 | 3.0963780E−14 |
| A19 | −3.7479574E−15 | 3.9136232E−15 | 1.7903670E−15 | 1.5789388E−15 |
| A20 | −6.7099849E−16 | −1.0160893E−16 | −2.0766098E−16 | −1.4971938E−16 |

### Example 7

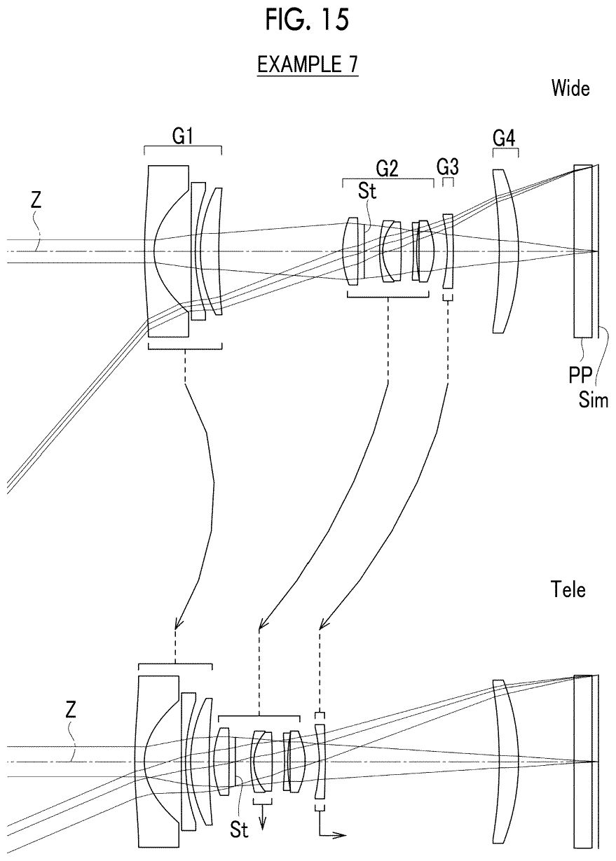

A configuration and a moving trajectory of a variable magnification optical system of Example 7 are shown in FIG. 15. The variable magnification optical system of Example 7 consists of, in order from the object side to the image side, the first lens group G1 having a negative refractive power, the second lens group G2 having a positive refractive power, the third lens group G3 having a negative refractive power, and the fourth lens group G4 having a positive refractive power.

During changing the magnification from the wide angle end to the telephoto end, the fourth lens group G4 is fixed with respect to the image plane Sim, and other lens groups move along the optical axis Z by changing their spacings with respect to their adjacent lens groups. The vibration-proof group consists of one cemented lens that is a lens in the second lens group G2 and is disposed adjacent to the image side of the aperture stop St. The focusing group consists of the third lens group G3. During focusing from the infinite distance object to the nearby object, the focusing group moves to the image side.

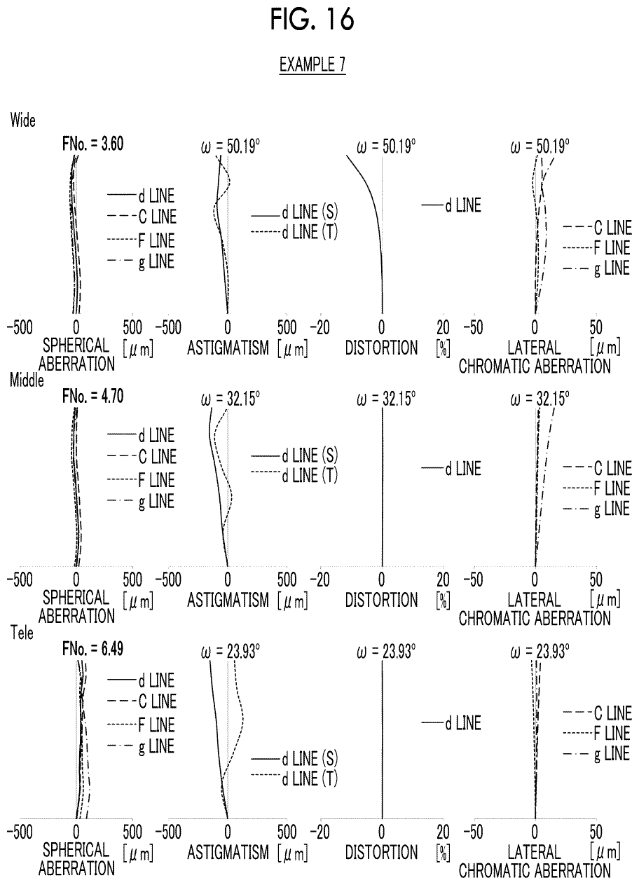

With respect to the variable magnification optical system according to Example 7, basic lens data is shown in Table 19, specifications and variable surface spacings are shown in Table 20, aspherical coefficients are shown in Table 21, and each aberration diagram is shown in FIG. 16.

TABLE 19
Example 7

| Sn | R | D | Nd | vd | θgF | ED | Material |
|---|---|---|---|---|---|---|---|
| *1 | 82.5270 | 1.500 | 1.80610 | 40.73 | 0.56940 | 25.72 | M-NBFD 130.HOYA |
| *2 | 9.4355 | 5.850 | | | | 19.66 | |
| 3 | 1217.7060 | 0.660 | 1.45860 | 90.17 | 0.53706 | 19.51 | H-FK90.NHG |
| 4 | 31.6409 | 0.810 | | | | 19.15 | |
| 5 | 23.3198 | 2.910 | 2.00100 | 29.13 | 0.59935 | 19.20 | H-ZLAF82.NHG |
| 6 | 107.9690 | DD[6] | | | | 18.79 | |
| *7 | 14.7088 | 2.420 | 1.58313 | 59.46 | 0.54056 | 9.31 | M-BACD12.HOYA |
| *8 | −294.2865 | 0.990 | | | | 9.04 | |
| 9(St) | ∞ | 2.420 | | | | 8.80 | |
| 10 | 20.7593 | 0.510 | 1.56883 | 56.04 | 0.54960 | 8.34 | H-BAK7.CDGM |
| 11 | 7.4048 | 2.900 | 1.49700 | 81.61 | 0.53887 | 8.02 | FCD1.HOYA |
| 12 | −93.5186 | 1.940 | | | | 7.69 | |
| 13 | −49.2217 | 0.500 | 1.85883 | 30.00 | 0.59793 | 7.05 | NBFD30.HOYA |
| 14 | 25.5411 | 0.380 | | | | 7.41 | |
| *15 | 269.2357 | 2.380 | 1.49710 | 81.56 | 0.53848 | 7.57 | M-FCD1.HOYA |
| *16 | −10.4472 | DD[16] | | | | 8.61 | |
| *17 | −17.8133 | 0.940 | 1.69350 | 53.20 | 0.54661 | 11.06 | M-LAC130.HOYA |
| *18 | −47.3222 | DD[18] | | | | 11.96 | |
| 19 | −81.5967 | 3.040 | 1.83481 | 42.72 | 0.56434 | 24.28 | H-ZLAF55D.CDGM |
| 20 | −38.1601 | 8.772 | | | | 25.09 | |
| 21 | ∞ | 2.850 | 1.51680 | 64.20 | 0.53430 | | BSC7.HOYA |
| 22 | ∞ | 1.014 | | | | | |

TABLE 20
Example 7

| | Wide | Middle | Tele |
|---|---|---|---|
| Zr | 1.0 | 1.7 | 2.4 |
| f | 13.39 | 22.59 | 32.02 |
| FNo. | 3.60 | 4.70 | 6.49 |
| 2ω[°] | 100.37 | 64.30 | 47.86 |
| DD[6] | 19.470 | 5.920 | 0.734 |
| DD[16] | 2.100 | 2.671 | 2.155 |
| DD[18] | 7.250 | 16.099 | 27.468 |

TABLE 21
Example 7

| Sn | 1 | 2 | 7 | 8 |
|---|---|---|---|---|
| KA | 1.0000000E+00 | −1.2531094E+00 | 1.0000000E+00 | 1.0000000E+00 |
| A3 | 0.0000000E+00 | 0.0000000E+00 | 0.0000000E+00 | 0.0000000E+00 |
| A4 | 3.2465819E−06 | 2.1474203E−04 | −3.8359415E−05 | 4.0184468E−05 |
| A5 | −5.6325893E−06 | −4.8587146E−06 | −3.7479907E−05 | −5.3718644E−05 |
| A6 | 1.2240170E−06 | 1.0704520E−05 | 4.1825110E−05 | −2.5843012E−05 |
| A7 | −4.0063656E−08 | −6.3672123E−06 | −2.1579134E−05 | 8.3113717E−05 |
| A8 | −2.8597463E−08 | 1.7071282E−06 | 5.5165975E−06 | −6.0496842E−05 |
| A9 | 2.5056216E−09 | −2.6044644E−07 | −5.6780858E−07 | 1.8597494E−05 |
| A10 | 1.9102429E−10 | 2.2297574E−08 | 9.3091031E−09 | −9.0206228E−07 |
| A11 | −1.2836992E−11 | −9.1587256E−10 | −1.3152396E−08 | −8.5362015E−07 |
| A12 | −1.8332392E−12 | 7.6520214E−12 | 3.8928865E−09 | 1.6207691E−07 |
| A13 | −2.3441676E−14 | −1.9442883E−12 | −5.1888111E−10 | −6.4317838E−09 |
| A14 | 2.2470932E−14 | 6.7926426E−13 | 3.2013676E−10 | 7.1911624E−09 |
| A15 | −2.4044561E−16 | −1.4576221E−14 | −8.2392447E−11 | −2.6961038E−09 |
| A16 | −1.0861191E−16 | −1.0080873E−14 | 1.9673300E−12 | 1.1713622E−10 |
| A17 | 3.3260139E−18 | −1.3039335E−16 | 1.5175945E−13 | 6.2648688E−11 |
| A18 | 2.1407600E−19 | 2.4559606E−16 | 4.7203488E−13 | −6.7294529E−12 |
| A19 | −1.3070369E−20 | −2.2486004E−17 | −9.5543233E−14 | −3.3831905E−13 |
| A20 | 1.9837557E−22 | 6.2506810E−19 | 5.2348642E−15 | 5.2173545E−14 |
| Sn | 15 | 16 | 17 | 18 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −7.0691804E−05 | 2.1210811E−04 | 5.7788596E−04 | 4.5018032E−04 |
| A5 | −6.1149899E−05 | 9.8892617E−06 | 9.1134921E−05 | 1.0120028E−04 |
| A6 | 7.5023027E−05 | −1.3509620E−04 | −8.8755789E−05 | −1.9379682E−05 |
| A7 | −6.5242224E−05 | 1.2814587E−04 | 1.9351466E−05 | −3.8878212E−05 |
| A8 | 3.9116966E−05 | −4.4777120E−05 | 2.1029505E−07 | 1.9144324E−05 |
| A9 | −1.2396119E−05 | −5.9781401E−07 | −7.3148314E−07 | −1.4280390E−06 |
| A10 | 1.0683000E−06 | 4.3310552E−06 | 1.0784564E−07 | −1.2704232E−06 |
| A11 | 3.7867254E−07 | −6.8665853E−07 | −2.6308791E−08 | 3.9087456E−07 |
| A12 | −2.3396378E−08 | −1.0677525E−07 | 8.9089268E−09 | −3.1083254E−08 |
| A13 | −3.4149864E−08 | 1.6664148E−08 | −1.6342892E−09 | −3.6353802E−09 |
| A14 | 3.2683749E−09 | 4.0666219E−09 | 2.3260155E−10 | 6.0220957E−10 |
| A15 | 2.8477508E−09 | 2.3123295E−10 | −1.8145802E−11 | 5.6407183E−11 |
| A16 | −1.0069889E−09 | −2.1280369E−10 | −1.8748475E−12 | −1.8636232E−11 |
| A17 | 8.7049869E−11 | −2.2146856E−11 | 2.2048141E−13 | 1.3360448E−12 |
| A18 | 2.8600146E−11 | 9.8023947E−12 | 2.6553444E−14 | 5.2426621E−14 |
| A19 | −8.0801071E−12 | −5.7600198E−13 | −7.0622995E−16 | −1.3550110E−14 |
| A20 | 5.9756989E−13 | −1.2238588E−14 | −2.4111014E−16 | 6.1277331E−16 |

### Example 8

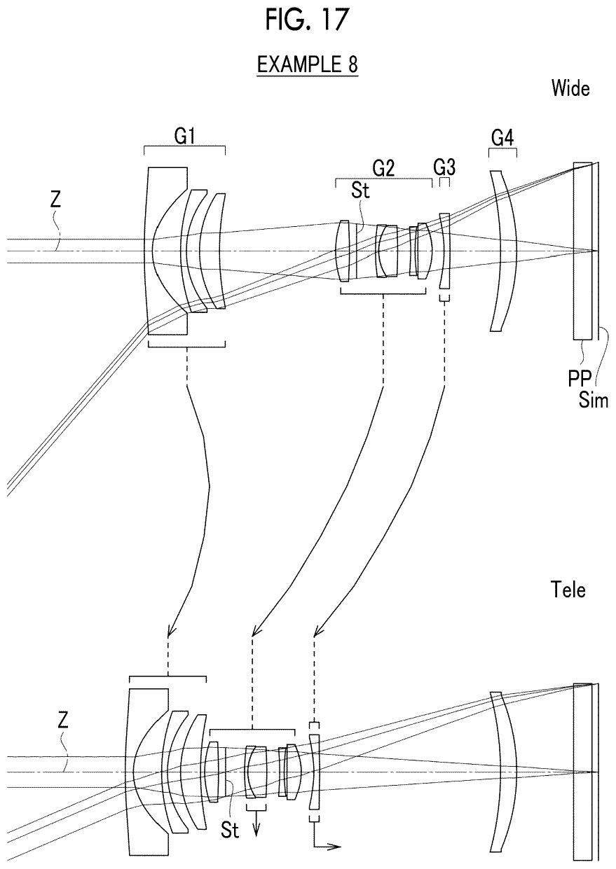

A configuration and a moving trajectory of a variable magnification optical system of Example 8 are shown in FIG. 17. The variable magnification optical system of Example 8 consists of, in order from the object side to the image side, the first lens group G1 having a negative refractive power, the second lens group G2 having a positive refractive power, the third lens group G3 having a negative refractive power, and the fourth lens group G4 having a positive refractive power.

During changing the magnification from the wide angle end to the telephoto end, the fourth lens group G4 is fixed with respect to the image plane Sim, and other lens groups move along the optical axis Z by changing their spacings with respect to their adjacent lens groups. The vibration-proof group consists of one cemented lens that is a lens in the second lens group G2 and is disposed adjacent to the image side of the aperture stop St. The focusing group consists of the third lens group G3. During focusing from the infinite distance object to the nearby object, the focusing group moves to the image side.

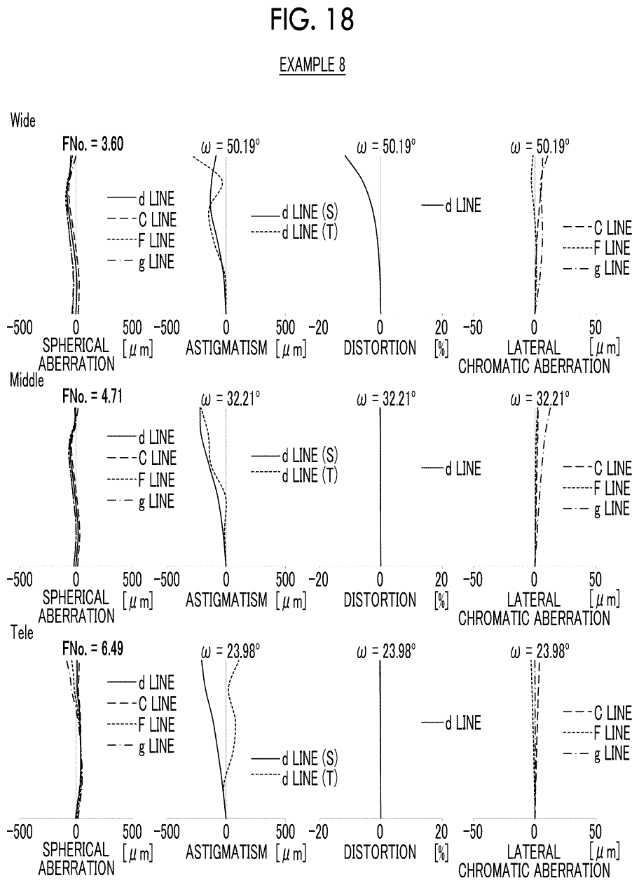

With respect to the variable magnification optical system according to Example 8, basic lens data is shown in Table 22, specifications and variable surface spacings are shown in Table 23, aspherical coefficients are shown in Table 24, and each aberration diagram is shown in FIG. 18.

TABLE 22
Example 8

| Sn | R | D | Nd | vd | θgF | ED | Material |
|---|---|---|---|---|---|---|---|
| *1 | 92.5254 | 1.250 | 1.74320 | 49.29 | 0.55303 | 26.03 | L-LAM60.OHARA |
| *2 | 9.5381 | 4.297 | | | | 19.80 | |
| 3 | 29.0358 | 0.900 | 1.59349 | 67.00 | 0.53667 | 19.53 | PCD51.HOYA |
| 4 | 14.6400 | 2.031 | | | | 18.26 | |
| 5 | 17.1050 | 3.092 | 1.90366 | 31.36 | 0.59567 | 18.34 | H-ZLAF75C.CDGM |
| 6 | 44.9459 | DD[6] | | | | 17.77 | |
| *7 | 15.1516 | 2.134 | 1.51633 | 64.06 | 0.53345 | 9.61 | L-BSL7.OHARA |
| *8 | −64.6682 | 1.093 | | | | 8.95 | |
| 9(St) | ∞ | 2.942 | | | | 8.67 | |
| 10 | 29.2375 | 0.500 | 1.61340 | 44.11 | 0.56567 | 8.29 | H-TF3L.CDGM |
| 11 | 7.3391 | 2.934 | 1.56907 | 71.30 | 0.54432 | 8.04 | H-ZPK7.CDGM |
| 12 | −65.7093 | 2.000 | | | | 7.81 | |
| 13 | −43.4701 | 0.704 | 1.88100 | 40.14 | 0.57010 | 7.29 | TAFD33.HOYA |
| 14 | 28.6906 | 0.432 | | | | 7.75 | |
| *15 | 311.6179 | 2.205 | 1.49710 | 81.56 | 0.53848 | 7.98 | M-FCD1.HOYA |
| *16 | −9.6853 | DD[16] | | | | 8.84 | |
| *17 | −16.4301 | 0.910 | 1.58913 | 61.25 | 0.53741 | 11.07 | M-BACD5N.HOYA |
| *18 | −47.6848 | DD[18] | | | | 11.97 | |
| 19 | −51.4326 | 2.500 | 1.88100 | 40.14 | 0.57010 | 23.87 | TAFD33.HOYA |
| 20 | −33.0183 | 8.807 | | | | 24.65 | |
| 21 | ∞ | 2.850 | 1.51680 | 64.20 | 0.53430 | | BSC7.HOYA |
| 22 | ∞ | 1.013 | | | | | |

TABLE 23
Example 8

| | Wide | Middle | Tele |
|---|---|---|---|
| Zr | 1.0 | 1.7 | 2.4 |
| f | 13.39 | 22.59 | 32.02 |
| FNo. | 3.60 | 4.71 | 6.49 |
| 2ω[°] | 100.38 | 64.42 | 47.96 |
| DD[6] | 17.986 | 5.642 | 0.651 |
| DD[16] | 1.855 | 2.201 | 1.953 |
| DD[18] | 7.750 | 17.115 | 27.926 |

TABLE 24
Example 8

| Sn | 1 | 2 | 7 | 8 |
|---|---|---|---|---|
| KA | 1.0000000E+00 | −1.3407945E+00 | 1.0000000E+00 | 1.0000000E+00 |
| A3 | 0.0000000E+00 | 0.0000000E+00 | 0.0000000E+00 | 0.0000000E+00 |
| A4 | 3.3575537E−05 | 2.7960286E−04 | −6.2349380E−05 | 1.7160249E−05 |
| A5 | −7.2266067E−06 | −9.1508704E−06 | 1.0355375E−05 | 5.3981407E−06 |
| A6 | 2.2647714E−07 | −1.2847851E−06 | 4.1838979E−06 | −3.2876850E−07 |
| A7 | 1.5686988E−08 | 1.3899496E−07 | −2.2041824E−06 | 4.0012478E−07 |
| A8 | −3.5942438E−10 | −2.2631601E−08 | −5.0880897E−07 | −1.0528698E−07 |
| A9 | −8.4891705E−11 | 2.7718139E−09 | 6.8749508E−07 | 5.8433602E−08 |
| A10 | 4.6946881E−12 | 1.3645540E−11 | −2.1309427E−07 | −9.5827961E−09 |
| A11 | 2.3981720E−13 | −2.5943521E−11 | 2.2158175E−08 | −2.9735056E−09 |
| A12 | −5.1020421E−14 | 3.0676518E−13 | −3.8720583E−10 | 1.5096786E−10 |
| A13 | 2.2967290E−15 | 2.1328183E−13 | 1.2985840E−09 | 1.9809589E−10 |
| A14 | 1.7337468E−16 | −7.5131673E−15 | −3.8678223E−10 | 6.1387288E−13 |
| A15 | −3.3709441E−17 | 4.5351878E−16 | −2.2025442E−11 | 4.2086641E−12 |
| A16 | 2.7381602E−18 | −2.7421580E−16 | 2.0210994E−11 | 4.7819956E−13 |
| A17 | −1.4077120E−19 | 2.1807832E−17 | −1.4524122E−12 | −5.5303471E−13 |
| A18 | 4.5184622E−21 | 6.5535774E−19 | −4.1572803E−13 | −4.2293739E−15 |
| A19 | −7.2626712E−23 | −1.2875781E−19 | 7.6857328E−14 | −1.7768846E−14 |
| A20 | 2.0887434E−25 | 3.7896470E−21 | −3.5299046E−15 | 4.9500335E−15 |
| Sn | 15 | 16 | 17 | 18 |
| KA | 1.0000000E+00 | 1.0000000E+00 | 1.0000000E+00 | 1.0000000E+00 |
| A3 | 0.0000000E+00 | 0.0000000E+00 | 3.3881318E−19 | −1.6940659E−19 |
| A4 | −1.6483001E−04 | 1.6464941E−04 | 5.1430141E−04 | 3.6681485E−04 |
| A5 | 1.2921480E−04 | 1.7274136E−05 | 1.2383368E−04 | 1.7712906E−04 |
| A6 | −1.2696926E−04 | −1.1081138E−04 | −4.1819651E−05 | −5.7547013E−05 |
| A7 | 7.6189039E−05 | 1.4279029E−04 | −1.2841064E−05 | −1.1011056E−05 |
| A8 | −2.7754979E−05 | −8.8731317E−05 | 6.0897701E−06 | 6.9932751E−06 |
| A9 | 5.8240949E−06 | 2.7957990E−05 | −6.9488755E−08 | −3.9016296E−07 |
| A10 | −8.2896938E−07 | −3.9583041E−06 | −3.2592549E−07 | −3.3363428E−07 |
| A11 | 2.4835725E−07 | 6.0249423E−07 | 4.1300932E−08 | 5.5854987E−08 |
| A12 | −7.8260172E−08 | −5.1744884E−07 | 7.5417166E−09 | 6.6760792E−09 |
| A13 | 9.8602379E−09 | 2.2727447E−07 | −1.9721562E−09 | −2.1984084E−09 |
| A14 | 2.3919904E−10 | −4.7843448E−08 | −1.9657973E−11 | −4.5565157E−12 |
| A15 | −1.3885932E−10 | 5.0401336E−09 | 4.2064217E−11 | 4.2239282E−11 |
| A16 | 6.9741478E−12 | −2.1620998E−10 | −2.2729677E−12 | −2.0174671E−12 |
| A17 | −2.0304666E−13 | −2.1479489E−13 | −4.3559643E−13 | −4.0704374E−13 |
| A18 | 2.4094752E−14 | 1.7449434E−14 | 3.9316162E−14 | 3.0963779E−14 |
| A19 | −4.2210738E−15 | 2.3544789E−15 | 1.7903674E−15 | 1.5789375E−15 |
| A20 | 4.0672734E−16 | −1.1732097E−18 | −2.0766227E−16 | −1.4971918E−16 |

### Example 9

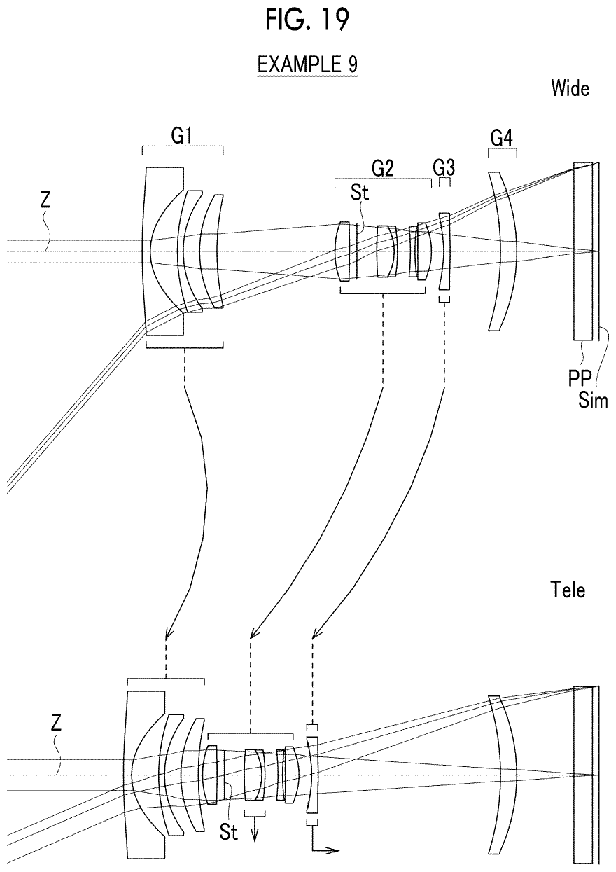

A configuration and a moving trajectory of a variable magnification optical system of Example 9 are shown in FIG. 19. The variable magnification optical system of Example 9 consists of, in order from the object side to the image side, the first lens group G1 having a negative refractive power, the second lens group G2 having a positive refractive power, the third lens group G3 having a negative refractive power, and the fourth lens group G4 having a positive refractive power.

During changing the magnification from the wide angle end to the telephoto end, the fourth lens group G4 is fixed with respect to the image plane Sim, and other lens groups move along the optical axis Z by changing their spacings with respect to their adjacent lens groups. The vibration-proof group consists of one cemented lens that is a lens in the second lens group G2 and is disposed adjacent to the image side of the aperture stop St. The focusing group consists of the third lens group G3. During focusing from the infinite distance object to the nearby object, the focusing group moves to the image side.

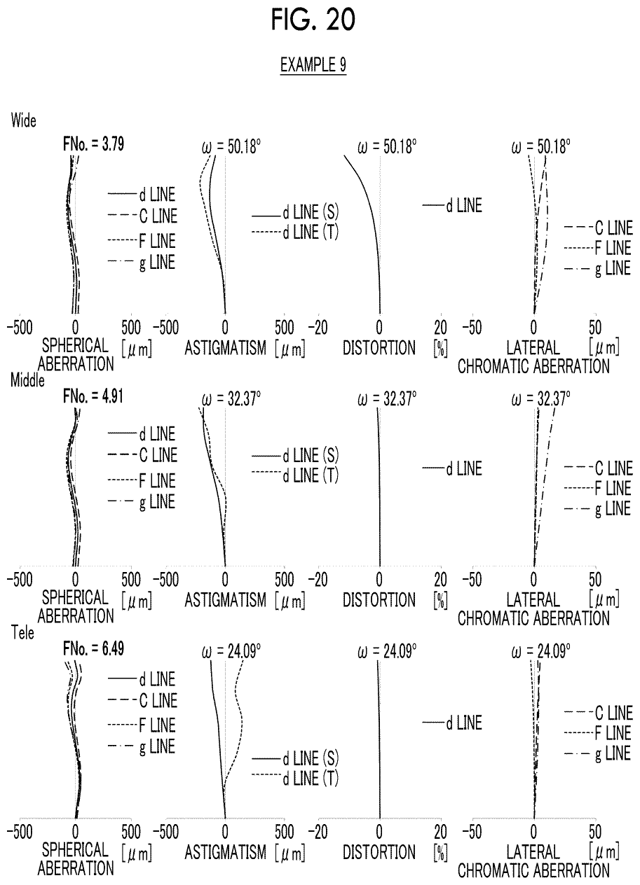

With respect to the variable magnification optical system according to Example 9, basic lens data is shown in Table 25, specifications and variable surface spacings are shown in Table 26, aspherical coefficients are shown in Table 27, and each aberration diagram is shown in FIG. 20.

TABLE 25
Example 9

| Sn | R | D | Nd | vd | θgF | ED | Material |
|---|---|---|---|---|---|---|---|
| *1 | 104.6593 | 1.250 | 1.74320 | 49.29 | 0.55303 | 25.73 | L-LAM60.OHARA |
| *2 | 9.8672 | 4.170 | | | | 19.61 | |
| 3 | 30.1699 | 0.900 | 1.60311 | 60.64 | 0.54148 | 19.31 | S-BSM14.OHARA |
| 4 | 15.4474 | 2.520 | | | | 18.09 | |
| 5 | 18.4371 | 2.671 | 2.00100 | 29.13 | 0.59935 | 18.00 | H-ZLAF82.NHG |
| 6 | 40.8996 | DD[6] | | | | 17.43 | |
| *7 | 13.5649 | 2.248 | 1.49710 | 81.56 | 0.53848 | 9.21 | M-FCD1.HOYA |
| *8 | −82.7671 | 1.123 | | | | 8.50 | |
| 9(St) | ∞ | 3.065 | | | | 8.35 | |
| 10 | 49.0143 | 2.674 | 1.48749 | 70.39 | 0.53005 | 8.09 | H-QK3L.NHG |
| 11 | −8.4518 | 0.510 | 1.54072 | 47.20 | 0.56295 | 7.99 | QF8.CDGM |
| 12 | −26.6136 | 2.000 | | | | 7.95 | |
| 13 | −36.6488 | 0.700 | 1.80100 | 34.97 | 0.58642 | 7.50 | S-LAM66.OHARA |
| 14 | 30.6772 | 0.434 | | | | 7.99 | |
| *15 | 391.4672 | 2.105 | 1.49710 | 81.56 | 0.53848 | 8.20 | M-FCD1.HOYA |
| *16 | −10.4200 | DD[16] | | | | 8.99 | |
| *17 | −16.6626 | 1.000 | 1.59208 | 60.99 | 0.53822 | 11.22 | L-BAL35P.OHARA |
| *18 | −46.0223 | DD[18] | | | | 12.14 | |
| 19 | −43.5958 | 2.500 | 1.88100 | 40.14 | 0.57010 | 23.73 | TAFD33.HOYA |
| 20 | −30.2522 | 8.808 | | | | 24.57 | |
| 21 | ∞ | 2.850 | 1.51680 | 64.20 | 0.53430 | | BSC7.HOYA |
| 22 | ∞ | 1.014 | | | | | |

TABLE 26
Example 9

| | Wide | Middle | Tele |
|---|---|---|---|
| Zr | 1.0 | 1.7 | 2.4 |
| f | 13.39 | 22.59 | 32.02 |
| FNo. | 3.79 | 4.91 | 6.49 |
| 2ω[°] | 100.37 | 64.74 | 48.18 |
| DD[6] | 18.085 | 5.622 | 0.656 |
| DD[16] | 1.874 | 2.258 | 1.874 |
| DD[18] | 7.750 | 17.010 | 28.062 |

TABLE 27
Example 9

| Sn | 1 | 2 | 7 | 8 |
|---|---|---|---|---|
| KA | 1.0000000E+00 | −1.4670387E+00 | 1.0000000E+00 | 1.0000000E+00 |
| A3 | 0.0000000E+00 | 0.0000000E+00 | 0.0000000E+00 | 0.0000000E+00 |
| A4 | 3.6235445E−05 | 2.6902858E−04 | −4.2391238E−05 | 4.9733188E−05 |
| A5 | −7.1292586E−06 | −8.2094779E−06 | 1.4933651E−05 | 8.7123260E−06 |
| A6 | 2.2980748E−07 | −1.2589053E−06 | 3.5793260E−06 | −1.6088008E−06 |
| A7 | 1.4995476E−08 | 1.3803338E−07 | −2.1816287E−06 | 4.5199157E−07 |
| A8 | −3.4007318E−10 | −2.2593235E−08 | −5.2406810E−07 | −8.8403670E−08 |
| A9 | −8.5496889E−11 | 2.7727649E−09 | 6.8860394E−07 | 6.1986963E−08 |
| A10 | 4.7076275E−12 | 1.3551201E−11 | −2.1339542E−07 | −9.4816207E−09 |
| A11 | 2.3786001E−13 | −2.5946690E−11 | 2.2017059E−08 | −3.2358750E−09 |
| A12 | −5.0900655E−14 | 3.0605128E−13 | −3.6589320E−10 | 1.5699284E−10 |
| A13 | 2.2951691E−15 | 2.1322131E−13 | 1.2987807E−09 | 1.9587592E−10 |
| A14 | 1.7346482E−16 | −7.5220416E−15 | −3.8596635E−10 | −4.2784531E−13 |
| A15 | −3.3693574E−17 | 4.5446800E−16 | −2.1963603E−11 | 3.6258530E−12 |
| A16 | 2.7377716E−18 | −2.7420488E−16 | 2.0256261E−11 | 4.2860929E−13 |
| A17 | −1.4082004E−19 | 2.1798392E−17 | −1.4716026E−12 | −5.3151454E−13 |
| A18 | 4.5173718E−21 | 6.5737132E−19 | −4.1716994E−13 | −3.0771707E−15 |
| A19 | −7.2245241E−23 | −1.2883227E−19 | 7.6911230E−14 | −1.7735382E−14 |
| A20 | 2.8505831E−25 | 3.8450862E−21 | −3.4381730E−15 | 5.1397662E−15 |
| Sn | 15 | 16 | 17 | 18 |
| KA | 1.0000000E+00 | 1.0000000E+00 | 1.0000000E+00 | 1.0000000E+00 |
| A3 | 0.0000000E+00 | 0.0000000E+00 | 3.3881318E−19 | −1.6940659E−19 |
| A4 | −1.5611131E−04 | 1.7038954E−04 | 5.1967604E−04 | 3.7550109E−04 |
| A5 | 1.2704176E−04 | 1.6633331E−05 | 1.2491771E−04 | 1.7763743E−04 |
| A6 | −1.2755172E−04 | −1.1066220E−04 | −4.1838807E−05 | −5.7489547E−05 |
| A7 | 7.6212820E−05 | 1.4273628E−04 | −1.2841494E−05 | −1.1012315E−05 |
| A8 | −2.7759385E−05 | −8.8734977E−05 | 6.0885944E−06 | 6.9930371E−06 |
| A9 | 5.8231316E−06 | 2.7959982E−05 | −6.8779790E−08 | −3.9029878E−07 |
| A10 | −8.2862671E−07 | −3.9584586E−06 | −3.2564065E−07 | −3.3366382E−07 |
| A11 | 2.4774906E−07 | 6.0244787E−07 | 4.1288815E−08 | 5.5874869E−08 |
| A12 | −7.8260333E−08 | −5.1744979E−07 | 7.5417062E−09 | 6.6759928E−09 |
| A13 | 9.8603632E−09 | 2.2727445E−07 | −1.9721835E−09 | −2.1984702E−09 |
| A14 | 2.3917406E−10 | −4.7843460E−08 | −1.9656339E−11 | −4.5539275E−12 |
| A15 | −1.3885960E−10 | 5.0401336E−09 | 4.2064121E−11 | 4.2239126E−11 |
| A16 | 6.9741470E−12 | −2.1620999E−10 | −2.2729702E−12 | −2.0174675E−12 |
| A17 | −1.8453064E−13 | −2.1331135E−13 | −4.3559659E−13 | −4.0704352E−13 |
| A18 | 5.4919164E−14 | 1.6759066E−14 | 3.9316161E−14 | 3.0963773E−14 |
| A19 | −5.9667679E−15 | 2.6243216E−15 | 1.7903657E−15 | 1.5789375E−15 |
| A20 | 5.2322800E−16 | 1.1171803E−16 | −2.0766227E−16 | −1.4971919E−16 |

### Example 10

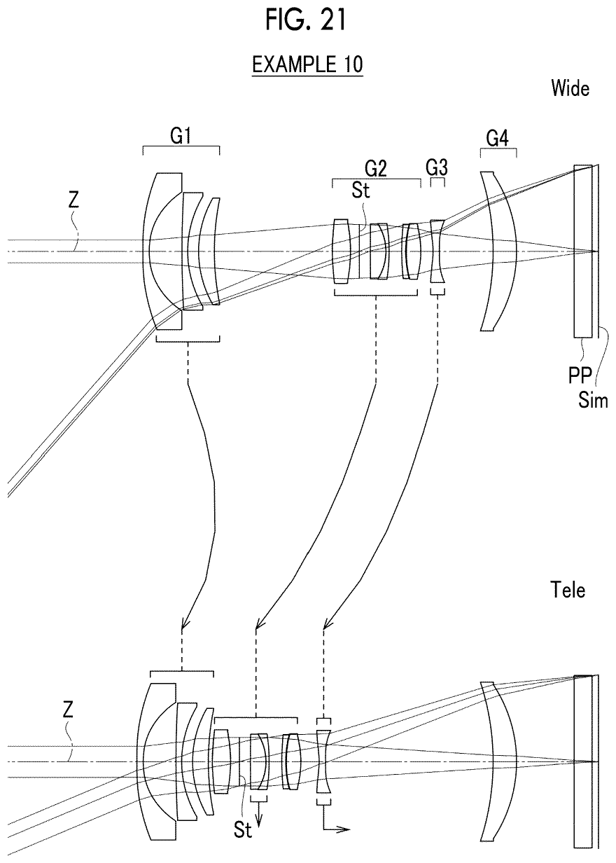

A configuration and a moving trajectory of a variable magnification optical system of Example 10 are shown in FIG. 21. The variable magnification optical system of Example 10 consists of, in order from the object side to the image side, the first lens group G1 having a negative refractive power, the second lens group G2 having a positive refractive power, the third lens group G3 having a negative refractive power, and the fourth lens group G4 having a positive refractive power.

During changing the magnification from the wide angle end to the telephoto end, the fourth lens group G4 is fixed with respect to the image plane Sim, and other lens groups move along the optical axis Z by changing their spacings with respect to their adjacent lens groups. The vibration-proof group consists of one cemented lens that is a lens in the second lens group G2 and is disposed adjacent to the image side of the aperture stop St. The focusing group consists of the third lens group G3. During focusing from the infinite distance object to the nearby object, the focusing group moves to the image side.

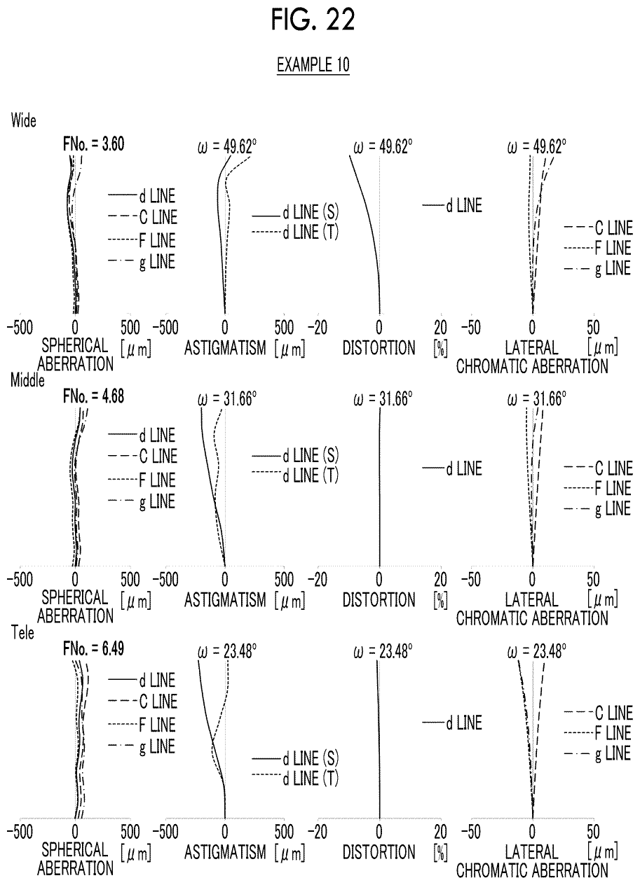

With respect to the variable magnification optical system according to Example 10, basic lens data is shown in Table 28, specifications and variable surface spacings are shown in Table 29, aspherical coefficients are shown in Table 30, and each aberration diagram is shown in FIG. 22.

TABLE 28
Example 10

| Sn | R | D | Nd | vd | θgF | ED | Material |
|---|---|---|---|---|---|---|---|
| *1 | 2001.4410 | 1.000 | 1.77250 | 49.50 | 0.55193 | 25.03 | M-TAF105.HOYA |
| *2 | 16.0255 | 5.176 | | | | 19.20 | |
| 3 | 180.6928 | 0.900 | 1.75500 | 52.32 | 0.54757 | 18.87 | S-LAH97.OHARA |
| 4 | 18.0925 | 1.726 | | | | 17.49 | |
| 5 | 17.9215 | 2.496 | 2.00100 | 29.13 | 0.59952 | 17.44 | TAFD55.HOYA |
| 6 | 44.1812 | DD[6] | | | | 16.99 | |
| *7 | 32.7527 | 2.870 | 1.49710 | 81.56 | 0.53848 | 10.27 | M-FCD1.HOYA |
| *8 | −25.7042 | 1.400 | | | | 9.60 | |
| 9(St) | ∞ | 1.750 | | | | 8.78 | |
| 10 | 592.7055 | 2.458 | 1.80400 | 46.53 | 0.55775 | 8.94 | S-LAH65VS.OHARA |
| 11 | −8.6804 | 0.500 | 1.88300 | 40.76 | 0.56679 | 8.99 | S-LAH58.OHARA |
| 12 | −30.0566 | 2.000 | | | | 9.12 | |
| 13 | 43.2063 | 0.625 | 1.84666 | 23.78 | 0.62076 | 8.87 | H-ZF52GT.CDGM |
| 14 | 18.4569 | 0.100 | | | | 8.74 | |
| *15 | 20.8840 | 2.293 | 1.55332 | 71.68 | 0.54029 | 8.84 | M-FCD500.HOYA |
| *16 | −15.7369 | DD[16] | | | | 9.11 | |
| *17 | −11.1835 | 1.000 | 1.58313 | 59.46 | 0.54056 | 9.74 | M-BACD12.HOYA |
| *18 | 2000.0000 | DD[18] | | | | 10.20 | |
| 19 | −43.0567 | 3.710 | 1.65160 | 58.40 | 0.54123 | 24.10 | H-LAK50A.CDGM |
| 20 | −23.4017 | 9.106 | | | | 25.16 | |
| 21 | ∞ | 2.850 | 1.51680 | 64.20 | 0.53430 | | BSC7.HOYA |
| 22 | ∞ | 1.019 | | | | | |

TABLE 29
Example 10

| | Wide | Middle | Tele |
|---|---|---|---|
| Zr | 1.0 | 1.7 | 2.5 |
| f | 13.39 | 23.00 | 32.99 |
| FNo. | 3.60 | 4.68 | 6.49 |
| 2ω[°] | 99.23 | 63.32 | 46.96 |
| DD[6] | 18.582 | 5.536 | 0.640 |
| DD[16] | 1.936 | 2.636 | 2.811 |
| DD[18] | 8.500 | 16.573 | 26.523 |

TABLE 30
Example 10

| Sn | 1 | 2 | 7 | 8 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 6.8486005E−04 | 7.6617376E−04 | −2.3297313E−04 | −5.3926715E−05 |
| A5 | −2.0226979E−05 | −6.9450168E−05 | 1.9502943E−04 | 8.2954231E−05 |
| A6 | −2.7785485E−05 | 7.0611608E−06 | −1.6401712E−04 | −1.4975143E−04 |
| A7 | 4.6280422E−06 | −6.4778360E−06 | 6.6153403E−05 | 1.4935317E−04 |
| A8 | −2.2048555E−07 | 1.5997245E−06 | −1.0710963E−05 | −7.4624668E−05 |
| A9 | 1.0148820E−08 | −1.4144630E−07 | 1.7720111E−07 | 1.2546127E−05 |
| A10 | −5.1152275E−09 | 2.6946924E−09 | −4.2846891E−09 | 4.5559337E−06 |
| A11 | 6.7514540E−10 | −4.0116167E−10 | −1.7802959E−07 | −2.6045234E−06 |
| A12 | −1.5757590E−11 | 1.2542286E−10 | 1.4893331E−07 | 4.6181243E−07 |
| A13 | −2.3241741E−12 | −6.1514936E−12 | −3.4308039E−08 | −3.9281466E−08 |
| A14 | 1.2887837E−13 | −5.3388351E−13 | 5.2506782E−10 | 7.7099713E−09 |
| A15 | −2.4105994E−15 | 1.3639030E−13 | 5.8129757E−10 | −1.0329092E−09 |
| A16 | 2.8052113E−16 | −2.1635767E−14 | 2.9467430E−11 | −2.6525187E−10 |
| A17 | 3.5081891E−17 | 1.2609920E−15 | −2.1978755E−11 | 3.6006611E−11 |
| A18 | −7.9351548E−18 | 7.6368813E−17 | 1.4579781E−12 | 1.3488891E−11 |
| A19 | 4.3974270E−19 | −1.1363533E−17 | 6.8289348E−14 | −2.9783591E−12 |
| A20 | −8.0129185E−21 | 3.4371728E−19 | −6.1280556E−15 | 1.6571572E−13 |
| Sn | 15 | 16 | 17 | 18 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −8.5772062E−05 | 9.2000881E−06 | 3.2007596E−03 | 2.9617394E−03 |
| A5 | 1.2771347E−04 | 4.1112958E−05 | −2.5051527E−05 | 1.9552900E−04 |
| A6 | −1.2467909E−04 | −1.0485934E−04 | −3.2919559E−04 | −5.9891503E−04 |
| A7 | 7.8008719E−05 | 1.4218074E−04 | 2.1745488E−04 | 4.5203279E−04 |
| A8 | −2.7815184E−05 | −8.8785055E−05 | −9.7381833E−05 | −2.2032760E−04 |
| A9 | 5.7438954E−06 | 2.7959692E−05 | 1.7583830E−05 | 5.7579087E−05 |
| A10 | −8.4218506E−07 | −3.9582227E−06 | 1.4191057E−06 | −5.4653877E−06 |
| A11 | 2.5246361E−07 | 6.0282531E−07 | −5.2014894E−07 | −6.9118755E−07 |
| A12 | −7.8203735E−08 | −5.1742809E−07 | −1.6608476E−07 | 1.7834397E−07 |
| A13 | 9.8688768E−09 | 2.2727546E−07 | 5.1451668E−08 | −4.6238479E−09 |
| A14 | 2.4430091E−10 | −4.7837644E−08 | 3.0895822E−10 | −1.1109776E−10 |
| A15 | −1.3813012E−10 | 5.0401375E−09 | −1.1916076E−09 | −2.7660737E−10 |
| A16 | 6.7428838E−12 | −2.1620934E−10 | 9.4914158E−11 | 2.8232393E−11 |

Tables 31 and 32 show corresponding values of Conditional Expressions (1) to (24) of the variable magnification optical systems of Examples 1 to 10. Preferable ranges of the conditional expressions may be set using the corresponding values shown in Tables 31 and 32 as the upper limit values or the lower limit values of the conditional expressions.

TABLE 31

| Expression | | Example | Example | Example | Example | Example |
|---|---|---|---|---|---|---|
| number | | 1 | 2 | 3 | 4 | 5 |
| (1) | DG1fG2f/fw | 2.334 | 2.315 | 2.328 | 2.329 | 2.322 |
| (2) | DG1/fw | 0.875 | 0.871 | 0.875 | 0.881 | 0.883 |
| (3) | TLw/(fw × tanωw) | 4.402 | 4.394 | 4.395 | 4.395 | 4.387 |
| (4) | Bfw/(fw × tanωw) | 0.727 | 0.726 | 0.726 | 0.737 | 0.731 |
| (5) | fOIS/ft | 3.259 | 1.810 | 3.269 | 3.218 | 1.848 |
| (6) | f1/fw | −1.682 | −1.692 | −1.688 | −1.699 | −1.686 |
| (7) | f2/fw | 1.353 | 1.354 | 1.353 | 1.356 | 1.349 |
| (8) | N1 + 0.01 × v1 | 2.220 | 2.220 | 2.220 | 2.213 | 2.213 |
| (9) | θ1 + 0.0025 × v1 | 0.672 | 0.672 | 0.672 | 0.671 | 0.671 |
| (10) | N2 + 0.01 × v2 | 2.360 | 2.360 | 2.359 | 2.388 | 2.388 |
| (11) | θ2 + 0.0025 × v2 | 0.762 | 0.762 | 0.761 | 0.771 | 0.771 |
| (12) | NG2p + 0.01 × vG2p | 2.270 | 2.268 | 2.268 | 2.268 | 2.268 |
| (13) | θG2p + 0.0025 × vG2p | 0.719 | 0.725 | 0.725 | 0.725 | 0.725 |
| (14) | NG2r + 0.01 × vG2r | 2.313 | 2.313 | 2.313 | 2.313 | 2.313 |
| (15) | θG2r + 0.0025 × vG2r | 0.742 | 0.742 | 0.742 | 0.742 | 0.742 |
| (16) | (RG2r + RG3f)/(RG2r - RG3f) | −3.546 | −3.798 | −3.837 | −3.740 | −3.609 |
| (17) | Dexpw/fw | −2.886 | −2.869 | −2.868 | −2.843 | −2.854 |
| (18) | Dexpw/TLw | −0.546 | −0.544 | −0.544 | −0.541 | −0.543 |
| (19) | ThG/fw | 2.258 | 2.260 | 2.248 | 2.246 | 2.248 |
| (20) | ThG/TLw | 0.428 | 0.429 | 0.426 | 0.427 | 0.428 |
| (21) | EDL1f/fw | 1.916 | 1.922 | 1.920 | 1.914 | 1.919 |
| (22) | EDL1f/TLw | 0.363 | 0.365 | 0.364 | 0.364 | 0.365 |
| (23) | \|(1 - βFoc²) × βFocR²\| | 2.410 | 2.408 | 2.415 | 2.397 | 2.433 |
| (24) | \|(1 - βOIS) × βOISR\| | 1.097 | 2.133 | 1.102 | 1.116 | 2.089 |

TABLE 32

| Expression | | Example | Example | Example | Example | Example |
|---|---|---|---|---|---|---|
| number | | 6 | 7 | 8 | 9 | 10 |
| (1) | DG1fG2f/fw | 2.313 | 2.330 | 2.207 | 2.210 | 2.231 |
| (2) | DG1/fw | 0.866 | 0.876 | 0.864 | 0.860 | 0.843 |
| (3) | TLw/(fw × tanωw) | 4.341 | 4.397 | 4.308 | 4.313 | 4.510 |
| (4) | Bfw/(fw ×x tanωw) | 0.729 | 0.726 | 0.728 | 0.728 | 0.762 |
| (5) | fOIS/ft | 2.856 | 3.265 | 3.200 | 3.152 | 3.447 |
| (6) | f1/fw | −1.734 | −1.691 | −1.574 | −1.568 | −1.543 |
| (7) | f2/fw | 1.239 | 1.353 | 1.316 | 1.327 | 1.020 |
| (8) | N1 + 0.01 × v1 | 2.225 | 2.213 | 2.236 | 2.236 | 2.268 |
| (9) | θ1 + 0.0025 × v1 | 0.680 | 0.671 | 0.676 | 0.676 | 0.676 |
| (10) | N2 + 0.01 × v2 | 2.312 | 2.360 | 2.264 | 2.210 | 2.278 |
| (11) | θ2 + 0.0025 × v2 | 0.741 | 0.762 | 0.704 | 0.693 | 0.678 |
| (12) | NG2p + 0.01 × vG2p | 2.287 | 2.268 | 2.251 | 2.213 | 2.291 |
| (13) | θG2p + 0.0025 × vG2p | 0.710 | 0.725 | 0.720 | 0.722 | 0.710 |
| (14) | NG2r + 0.01 × vG2r | 2.270 | 2.313 | 2.313 | 2.313 | 2.270 |
| (15) | θG2r + 0.0025 × vG2r | 0.720 | 0.742 | 0.742 | 0.742 | 0.720 |
| (16) | (RG2r + RG3f)/(RG2r - RG3f) | −6.979 | −3.837 | −3.872 | −4.338 | 5.912 |
| (17) | Dexpw/fw | −2.806 | −2.866 | −2.917 | −2.925 | −2.929 |
| (18) | Dexpw/TLw | −0.539 | −0.543 | −0.564 | −0.565 | −0.552 |
| (19) | ThG/fw | 2.241 | 2.251 | 2.235 | 2.231 | 2.240 |
| (20) | ThG/TLw | 0.430 | 0.427 | 0.432 | 0.431 | 0.422 |
| (21) | EDL1f/fw | 2.140 | 1.921 | 1.944 | 1.921 | 1.869 |
| (22) | EDL1f/TLw | 0.411 | 0.364 | 0.376 | 0.371 | 0.352 |
| (23) | \|(1 - βFoc²) × βFocR²\| | 3.642 | 2.406 | 2.432 | 2.366 | 7.176 |
| (24) | \|(1 - βOIS) × βOISR\| | 1.170 | 1.098 | 1.101 | 1.104 | 1.083 |

The variable magnification optical systems of Examples 1 to 10 have a wide angle of view with a maximum full angle of view of 90 degrees or more at the wide angle end while being configured to be small. In addition, in the variable magnification optical systems according to Examples 1 to 10, various aberrations are favorably corrected in the entire magnification range, and high optical performance is maintained.

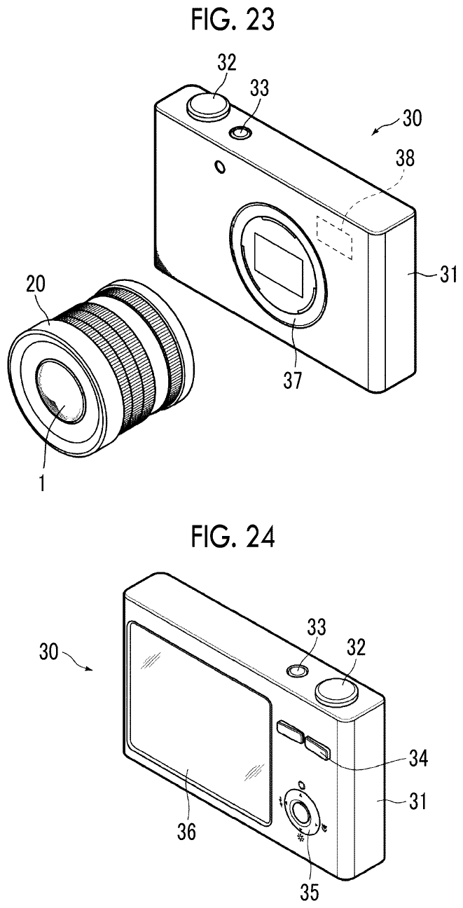

Next, an imaging apparatus according to the embodiment of the present disclosure will be described. FIGS. 23 and 24 show external views of a camera 30 that is the imaging apparatus according to one embodiment of the present disclosure. FIG. 23 shows a perspective view of the camera 30 seen from a front surface side, and FIG. 24 shows a perspective view of the camera 30 seen from a rear surface side. The camera 30 is a digital camera of a so-called mirrorless type on which an interchangeable lens 20 can be attachably and detachably mounted. The interchangeable lens 20 is configured to include a variable magnification optical system 1 according to one embodiment of the present disclosure, accommodated in a lens barrel.

The camera 30 comprises a camera body 31. A shutter button 32 and a power button 33 are provided on an upper surface of the camera body 31. An operation unit 34, an operation unit 35, and a display unit 36 are provided on a rear surface of the camera body 31. The display unit 36 can display a captured image and an image within an angle of view before capturing.

An imaging aperture on which light from an imaging target is incident is provided at a center portion of a front surface of the camera body 31. A mount 37 is provided at a position corresponding to the imaging aperture, and the interchangeable lens 20 is mounted on the camera body 31 with the mount 37 interposed therebetween.

An imaging element 38 is provided in the camera body 31. The imaging element 38 outputs an imaging signal corresponding to a subject image formed by the interchangeable lens 20. For example, a charge coupled device (CCD) or a complementary metal oxide semiconductor (CMOS) is used as the imaging element 38. A signal processing circuit (not shown), a recording medium (not shown), and the like are provided in the camera body 31. The signal processing circuit generates an image by processing the imaging signal output from the imaging element 38. The recording medium is used to record the generated image. In the camera 30, a still image or a moving image can be captured by pressing the shutter button 32, and image data obtained by the capturing is recorded on the recording medium.

While the technology of the present disclosure is described above using the embodiment and the examples, the technology of the present disclosure is not limited to the embodiment and the examples, and various modifications can be made. For example, the curvature radius, the surface spacing, the refractive index, the Abbe number, and the aspherical coefficients of each lens are not limited to the values shown in each example and may have other values.

The imaging apparatus according to the embodiment of the present disclosure is not limited to the above example and, for example, various aspects such as a camera of a type other than a mirrorless type, a camera composed of an imaging lens and a camera body that are integrally formed with each other, a film camera, a video camera, a surveillance camera, a broadcasting camera, a movie imaging camera, a factory automation (FA) camera, and a machine vision (MV) camera can be adopted.

The following appendices are further disclosed with respect to the embodiment and the examples described above.

### Appendix 1

A variable magnification optical system consisting of, in order from an object side to an image side, a first lens group having a negative refractive power, a second lens group having a positive refractive power, a third lens group, and a fourth lens group,
in which all spacings between adjacent lens groups change during changing magnification,
the second lens group includes an aperture stop,
a vibration-proof group that moves in a direction intersecting an optical axis during image shake correction is disposed adjacent to the aperture stop,
a focusing group that moves along the optical axis during focusing is disposed closer to the image side than the aperture stop, and
in a case where
   a distance on the optical axis from a lens surface of the first lens group closest to the object side to a lens surface of the second lens group closest to the object side in a state where an infinite distance object is in focus at a wide angle end is denoted by DG1fG2f,
   a focal length of an entire system in a state where the infinite distance object is in focus at the wide angle end is denoted by fw,
   a thickness of the first lens group on the optical axis is denoted by DG1,
   a sum of a distance on the optical axis from the lens surface of the first lens group closest to the object side to a lens surface of the fourth lens group closest to the image side and a back focus of the entire system in terms of an air conversion distance in a state where the infinite distance object is in focus at the wide angle end is denoted by TLw,
   a maximum half angle of view in a state where the infinite distance object is in focus at the wide angle end is denoted by ωw, and
   a back focus of the entire system in terms of the air conversion distance at the wide angle end is denoted by Bfw,

Conditional Expressions (1), (2), (3), and (4) are satisfied, which are represented by

$$1 < DG 1 fG 2 f / fw < 5 , \qquad ( 1 )$$

$$0.4 < DG 1 / fw < 2.5 , \qquad ( 2 )$$

$$2 < TLw / ( fw \times tan ω w ) < 8 , and \qquad ( 3 )$$

$$0.2 < Bfw / ( fw \times tan ω w ) < 1.8 . \qquad ( 4 )$$

### Appendix 2

The variable magnification optical system according to Appendix 1,
in which the third lens group has a negative refractive power,
the fourth lens group has a positive refractive power, and
the focusing group consists of the third lens group.

### Appendix 3

The variable magnification optical system according to Appendix 1 or 2,
in which in a case where
   a focal length of the vibration-proof group is denoted by fOIS, and
   a focal length of the entire system in a state where the infinite distance object is in focus at a telephoto end is denoted by ft,

Conditional Expression (5) is satisfied, which is represented by

$$0.5 < fOIS / ft < 6. \qquad ( 5 )$$

### Appendix 4

The variable magnification optical system according to any one of Appendices 1 to 3,
in which in a case where a focal length of the first lens group is denoted by f1,

Conditional Expression (6) is satisfied, which is represented by

$$- 4 < f 1 / fw < - 0.8 . \qquad ( 6 )$$

### Appendix 5

The variable magnification optical system according to any one of Appendices 1 to 4,
in which in a case where a focal length of the second lens group is denoted by f2,

Conditional Expression (7) is satisfied, which is represented by

$$0.5 < f 2 / fw < 3. \qquad ( 7 )$$

### Appendix 6

The variable magnification optical system according to any one of Appendices 1 to 5,
in which a first lens disposed closest to the object side in the first lens group is an aspherical lens having a negative refractive power, and
in a case where
   a refractive index of the first lens with respect to a d line is denoted by N1,
   an Abbe number of the first lens based on the d line is denoted by v1, and
   a partial dispersion ratio of the first lens between a g line and an F line is denoted by θ1,

Conditional Expressions (8) and (9) are satisfied, which are represented by

$$2.19 < N 1 + 0.01 \times ν1 < 2.29 , and \qquad ( 8 )$$

$$0.65 < θ1 + 0.0 \; 025 \times ν1 < 0.7 . \qquad ( 9 )$$

### Appendix 7

The variable magnification optical system according to any one of Appendices 1 to 6,
in which a second lens disposed second from the object side in the first lens group has a negative refractive power, and
in a case where
   a refractive index of the second lens with respect to a d line is denoted by N2
   an Abbe number of the second lens based on the d line is denoted by v2, and
   a partial dispersion ratio of the second lens between a g line and an F line is denoted by θ2,

Conditional Expressions (10) and (11) are satisfied, which are represented by

$$2.18 < N 2 + 0.01 \times ν2 < 2.4 , and \qquad ( 10 )$$

$$0.65 < θ2 + 0.0 \; 025 \times ν2 < 0.79 . \qquad ( 11 )$$

### Appendix 8

The variable magnification optical system according to any one of Appendices 1 to 7,
in which the second lens group includes a plurality of positive lenses, and
in a case where
   an average value of refractive indices of all positive lenses included in the second lens group with respect to a d line is denoted by NG2p,
   an average value of Abbe numbers of all positive lenses included in the second lens group based on the d line is denoted by vG2p, and
   an average value of partial dispersion ratios of all positive lenses included in the second lens group between a g line and an F line is denoted by θG2p,

Conditional Expressions (12) and (13) are satisfied, which are represented by

$$2.16 < NG 2 p + 0.01 \times νG 2 p < 2.36 , and \qquad ( 12 )$$

$$0.68 < θ G 2 p + 0.0 \; 025 \times ν G 2 p < 0.76 . \qquad ( 13 )$$

### Appendix 9

The variable magnification optical system according to any one of Appendices 1 to 8,
in which a lens disposed closest to the image side in the second lens group is a positive lens, and
in a case where
   a refractive index of the positive lens closest to the image side in the second lens group with respect to a d line is denoted by NG2r,
   an Abbe number of the positive lens closest to the image side in the second lens group based on the d line is denoted by vG2r, and
   a partial dispersion ratio of the positive lens closest to the image side in the second lens group between a g line and an F line is denoted by θG2r,

Conditional Expressions (14) and (15) are satisfied, which are represented by

$$2.18 < NG 2 r + 0.01 \times vG 2 r < 24 , and \qquad ( 14 )$$

$$0.7 < θ G 2 r + 0.0025 \times vG 2 r < 0 \text{.76} . \qquad ( 15 )$$

### Appendix 10

The variable magnification optical system according to any one of Appendices 1 to 9,
in which in a case where
   a paraxial curvature radius of a lens surface of the second lens group closest to the image side is denoted by RG2r, and
   a paraxial curvature radius of a lens surface of the third lens group closest to the object side is denoted by RG3f,

Conditional Expression (16) is satisfied, which is represented by

$$- 12 < ( RG 2 r + RG 3 f ) / ( RG 2 r - RG 3 f ) < - 0.5 . \qquad ( 16 )$$

### Appendix 11

The variable magnification optical system according to any one of Appendices 1 to 10,
in which in a case where
   a distance on the optical axis from an image plane to a paraxial exit pupil position in a state where the infinite distance object is in focus at the wide angle end is denoted by Dexpw,
   a sign of Dexpw is defined with the image plane as a reference such that a distance on the image side is positive and a distance on the object side is negative, and
   Dexpw is calculated, in a case where an optical member not having a refractive power is disposed between the image plane and the paraxial exit pupil position, by using an air conversion distance for the optical member,

Conditional Expression (17) is satisfied, which is represented by

$$- 5 < Dexpw / fw < - 1.5 . \qquad ( 17 )$$

### Appendix 12

The variable magnification optical system according to any one of Appendices 1 to 11,
in which in a case where
   a distance on the optical axis from an image plane to a paraxial exit pupil position in a state where the infinite distance object is in focus at the wide angle end is denoted by Dexpw,
   a sign of Dexpw is defined with the image plane as a reference such that a distance on the image side is positive and a distance on the object side is negative, and
   Dexpw is calculated, in a case where an optical member not having a refractive power is disposed between the image plane and the paraxial exit pupil position, by using an air conversion distance for the optical member,

Conditional Expression (18) is satisfied, which is represented by

$$- 1 < Dexpw / TLw < - 0.3 . \qquad ( 18 )$$

### Appendix 13

The variable magnification optical system according to any one of Appendices 1 to 12,
in which in a case where a sum of the thickness of the first lens group on the optical axis, a thickness of the second lens group on the optical axis, a thickness of the third lens group on the optical axis, and a thickness of the fourth lens group on the optical axis is denoted by ThG,

Conditional Expression (19) is satisfied, which is represented by

$$0.5 < ThG / fw < 3.8 . \qquad ( 19 )$$

### Appendix 14

The variable magnification optical system according to any one of Appendices 1 to 13,
in which in a case where a sum of the thickness of the first lens group on the optical axis, a thickness of the second lens group on the optical axis, a thickness of the third lens group on the optical axis, and a thickness of the fourth lens group on the optical axis is denoted by ThG,

Conditional Expression (20) is satisfied, which is represented by

$$0.15 < ThG / TLw < 0.7 . \qquad ( 20 )$$

### Appendix 15

The variable magnification optical system according to any one of Appendices 1 to 14,
in which in a case where an effective diameter of the lens surface of the first lens group closest to the object side is denoted by EDL1f,

Conditional Expression (21) is satisfied, which is represented by

$$1. 5 < EDL 1 f / fw < 2.5 . \qquad ( 21 )$$

### Appendix 16

The variable magnification optical system according to any one of Appendices 1 to 15,
in which in a case where an effective diameter of the lens surface of the first lens group closest to the object side is denoted by EDL1f,

Conditional Expression (22) is satisfied, which is represented by

$$0.2 < EDL 1 f / TLw < 0.6 . \qquad ( 22 )$$

### Appendix 17

The variable magnification optical system according to any one of Appendices 1 to 16,
in which in a case where
   a lateral magnification of the focusing group in a state where the infinite distance object is in focus at a telephoto end is denoted by βFoc, and
   a combined lateral magnification of all lenses closer to the image side than the focusing group in a state where the infinite distance object is in focus at the telephoto end is denoted by βFocR,

Conditional Expression (23) is satisfied, which is represented by

$$1 < \vert ( 1 - β {Foc}^{2} ) \times β Foc {R}^{2} \vert < 10. \qquad ( 23 )$$

### Appendix 18

The variable magnification optical system according to any one of Appendices 1 to 17,
in which in a case where
   a lateral magnification of the vibration-proof group in a state where the infinite distance object is in focus at a telephoto end is denoted by BOIS, and
   a combined lateral magnification of all lenses closer to the image side than the vibration-proof group in a state where the infinite distance object is in focus at the telephoto end is denoted by βOISR,

Conditional Expression (24) is satisfied, which is represented by

$$0.6 < \vert ( 1 - β OIS ) \times β OISR \vert < 3.5 . \qquad ( 24 )$$

### Appendix 19

The variable magnification optical system according to any one of Appendices 1 to 18,
in which the first lens group consists of, in order from the object side to the image side, a single lens having a negative refractive power, a single lens having a negative refractive power, and a single lens having a positive refractive power.

### Appendix 20

The variable magnification optical system according to any one of Appendices 1 to 19,
in which the third lens group consists of one single lens having a negative refractive power.

### Appendix 21

The variable magnification optical system according to any one of Appendices 1 to 20,
in which the fourth lens group consists of one single lens having a positive refractive power.

### Appendix 22

The variable magnification optical system according to any one of Appendices 1 to 21,
in which the number of lenses included in the entire system is 12 or less.

### Appendix 23

The variable magnification optical system according to any one of Appendices 1 to 22,
in which Conditional Expression (1-1) is satisfied, which is represented by

$$1. 8 < DG 1 fG 2 f / fw < 2.6 . \qquad ( 1 - 1 )$$

### Appendix 24

The variable magnification optical system according to any one of Appendices 1 to 23,
in which Conditional Expression (2-1) is satisfied, which is represented by

$$0.7 < DG 1 / fw < 1. \qquad ( 2 - 1 )$$

### Appendix 25

The variable magnification optical system according to any one of Appendices 1 to 24,
in which Conditional Expression (3-1) is satisfied, which is represented by

$$3 < TLw / ( fw \times tan ω w ) < 5.5 . \qquad ( 3 - 1 )$$

### Appendix 26

An imaging apparatus comprising the variable magnification optical system according to any one of Appendices 1 to 25.

What is claimed is:

1. A variable magnification optical system consisting of, in order from an object side to an image side, a first lens group having a negative refractive power, a second lens group having a positive refractive power, a third lens group, and a fourth lens group,
wherein all spacings between adjacent lens groups change during changing magnification,
the second lens group includes an aperture stop,
a vibration-proof group that moves in a direction intersecting an optical axis during image shake correction is disposed adjacent to the aperture stop,
a focusing group that moves along the optical axis during focusing is disposed closer to the image side than the aperture stop, and
in a case where
a distance on the optical axis from a lens surface of the first lens group closest to the object side to a lens surface of the second lens group closest to the object side in a state where an infinite distance object is in focus at a wide angle end is denoted by DG1fG2f,
a focal length of the variable magnification optical system in a state where the infinite distance object is in focus at the wide angle end is denoted by fw,
a thickness of the first lens group on the optical axis is denoted by DG1,
a sum of a distance on the optical axis from the lens surface of the first lens group closest to the object side to a lens surface of the fourth lens group closest to the image side and a back focus of the variable magnification optical system in terms of an air conversion distance in a state where the infinite distance object is in focus at the wide angle end is denoted by TLw,
a maximum half angle of view in a state where the infinite distance object is in focus at the wide angle end is denoted by ωw, and
a back focus of the variable magnification optical system in terms of the air conversion distance at the wide angle end is denoted by Bfw,
Conditional Expressions (1), (2), (3), and (4) are satisfied, which are represented by
$$1 < DG 1 fG 2 f / fw < 5 , \qquad ( 1 )$$
$$0.4 < DG 1 / fw < 2.5 , \qquad ( 2 )$$
$$2 < TLw / ( fw \times tan ω w ) < 8 , and \qquad ( 3 )$$
$$0.2 < Bfw / ( fw \times tan ω w ) < 1.8 . \qquad ( 4 )$$

2. The variable magnification optical system according to claim 1,
wherein the third lens group has a negative refractive power,
the fourth lens group has a positive refractive power, and
the focusing group consists of the third lens group.

3. The variable magnification optical system according to claim 1,
wherein in a case where
a focal length of the vibration-proof group is denoted by fOIS, and
a focal length of the variable magnification optical system in a state where the infinite distance object is in focus at a telephoto end is denoted by ft,
Conditional Expression (5) is satisfied, which is represented by
$$0.5 < f OIS / ft < 6. \qquad ( 5 )$$

4. The variable magnification optical system according to claim 1,
wherein in a case where a focal length of the first lens group is denoted by f1,
Conditional Expression (6) is satisfied, which is represented by
$$- 4 < fl / fw < - 0.8 . \qquad ( 6 )$$

5. The variable magnification optical system according to claim 1,
wherein in a case where a focal length of the second lens group is denoted by f2,
Conditional Expression (7) is satisfied, which is represented by
$$0.5 < f 2 / fw < 3. \qquad ( 7 )$$

6. The variable magnification optical system according to claim 1,
wherein a first lens disposed closest to the object side in the first lens group is an aspherical lens having a negative refractive power, and
in a case where
a refractive index of the first lens with respect to a d line is denoted by N1,
an Abbe number of the first lens based on the d line is denoted by v1, and
a partial dispersion ratio of the first lens between a g line and an F line is denoted by θ1,
Conditional Expressions (8) and (9) are satisfied, which are represented by
$$2.19 < N 1 + 0.01 \times vl < 2.29 , and \qquad ( 8 )$$
$$0.65 < θ1 + 0.0025 \times vl < 0.7 . \qquad ( 9 )$$

7. The variable magnification optical system according to claim 1,
wherein a second lens disposed second from the object side in the first lens group has a negative refractive power, and
in a case where
a refractive index of the second lens with respect to a d line is denoted by N2,
an Abbe number of the second lens based on the d line is denoted by v2, and
a partial dispersion ratio of the second lens between a g line and an F line is denoted by θ2,
Conditional Expressions (10) and (11) are satisfied, which are represented by
$$2.18 < N 2 + 0.01 \times v 2 < 2.4 , and \qquad ( 10 )$$
$$0.65 < θ2 + 0.0025 \times v 2 < 0 \text{.79} . \qquad ( 11 )$$

8. The variable magnification optical system according to claim 1,
wherein the second lens group includes a plurality of positive lenses, and
in a case where
an average value of refractive indices of all positive lenses included in the second lens group with respect to a d line is denoted by NG2p,
an average value of Abbe numbers of all positive lenses included in the second lens group based on the d line is denoted by vG2p, and
an average value of partial dispersion ratios of all positive lenses included in the second lens group between a g line and an F line is denoted by θG2p,
Conditional Expressions (12) and (13) are satisfied, which are represented by
$$2.16 < NG 2 p + 0.01 \times v G 2 p < 2.36 , and \qquad ( 12 )$$
$$0.68 < θ G 2p + 0.0025 \times v G 2 p < 0 \text{.76} . \qquad ( 13 )$$

9. The variable magnification optical system according to claim 1,
wherein a lens disposed closest to the image side in the second lens group is a positive lens, and
in a case where
a refractive index of the positive lens closest to the image side in the second lens group with respect to a d line is denoted by NG2r,
an Abbe number of the positive lens closest to the image side in the second lens group based on the d line is denoted by vG2r, and
a partial dispersion ratio of the positive lens closest to the image side in the second lens group between a g line and an F line is denoted by θG2r,
Conditional Expressions (14) and (15) are satisfied, which are represented by
$$2.18 < NG 2 r + 0. 01 \times vG 2 r < 2.4 , and \qquad ( 14 )$$
$$0.7 < θ G 2 r + 0.0025 \times vG 2 r < 0.76 . \qquad ( 15 )$$

10. The variable magnification optical system according to claim 1,
wherein in a case where
a paraxial curvature radius of a lens surface of the second lens group closest to the image side is denoted by RG2r, and
a paraxial curvature radius of a lens surface of the third lens group closest to the object side is denoted by RG3f,
Conditional Expression (16) is satisfied, which is represented by
$$- 12 < ( RG 2 r + RG 3 f ) / ( RG 2 r - RG 3 f ) < - 0.5 . \qquad ( 16 )$$

11. The variable magnification optical system according to claim 1,
wherein in a case where
a distance on the optical axis from an image plane to a paraxial exit pupil position in a state where the infinite distance object is in focus at the wide angle end is denoted by Dexpw,
a sign of Dexpw is defined with the image plane as a reference such that a distance on the image side is positive and a distance on the object side is negative, and
Dexpw is calculated, in a case where an optical member not having a refractive power is disposed between the image plane and the paraxial exit pupil position, by using an air conversion distance for the optical member,
Conditional Expression (17) is satisfied, which is represented by
$$- 5 < Dexpw / fw < - 1.5 . \qquad ( 17 )$$

12. The variable magnification optical system according to claim 1,
wherein in a case where
a distance on the optical axis from an image plane to a paraxial exit pupil position in a state where the infinite distance object is in focus at the wide angle end is denoted by Dexpw,
a sign of Dexpw is defined with the image plane as a reference such that a distance on the image side is positive and a distance on the object side is negative, and
Dexpw is calculated, in a case where an optical member not having a refractive power is disposed between the image plane and the paraxial exit pupil position, by using an air conversion distance for the optical member,
Conditional Expression (18) is satisfied, which is represented by
$$- 1 < Dexpw / TLw < - 0.3 . \qquad ( 18 )$$

13. The variable magnification optical system according to claim 1,
wherein in a case where a sum of the thickness of the first lens group on the optical axis, a thickness of the second lens group on the optical axis, a thickness of the third lens group on the optical axis, and a thickness of the fourth lens group on the optical axis is denoted by ThG,
Conditional Expression (19) is satisfied, which is represented by
$$0.5 < ThG / fw < 3.8 . \qquad ( 19 )$$

14. The variable magnification optical system according to claim 1,
wherein in a case where a sum of the thickness of the first lens group on the optical axis, a thickness of the second lens group on the optical axis, a thickness of the third lens group on the optical axis, and a thickness of the fourth lens group on the optical axis is denoted by ThG,
Conditional Expression (20) is satisfied, which is represented by
$$0.15 < ThG / TLw < 0.7 . \qquad ( 20 )$$

15. The variable magnification optical system according to claim 1,
wherein in a case where an effective diameter of the lens surface of the first lens group closest to the object side is denoted by EDL1f,
Conditional Expression (21) is satisfied, which is represented by
$$1.5 < EDL 1 f / fw < 2.5 . \qquad ( 21 )$$

16. The variable magnification optical system according to claim 1,
wherein in a case where an effective diameter of the lens surface of the first lens group closest to the object side is denoted by EDL1f,
Conditional Expression (22) is satisfied, which is represented by
$$0.2 < EDL 1 f / TLw < 0.6 . \qquad ( 22 )$$

17. The variable magnification optical system according to claim 1,
wherein in a case where
a lateral magnification of the focusing group in a state where the infinite distance object is in focus at a telephoto end is denoted by βFoc, and
a combined lateral magnification of all lenses closer to the image side than the focusing group in a state where the infinite distance object is in focus at the telephoto end is denoted by βFocR,
Conditional Expression (23) is satisfied, which is represented by
$$1 < \vert ( 1 - {β Foc}^{2} ) \times {β FocR}^{2} \vert < 10. \qquad ( 23 )$$

18. The variable magnification optical system according to claim 1,
wherein in a case where
a lateral magnification of the vibration-proof group in a state where the infinite distance object is in focus at a telephoto end is denoted by BOIS, and
a combined lateral magnification of all lenses closer to the image side than the vibration-proof group in a state where the infinite distance object is in focus at the telephoto end is denoted by βOISR,
Conditional Expression (24) is satisfied, which is represented by
$$0.6 < \vert ( 1 - β OIS ) \times β OISR \vert < 3.5 . \qquad ( 24 )$$

19. The variable magnification optical system according to claim 1,
wherein the first lens group consists of, in order from the object side to the image side, a single lens having a negative refractive power, a single lens having a negative refractive power, and a single lens having a positive refractive power.

20. An imaging apparatus comprising:
the variable magnification optical system according to claim 1.
